(19) United States
(12) Patent Application Publication
(10) Pub. No.: US 2009/0144088 A1
(43) Pub. Date: Jun. 4, 2009

(54) DIAGNOSTICS BENEFITS MANAGEMENT AND DECISION SUPPORT SYSTEM, AND ASSOCIATED METHOD AND COMPUTER-READABLE STORAGE MEDIUM

(75) Inventors: Matthew Zubiller, San Diego, CA (US); Laura Lata Coughlin, North Grafton, MA (US); Richard Hensley, Erie, CO (US); Craig Allen Knier, Asbury, IA (US); Daniel Lyakovetsky, Norwalk, CT (US); Douglas James Moeller, Phoenixville, PA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/235,167

(22) Filed: Sep. 22, 2008

Related U.S. Application Data
(60) Provisional application No. 60/974,319, filed on Sep. 21, 2007.

(51) Int. Cl. G06Q 50/00; G06Q 40/00; G06Q 20/00; G06Q 90/00

(52) U.S. Cl. 705/3; 705/2; 705/4; 705/40; 705/400

(57) ABSTRACT

A system may receive a proposed medical diagnosis of a patient, and automatically identify potential medical services to be performed with respect to the patient. The identified medical services may be deemed relevant to the proposed medical diagnosis, which the system may determine from a customizable decision table. Further, the system may receive selection of a potential medical service from the identified potential medical services, and present an automated, real-time indication regarding paying entity/plan coverage and estimated cost and/or quality metrics for the selected medical service based on the patient and paying entity/plan of the patient. In addition, the system may facilitate selection of a lab/facility to perform the selected medical service. To communicate across clinicians, labs/facilities and paying entities, the system may employ a catalog of medical services spanning multiple clinicians, labs/facilities or paying entities/plans to thereby integrate their nomenclatures, and may employ a coding system in this regard.

### CROSS-REFERENCE TO RELATED APPLICATIONS

The present application claims priority to U.S. Provisional Patent Application No. 60/974,319, entitled: Diagnostics Benefits Management and Decision Support System, and Associated Method and Computer-Readable Storage Medium, filed on Sep. 21, 2007, the content of which is incorporated herein by reference.

### FIELD OF THE INVENTION

The present invention generally relates to systems and methods for providing medical services, and more particularly, to systems and methods for determining, or facilitating determination of, appropriateness of medical procedures and an appropriate lab/facility to provide medical services to patients.

### BACKGROUND OF THE INVENTION

In today's medical industry, there is currently a lack of informational transparency at the point of care of patients regarding the appropriate use, coverage and cost, and efficient ordering of diagnostic tests, services and procedures. As a result, the total cost of care is often increased, system performance is often suboptimal, and medical decisions associated with unnecessary or inappropriate testing or procedures and their outcomes may decrease the overall quality of care.

### SUMMARY OF THE INVENTION

In light of the foregoing background, exemplary embodiments of the present invention provide an improved system and method for determining or facilitating determination of medical services and an appropriate lab/facility to provide medical services to patients. In this regard, exemplary embodiments of the present invention may be implemented by medical practitioners through a set of networked services to access evidence-based care guidelines, compare and contrast the appropriateness, coverage, cost, and quality of diagnostic/service options, interact with the paying entity and servicing lab/facility, and choose efficient medical processes. The networked services may be built on a formulary including a meta-catalog service, a coverage determination service, a payment estimation and determination service, and a servicing lab/facility selection service.

The meta-catalog service may be configured to implement a classification and coding system that provides a unique, universal code for each test/analyte to all users. This coding system may automatically generate, for a selected medical service, a unique code having a level of specificity or granularity in line with that of the respective service, as may be described at entry to the catalog with variables such as medical appropriateness or necessity. The meta-catalog may also be configured to implement a mapping system to link similar tests and services to each other within the content store. The coverage determination service may be configured to implement medical necessity rules, eligibility, payment, contract, and benefits rules in a configurable and customizable format to show and automate coverage determination and/or authorization in an automated, real-time or rapid manner. The payment estimation and determination service may be configured to forecast and/or determine patient, physician, payor, or diagnostic facility financial responsibility for anticipated services. The servicing lab/facility selection service may be configured to display, according to configurable rules, the options and characteristics of those options for where a test/service can be performed and/or by which entity.

Various embodiments of the present invention may also include a system analytics and system optimization service that may be configured to store and otherwise interact with data, for example, to implement reporting features. In this regard, data collected during service transactions provides for system analytics by each stakeholder who uses the system, and the system analytics may be analyzed to facilitate general reporting, system optimization, and/or rules configuration. In this regard, a rules configuration interface may be included and configured to create, review, edit, and test rules provided by each stakeholder who uses the system. Further, a system optimization service may be configured to use data analytics and rules configuration to improve healthcare outcomes and profitability by and for each stakeholder.

Exemplary embodiments of the present invention may provide the opportunity for a medical practitioner to view a patient's history, select a diagnosis, select a service from a meta-catalog, understand coverage rules for this service, check medical appropriateness, process any coverage requirements, estimate and determine financial responsibility, weigh attractiveness of available service providers, place an order, receive results, and view reports to improve decision making and implement appropriate controls. Exemplary embodiments may also enable the paying entity, the servicing lab/facility, and/or patient to interact with the system to provide data and configure rules for the processes and services described above.

As indicated above and explained below, the system and method of exemplary embodiments of the present invention may solve the problems identified by prior techniques and may provide additional benefits.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a diagnostics benefits management and decision support system in accordance with exemplary embodiments of the present invention;

FIG. 2 is a schematic block diagram of an apparatus that may be configured to operate as a patient, clinician, lab/facility, payor and/or service provider, in accordance with embodiments of the present invention;

FIG. 3 is a functional block diagram of the diagnostics benefits management and decision support system in accordance with exemplary embodiments of the present invention;

FIG. 4 is a functional block diagram of networked services according to exemplary embodiments of the present invention;

FIG. 5 is a flowchart including various steps in a method according to exemplary embodiments of the present invention;

FIGS. 5a-5i, illustrate flowcharts including various steps in a method of determining or facilitating determination of medical procedures and a lab/facility for effectuating those or other procedures, according to exemplary embodiments of the present invention;

FIGS. 6-21 illustrate exemplary parties carrying out the system and method of exemplary embodiments, and exemplary user interface displays that may be presented to those parties (e.g., by the respective parties processing elements), according to exemplary embodiments of the present invention;

FIG. 22 is an illustration of the meta-catalog and the underlying components

FIG. 23 is an illustration of system rules relationships according to exemplary embodiments of the present invention;

FIGS. 24 and 25 are illustrations of overviews of the clinician aspects of exemplary embodiments of the present invention;

FIG. 26 is an illustration of an overview of the lab/facility aspects of exemplary embodiments of the present invention;

FIG. 27 is an illustration of an overview of the payor aspects of exemplary embodiments of the present invention;

FIGS. 28 and 29 are overview listings of various networked services according to exemplary embodiments of the present invention;

FIG. 30 illustrates an example benefit coverage service according to exemplary embodiments of the present invention;

FIGS. 31 and 32 and 32a-b illustrate decision tables and decision trees according to exemplary embodiments of the present invention;

FIG. 33 is a list of example networked services according to exemplary embodiments of the present invention;

FIG. 34 illustrates a provider and payer workflow according to exemplary embodiments of the present invention;

FIG. 35 depicts a list of coverage determination inputs ands rules according to exemplary embodiments of the present invention; and

FIGS. 36 and 37 illustrate a classification nomenclature according to exemplary embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

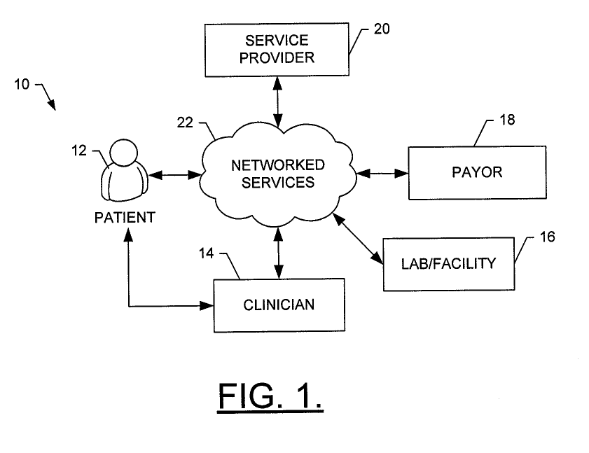

Referring to FIG. 1, a diagnostics benefits management and decision support (DBM) system 10 for providing choice and transparency to the world of medical procedures for its users, including one or more patients 12, clinicians 14, labs or other facilities 16, payors 18, and service providers 20 (one of each being shown). Although shown and described herein in terms of “medical procedures,” it should be understood that exemplary embodiments of the present invention may generally apply to medical services, some of which may or may not be considered procedures.

The patients 12, clinicians 14, facilities 16, payors 18 and/or service providers 20 can be configured to directly and/or indirectly communicate with one another across one or more networked services 22. The networked services can comprise any of a number of different combinations of one or more different types of networks, including social, data and/or voice networks. For example, the network(s) can include one or more data networks, such as a local area network (LAN), a metropolitan area network (MAN), and/or a wide area network (WAN) (e.g., Internet), and include one or more voice networks, such as a public-switched telephone network (PSTN). Although not shown, the network(s) may include one or more entities or switches for relaying data, information or the like between the patients, clinicians, facilities, payors and service providers.

The patients 12, clinicians 14, labs/facilities 16, payors 18, and service providers 20 can comprise any one or more of a number of different entities, devices, or the like configured to operate in accordance with embodiments of the present invention. In this regard, one or more of the patients, clinicians, facilities, payors, and service providers can comprise, include, or be embodied in one or more processing elements, such as one or more of a laptop computer, desktop computer, server computer or the like. Additionally or alternatively, one or more of the patients, clinicians, facilities, payors and service provider can comprise, include or be embodied in one or more portable electronic devices, such as one or more of a mobile telephone, portable digital assistant (PDA), pager or the like. For example, the patients, clinicians, facilities, payors and/or service provider can each comprise a processing element configured to communicate with one another across the Internet (e.g., network 22). In one exemplary scenario, for example, each of one or more of the clinician, lab/facility or payor may comprise a number of processing elements networked with one another across a LAN, and networked with processing elements of the others of the clinician, lab/facility, payor and service provider across the Internet.

It should be understood, however, that one or more of the patients 12, clinicians 14, labs or other facilities 16, payors 18, and service provider 20 can comprise or otherwise be associated with one or more users carrying out the functions of the respective entity. For example, the patient can comprise a user communicating across a PSTN (e.g., included in networked services 22) or in person with a clinician (or another user acting on behalf of a clinician) operating one or more clinician processing elements, where the clinician and respective processing element(s) collectively comprise the clinician. Similarly, for example, the patient can comprise a user communicating across a PSTN, or a user communicating in person with a lab/facility user operating one or more lab/facility processing elements, where the lab/facility user and respective processing element(s) collectively comprise the lab/facility. As explained herein, then, the term “patient” may refer to a patient himself/herself (e.g., a consumer or client) or user acting on behalf of a patient, and/or one or more patient processing elements. Similarly, a “clinician” may refer to a clinician or user acting on behalf of a clinician (e.g., an office administrator) and/or one or more clinician processing elements; a “lab/facility” may refer to a user acting on behalf of the lab/facility and/or one or more lab/facility processing elements. Further, “payor” may refer to a payor, a paying entity, or user acting on behalf of a payor or paying entity, and/or one or more payor processing elements; and an “service provider” may refer to an service provider (or user acting on behalf of a service provider) and/or one or more service provider processing elements.

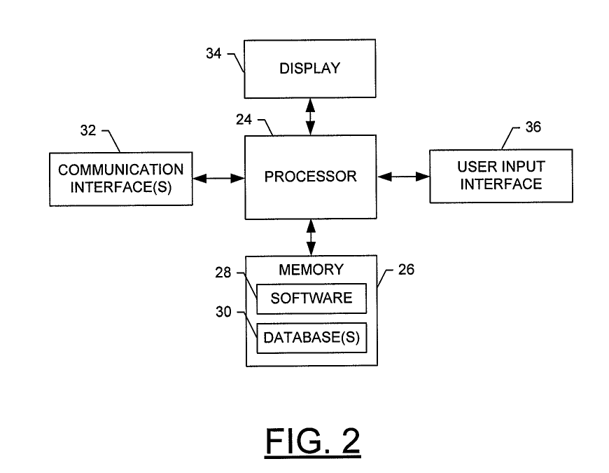

FIG. 2 illustrates a block diagram of an entity configured to operate as a patient 12, clinician 14, lab/facility 16, payor 18 and/or service provider 20, or more particularly their respective processing element(s) in accordance with exemplary embodiments of the present invention. Although shown as separate entities, in some embodiments, one or more entities may support one or more of a patient, clinician, lab/facility, payor and service provider, logically separated but co-located within the entit(ies). For example, a single entity may support a logically separate, but co-located, clinician and lab/facility. Also, for example, a single entity may support a logically separate, but co-located clinician and/or service provider.

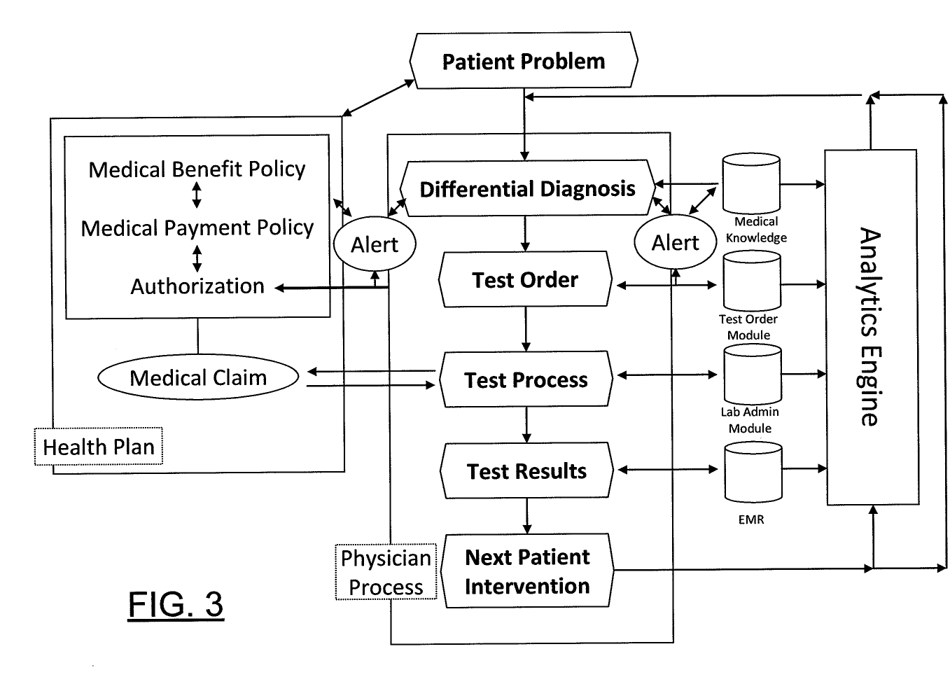

The entity configured to operate as a patient 12, clinician 14, lab/facility 16, payor 18 and/or service provider 20 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, the entity can include a processor 24 connected to a memory 26. The memory can comprise volatile and/or non-volatile memory, and typically stores content, rules, data or the like. In this regard, the memory may store software applications 28, instructions or the like for the processor to perform steps associated with operation of the entity in accordance with embodiments of the present invention. The memory may also store content transmitted from, and/or received by, one or more of the entities. More particularly for various interactions of the patient, clinician, lab/facility, payor and/or service provider, the memory may store one or more databases 30 for storing various pieces of information, such as information associated with one or more patients. As described herein, the software application(s) may each comprise software operated by the respective entities. It should be understood, however, that any one or more of the patient applications described herein can alternatively comprise firmware or hardware, without departing from the spirit and scope of the present invention.

In addition to the memory 26, the processor 24 can also be connected to at least one interface or other means for displaying, processing, analyzing, transmitting and/or receiving data, content or the like from one or more of the entities, possibly concurrently. In this regard, the interface(s) can include at least one communication interface 32 or other means for transmitting, configuring, processing, and/or receiving data, rules, content, or the like. In addition to the communication interface(s), the interface(s) can also include at least one user interface that can include one or more earphones and/or speakers, a display 34, and/or a user input interface 36. The user input interface, in turn, can comprise any of a number of devices allowing the entity to receive data from a user, such as a microphone, a keypad, a touch display, a joystick, or other input device.

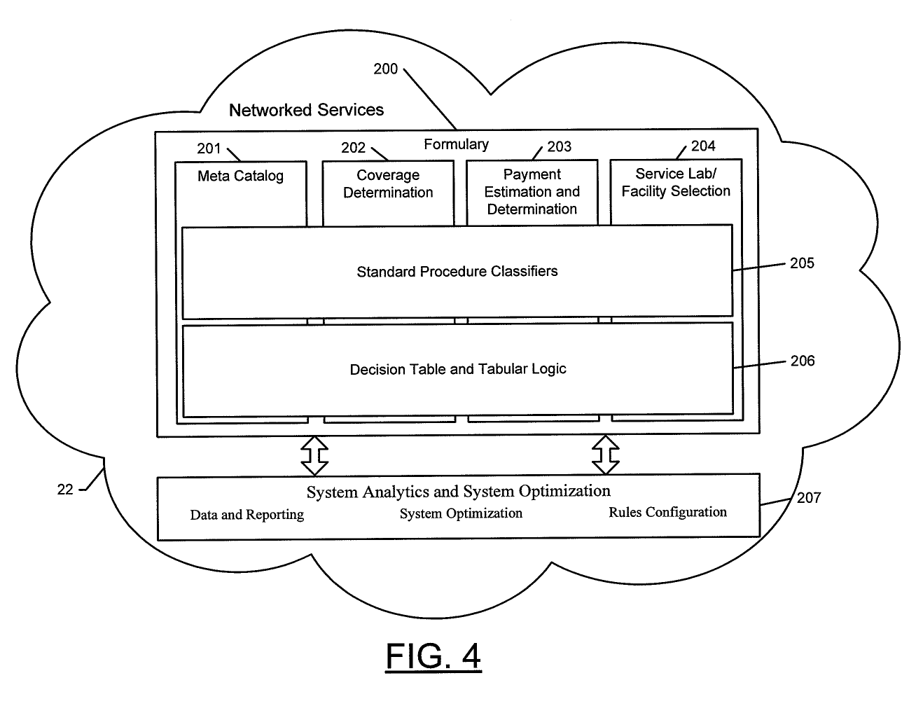

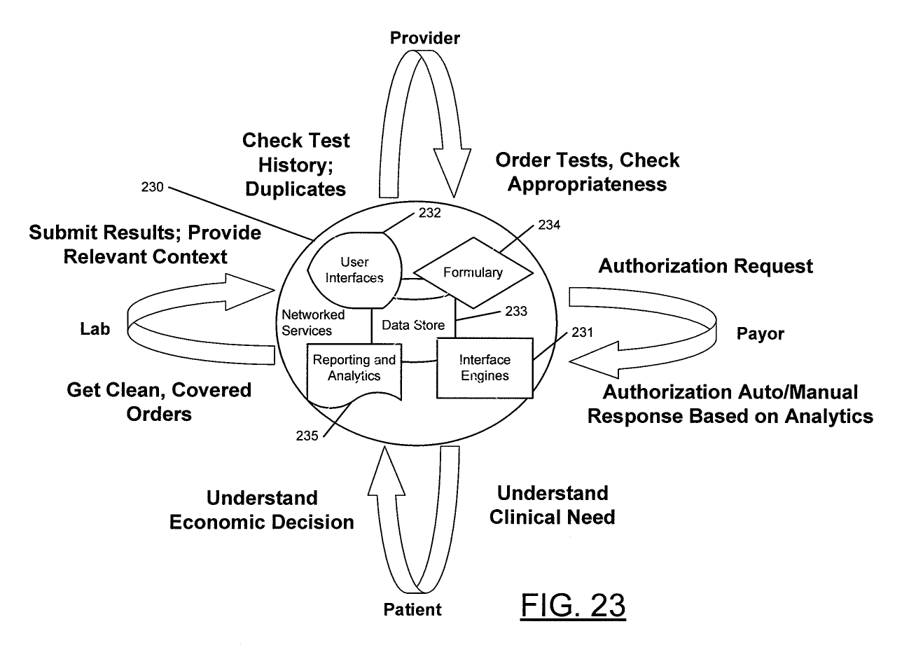

One or more patients, clinicians, labs or other facilities, payors, or service providers can access the system through the set of networked services 22 (a detailed version of which is depicted in FIG. 4) that may join multiple support, clinical, and/or financial tasks in the medical industry into one set of services. Another representation of a set of networked services that may join multiple support, clinical, and/or financial tasks in the medical industry into one set of services is depicted in FIG. 23.

Reference is now briefly made to FIG. 3, which illustrates one functional block diagram of a system and method according to exemplary embodiments of the present invention. As shown, the system and method of exemplary embodiments of the present invention bring choice and transparency to the world of medical procedures for its users, whether the patient, clinician, lab/facility, payor, or service provider. Generally, exemplary embodiments of the present invention perform or otherwise facilitate performance of three functions via formulary, namely (1) determining appropriateness and appropriate alternatives to a particular medical procedure, (2) determining its cost and coverage per that patient based on the paying entity's rules, and (3) offering the various labs/facilities where that procedure can be conducted and their associated characteristics. In this regard, the system may be configured to perform or otherwise facilitate performance of these and any other appropriate functions based on a number of business and/or clinical rules or other requirements that may be obtained or otherwise derived from information obtained from the patient 12, clinician 14, lab/facility 16, payor 18, and/or service provider 20, where these business rules may be implemented by one or more entities and/or analytics engines.

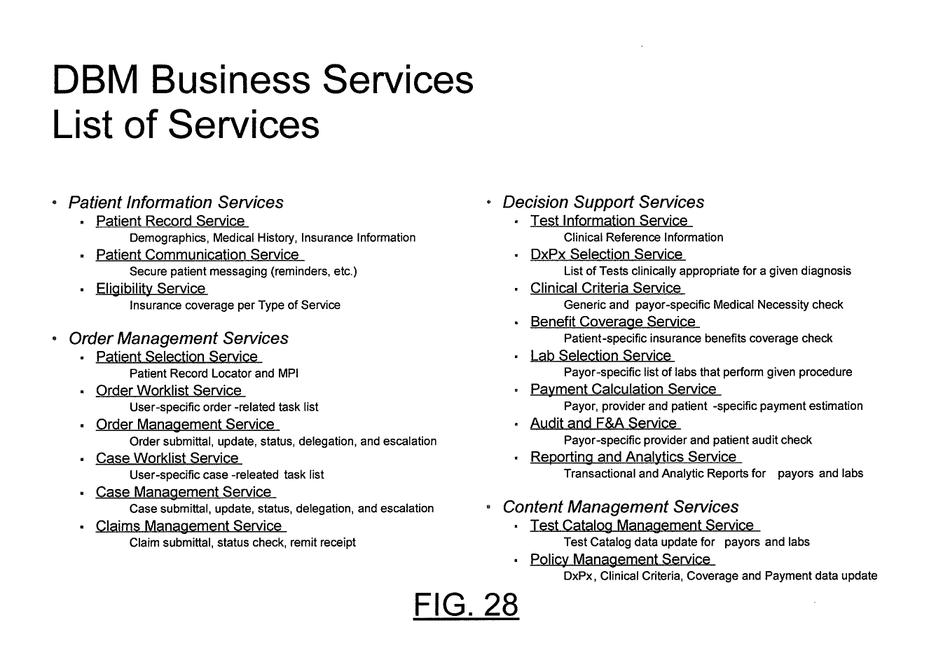

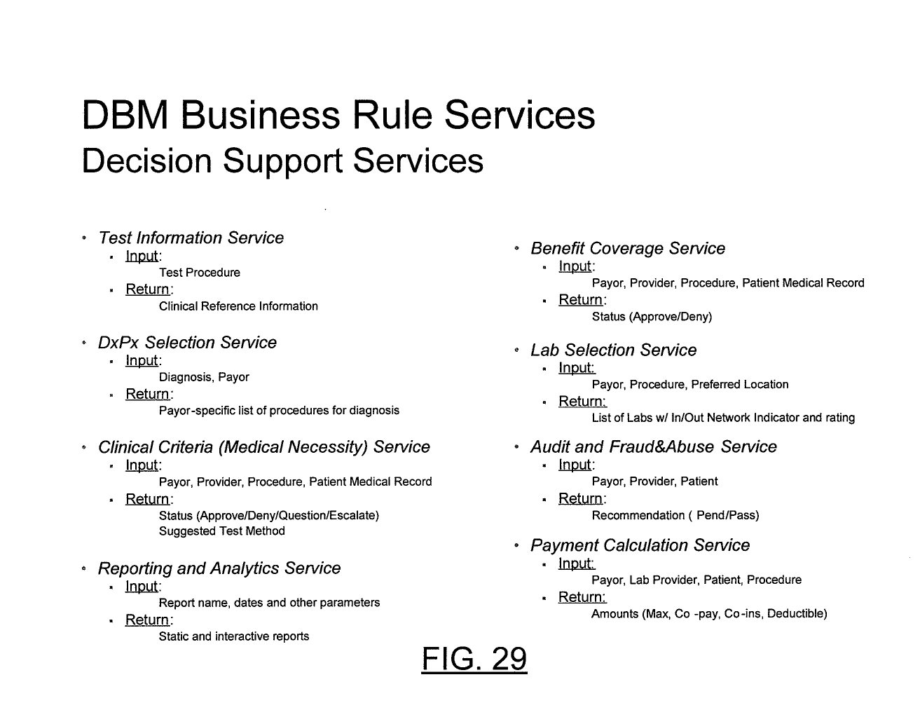

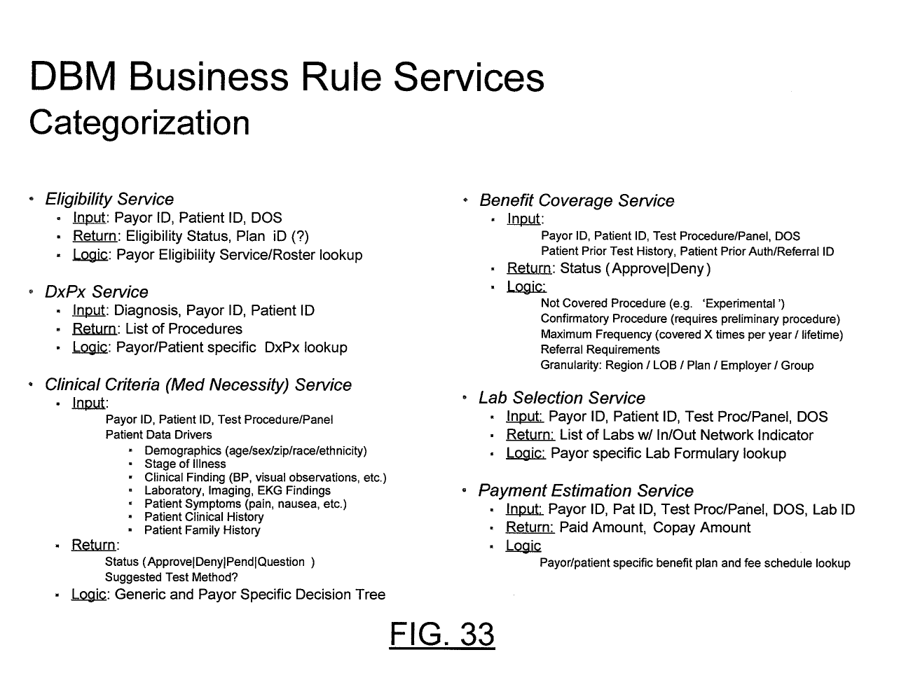

In performing or facilitating performance of the above functions, the service provider 20 of exemplary embodiments of the present invention, connects patients 12, clinicians 14, labs/facilities 16 and payors 18 through one intelligent, transparent, transaction system that facilitates their interactions. In doing so, robust data may be collected and used for various analytics, reporting, and management services. In accordance with exemplary embodiments, the system may be implemented as a stand-alone solution; or some, if not all, of the system may be integrated into one or more internal and/or external healthcare product tools such as computerized physician order entry tools (CPOE), electronic medical records (EMR), Practice Management Systems (PMSs), Care Management Systems (CMSs), Utilization Management Systems (UMSs), online healthcare sites and applications, Health Information Systems (HISs) like lab/facility information systems (LISs, RISs, PACs) and other lab/facility applications, payor claims management systems, consumer sites, healthcare portals, or the like. In this regard, the system of exemplary embodiments of the present invention may aggregate data across a number of different systems (which may span across multiple patients, clinicians, labs/facilities and/or payors) and/or platforms and perform functions with respect to that data, as explained in greater detail below. The system in some respects may be implemented as a collection of electronic services provided by the service provider that implements rules and logic based on this configuration and aggregation of data by respective entities to produce relevant outputs to the patients, clinicians, labs/facilities and/or payors. These services may be implemented by their own interfaces to the relevant entities, but may alternatively be “headless” in that they may be implemented without their own specific visual user interface to the relevant entities. An overview of a potential but not exhaustive list of networked services are contained in FIGS. 28 and 29. Several of these services are provided as examples in FIG. 33.

Reference is now made to FIG. 4, which illustrates various attributes and configurations of the entities included within the networked services 22. In this regard, a formulary 200 may include and be the central hub for a meta-catalog service 201, coverage determination service 202, payment estimation and determination 203, and/or servicing lab/facility selection service 204. Outputs of the meta-catalog service, the coverage determination service, the payment estimation and determination, and/or the servicing lab/facility selection service may be channeled to users (e.g., patients 12, clinicians 14, labs/facilities 16, payors 18, and/or service providers 20). For example, the formulary may provide the data and business, clinical, financial, and administrative rules necessary for a clinician to view a patient's history, select a diagnosis, select a service from a meta-catalog, understand coverage rules for this service, check medical appropriateness, process any coverage requirements, estimate and determine financial responsibility, weigh attractiveness and suitability of available service providers, place an order, receive results, and review reports against aggregate transactions and system performance. This formulary is informed by rules and data contributed by each entity (e.g., patients, clinicians, labs/facilities, payors, and/or service providers) to ensure optimal system performance.

The formulary may contain data and rules from the patient 12, clinician 14, lab/facility 16, payor 18, and/or service provider 20, and system rules that may automate interactions with these data and rules. An example of this can be seen in FIG. 23, where the constituents may be connected by networked services 230 via the use of an interface engine 231 and/or user interface 232; the transactional and historical data from each constituent may be captured in a data store 233; the networked services may be governed by the formulary 234 and housed in the formulary's meta-catalog; coverage determination, payment estimation and determination; and lab/facility selection, and the use of networked services may be reported, analyzed and optimized by a reporting and analytics module 235.

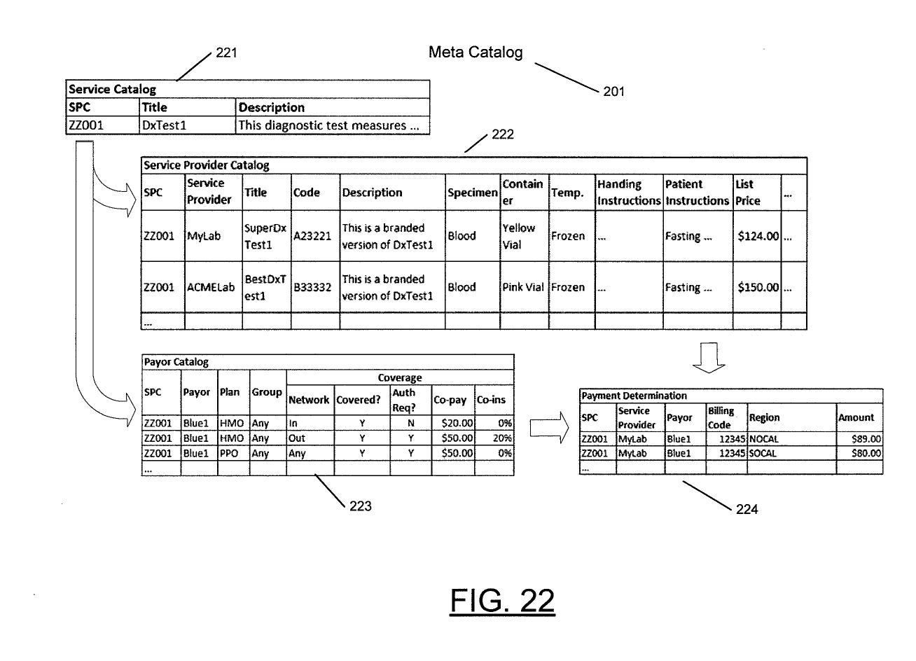

Referring back to FIG. 4, the formulary 200 processes of selecting diagnoses, services, and providers may be facilitated by a meta-catalog 201. The meta-catalog may be a coding and classification system that classifies and provides a unique, universal code for each test/analyte/procedure (each may be generally a “medical service”) to all users. The meta-catalog may also be a mapping system to link similar tests and procedures to each other within a data store 233 as shown in FIG. 23, and which may also be included in the networked services 22. The meta-catalog may allow patients 12, clinicians 14, labs/facilities 16 and payors 18 (who may have different naming and coding conventions for tests and procedures) to identify, order, and bill for the appropriate test/procedure. Thus the meta-catalog may be a translational tool between the primary participants in the process including the ordering provider (e.g., clinician), the servicing provider (e.g., lab/facility), and the payor. The meta-catalog also may also map tests and procedures to appropriate Diagnosis (ICD-9 or higher) and Procedure/Test (CPT, SNOMED, LOINC, etc) codes. FIG. 22 depicts meta-catalog as a collection of tables. A service catalog table 221 may list each service/procedure/test under its unique Standard Procedure Classifier (SPC). A service provider catalog 222 may map the SPC to the service provider (e.g., lab/facility) by specific code or name, and may provide specific information about the test. A payor catalog 223 may provide the payor-specific coverage determination. A payment determination table 224 may map each SPC into one or more billing codes and amounts per service provider.

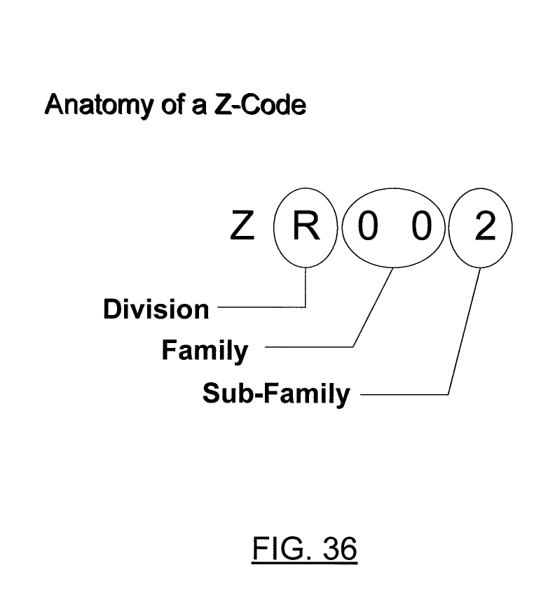

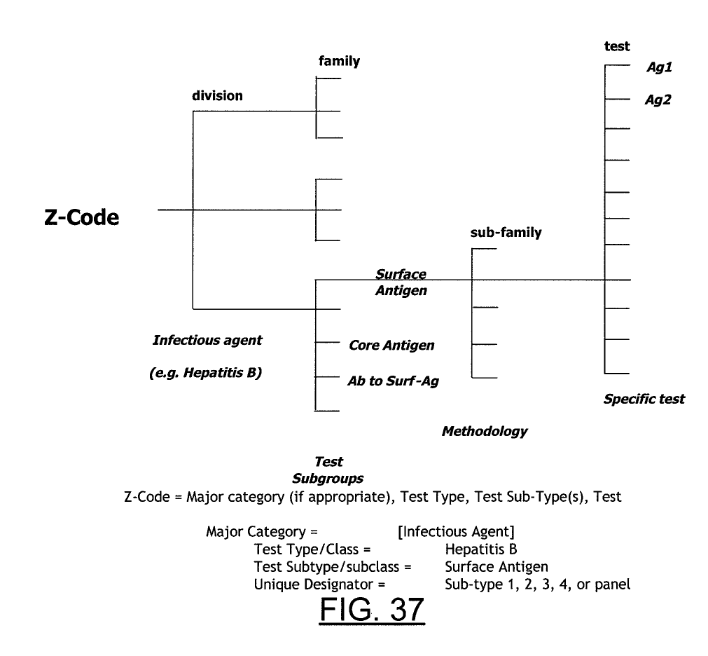

Returning to FIG. 4, and as indicated above, the meta-catalog 201 may also employ Standard Procedure Classifiers (SPCs) 205. SPCs are a nomenclature designed explicitly for identifying, selecting, ordering, and billing for tests/procedures/services with a multi-character alphanumeric code. In some exemplary embodiments, the SPC may start with a letter (e.g., “Z”). The specificity or granularity of the classification scheme is portrayed in FIGS. 36 and 37. In this regard, the meta-catalog service may be configured to automatically generate, for a selected medical service, a unique SPC having a level of specificity or granularity in line with a classification or other description of the respective service, as may be received at entry to the catalog with variables such as medical appropriateness or necessity. Thus, services defined with increasing specificity may have SPCs with increasing fine granularity (increasing hierarchical levels—see FIG. 37); and conversely, services defined with decreasing specificity may have SPCs with decreasing fine granularity. The coding scheme may therefore automatically incorporate the logic of the classification scheme into the coding algorithm and test/device description hierarchy, which may reduce or otherwise prevent undesirable duplicate service registrations. SPCs may allow patients 12, clinicians 14, labs/facilities 16 and payors 18 to attach a unique universal code to a specific test or procedure for communication throughout the industry and that the meta-catalog 201 may map to similar tests and procedures for purposes such as clinical, administrative, or financial transparency.

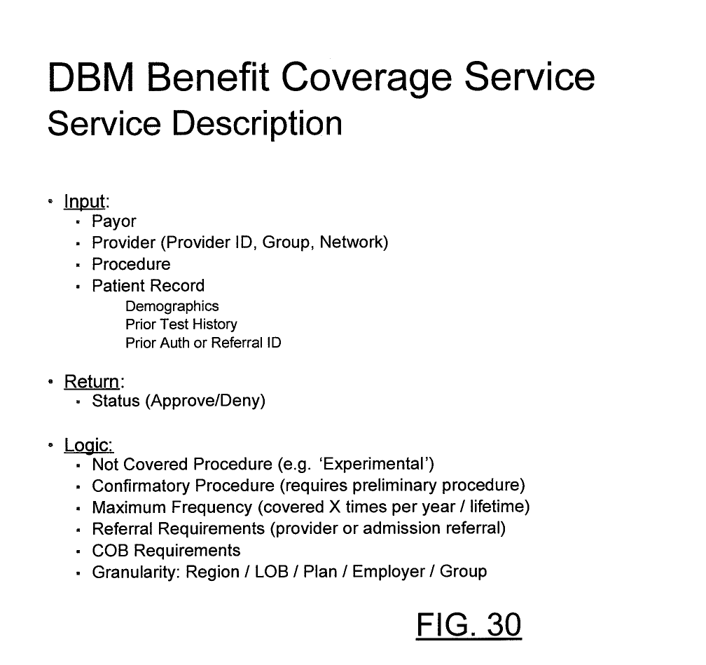

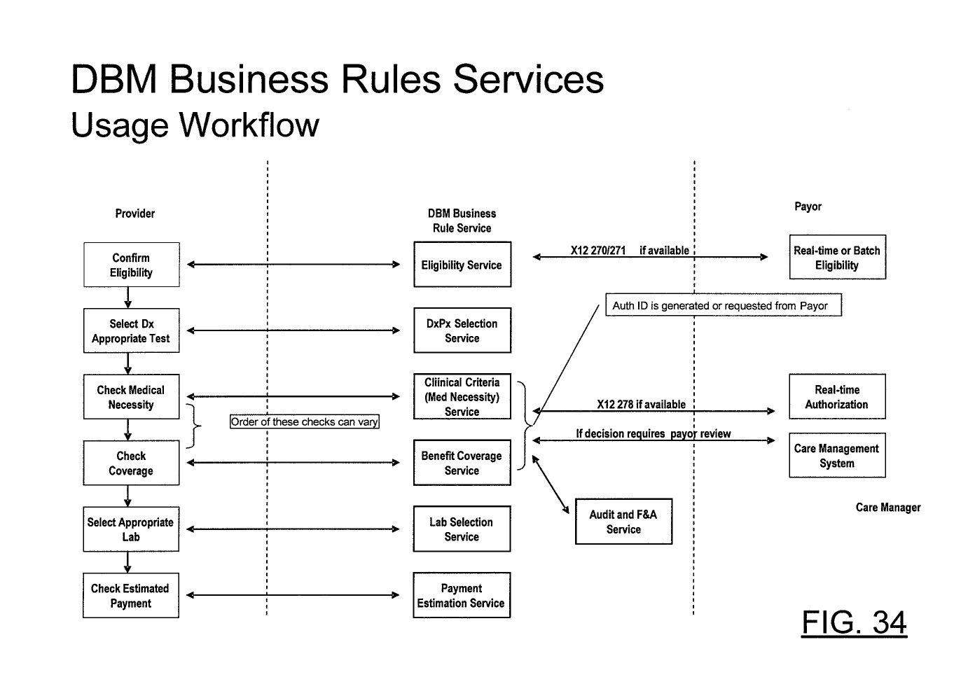

The formulary processes of understanding coverage rules for this service, checking medical appropriateness, and processing coverage requirements may be facilitated by coverage determination 202. An example of coverage determination is the benefit coverage service of FIG. 30, where the logic within coverage determination may be outlined to provide an example of the rules engine governing this service. Additionally, within FIG. 34, an example of the provider and payor workflow is shown, where a provider goes through a coverage determination process.

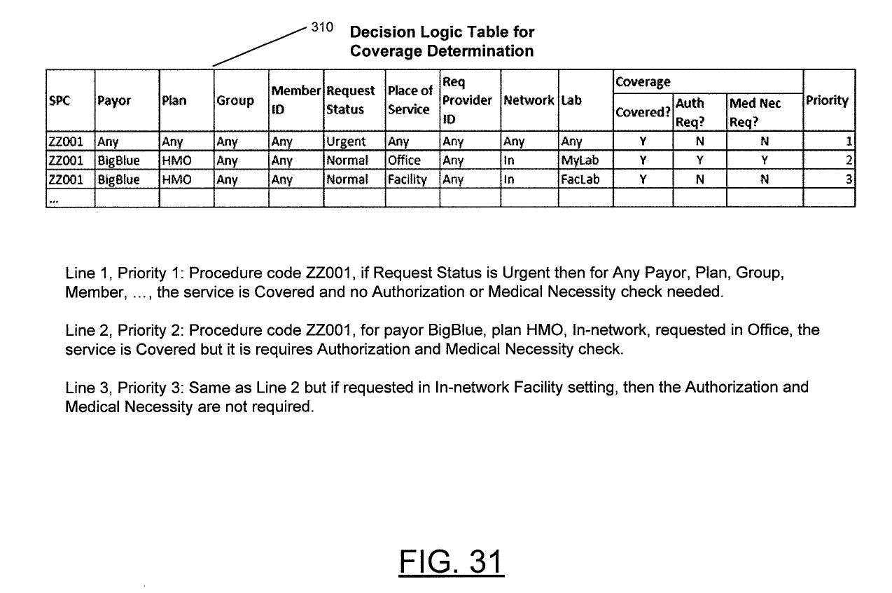

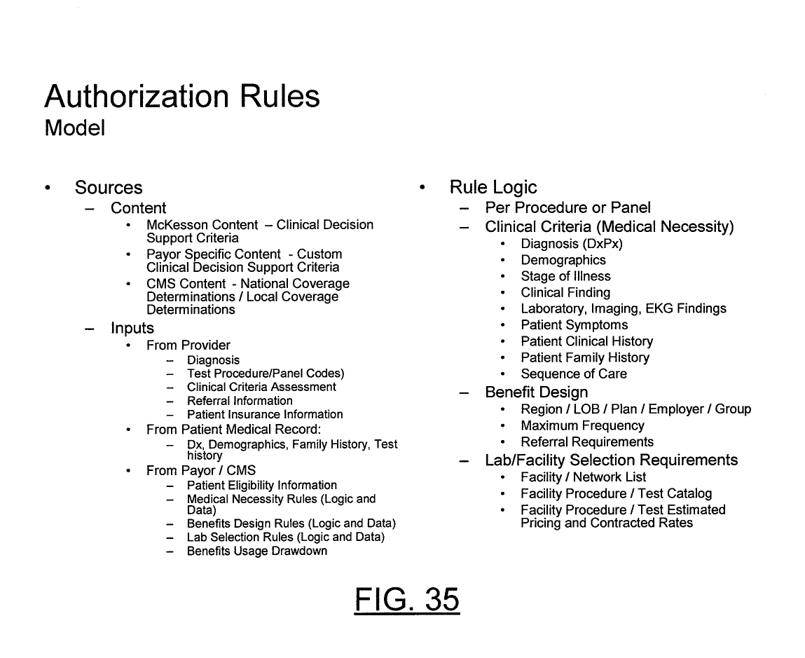

The formulary logic may use a decision table 206 format that may enable rapid customization and updates, as shown in FIG. 4. The decision table may take such inputs as payor coverage (benefits) information, answers to medical necessity questions, patients' order and claims history and other informational direct or indirect, automated or manual inputs from patients 12, clinicians 14, labs/facilities 16 and payors 18 and their systems and generate appropriate outputs and recommendations, such as, the service coverage determination, authorization requirements and payment estimation/determination. A sample decision table 310 is depicted on FIG. 31 and examples of inputs for the authorization requirement logic are depicted in FIG. 35.

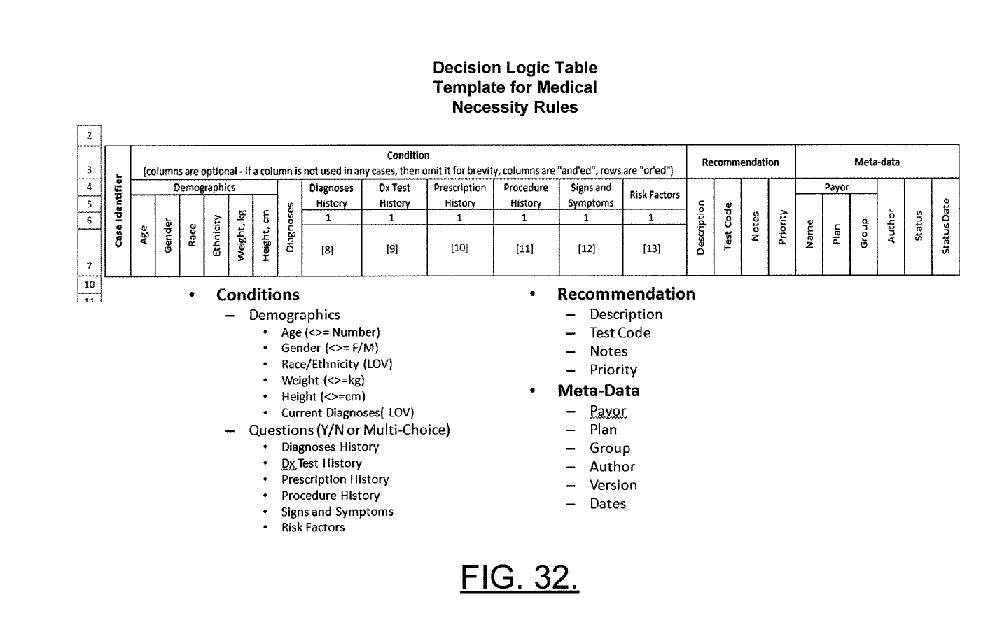

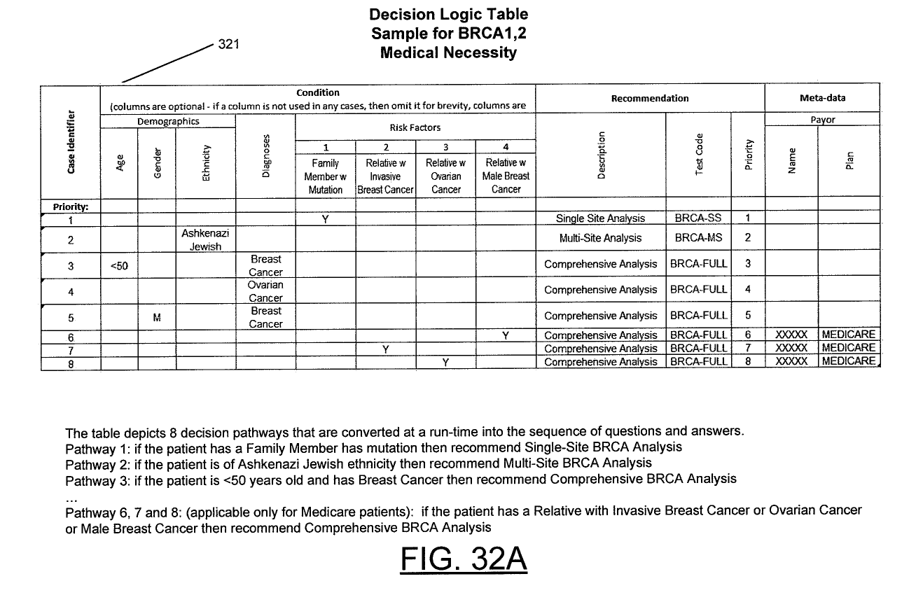

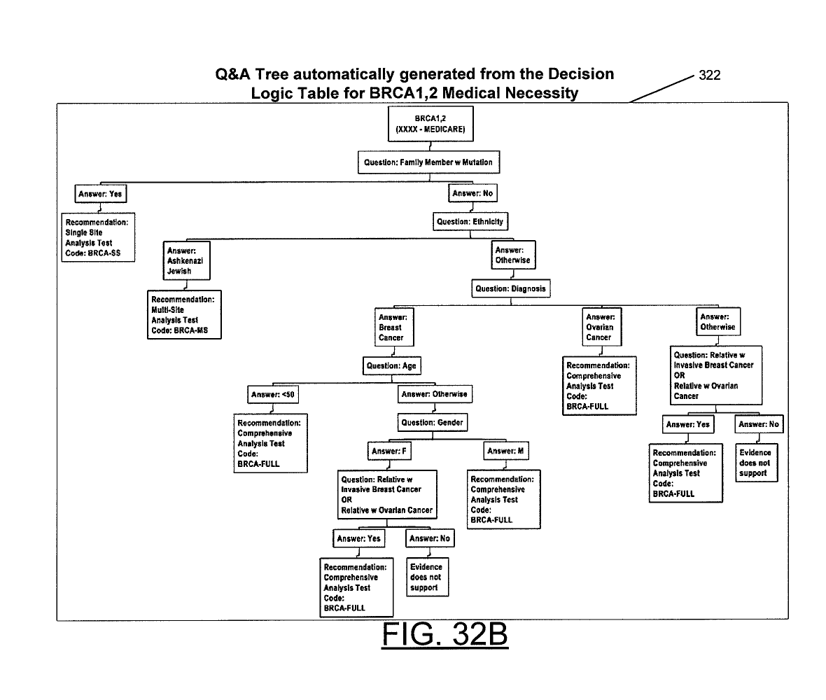

One part of the coverage determination logic may be a medical necessity check. The medical necessity rules may also be represented in a decision logic table format and may constitute a portion of exemplary embodiments of the invention, as shown in FIG. 32, 32A and 32B. Managing medical necessity rules with decision logic tables, may allow an automated process of developing, managing, and accessing content to provide rapid decision making and modifications to customers. FIG. 32 depicts a template 320 that may be used for medical necessity decision table. FIG. 32A depicts an example 321 of use of the decision logic template 320 for documenting and customizing the medical necessity rules for the molecular diagnostics test for certain types of breast cancer BRCA, at rows 1 and 2 as an example. The pathways at rows 6, 7 and 8 in 321 are applicable only for Medicare patients. This demonstrates the customization abilities of the use of decision logic tables for medical necessity rules. FIG. 32B depicts the questions/questionnaire 322 that may be automatically generated from the sample table 321. The coverage determination process may first attempt to resolve these questions 322 automatically, but if the process lacks the necessary information, it may pose these questions for the clinicians/office administrators 14 and/or patient 15.

The formulary process of estimating and determining financial responsibility may be facilitated by payment estimation and determination 203. The payment estimation and determination service may provide patients 12, clinicians 14, labs/facilities 16 and payors 18 with accurate information about the financial responsibility for the proposed next step in the care process, and may enable the ultimate adjudication and financial clearing for that responsibility.

The formulary process of weighing attractiveness and suitability of available service providers, understanding the cost and quality metrics, placing an order, and receiving results may be facilitated by service facility/lab selection 204. The service facility/lab selection service may provide patients 12, clinicians 14, labs/facilities 16, and payors 18 with objective and subjective information from across the networked services 22 about service providers 20 including, for example, the inclusion of a specific procedure in the facility's catalog and/or a quality metric of order turnaround time based on feedback from both patients and clinicians. Patients 12, clinicians 14, labs/facilities 16, and payors 18 may all benefit from this information exchange to ensure that they make optimized decisions regarding service providers.

The result of facilitating the above functions may be a rich data source which allows the system to provide patients 12, clinicians 14, labs/facilities 16, payors 18, and the service provider(s) 20 with appropriate analysis and rules configuration that can optimize the system's performance and stakeholder workflow. The data source may be complied and or generated by a system analytics and system optimization service 207. In this regard, the system analytics and system optimization service may provide for reporting of the data, system or stakeholder transaction optimization, and rules configuration and optimization. Additionally, this data can be used to improve health outcomes, clinical research, coverage, policy, and financial optimization, and spur new innovation within the market.

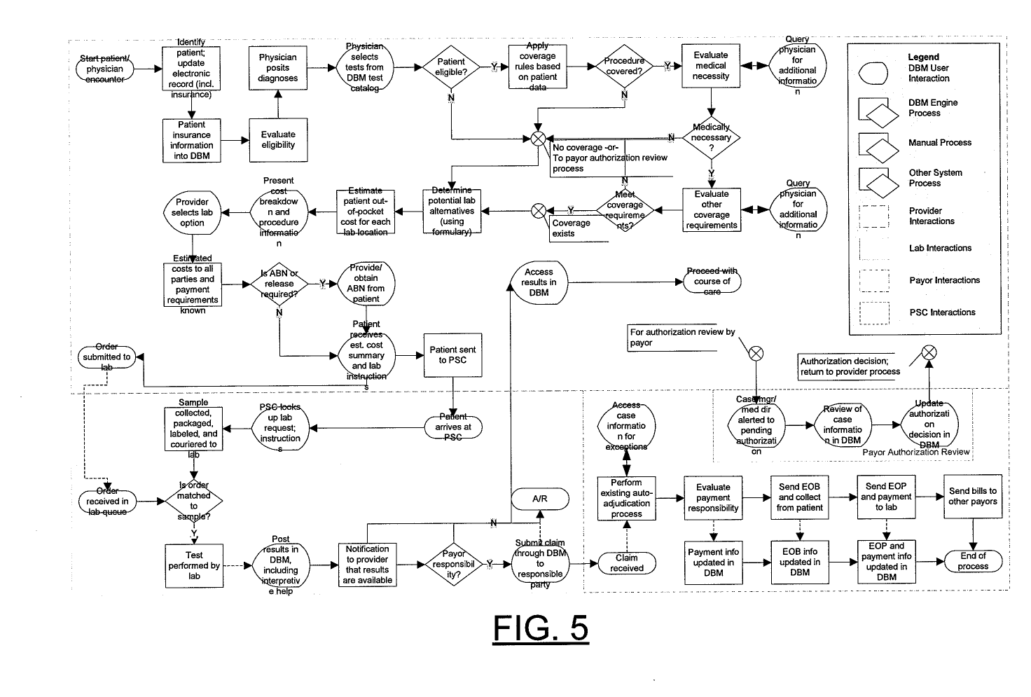

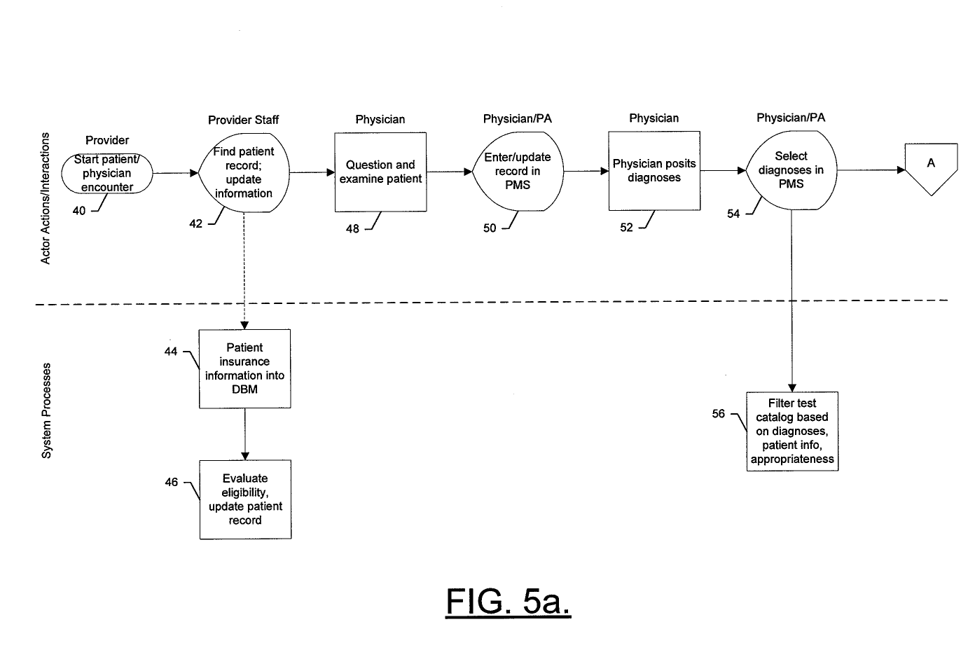

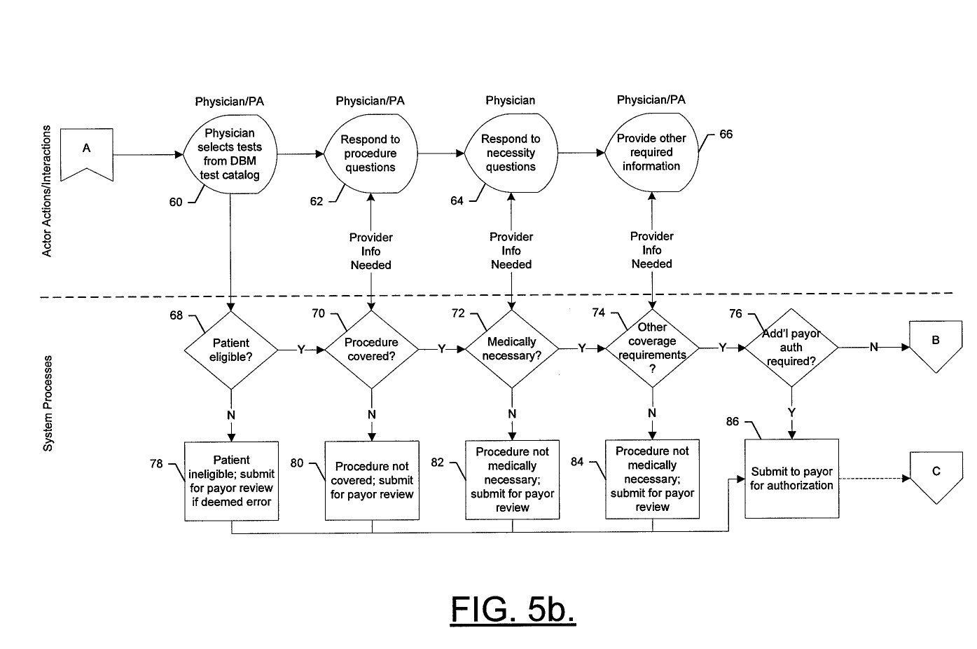

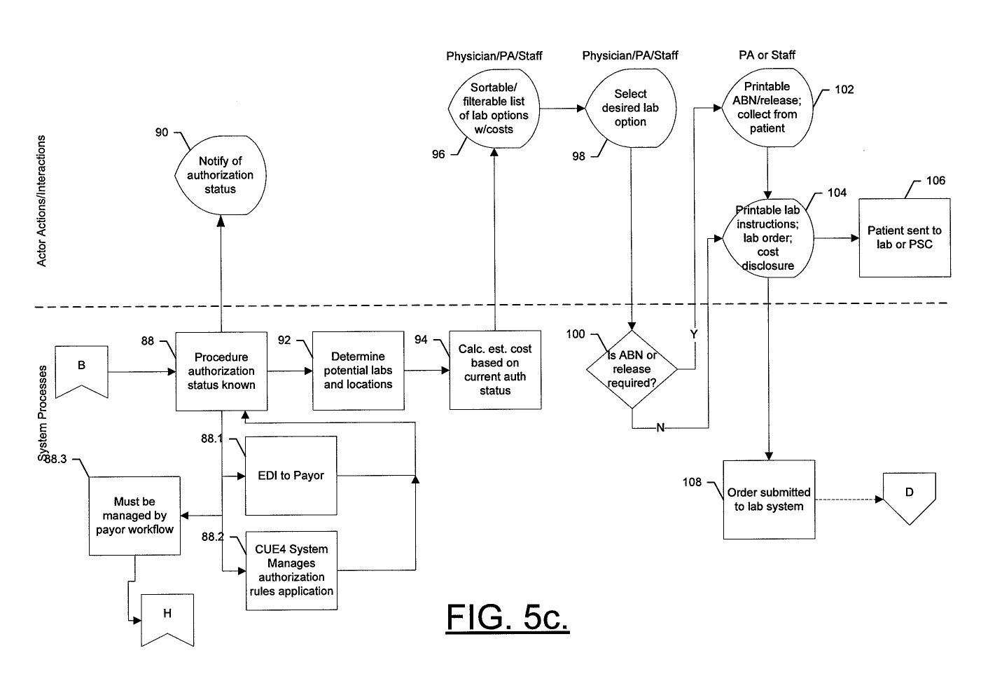

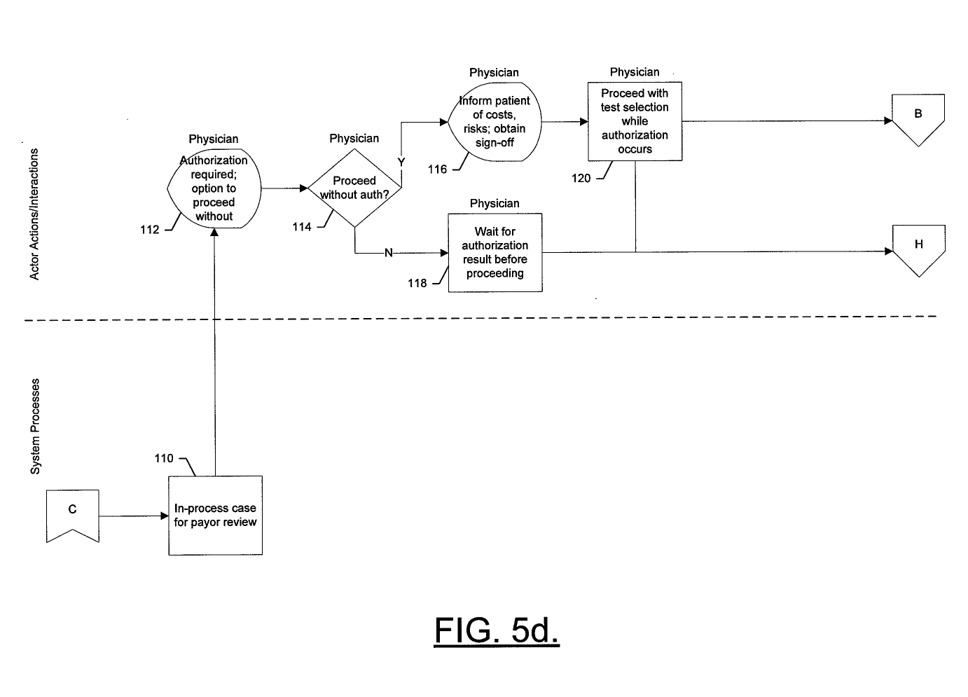

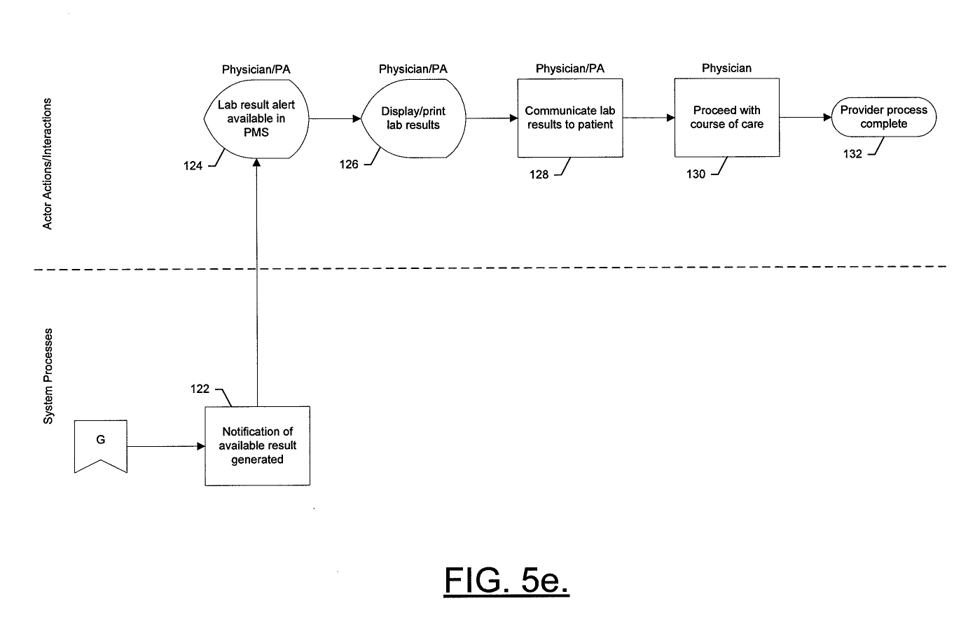

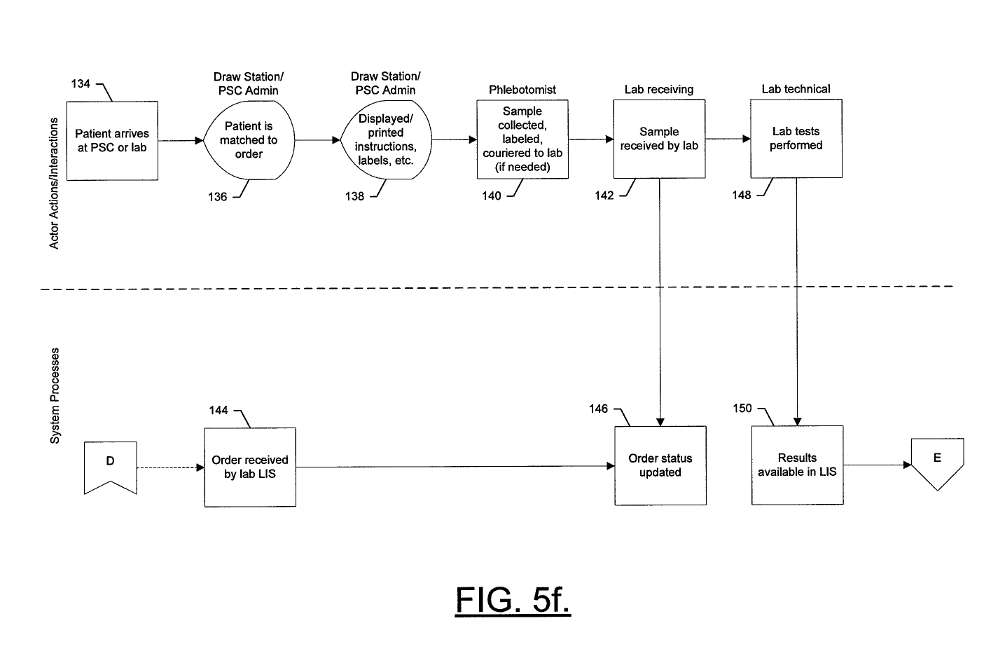

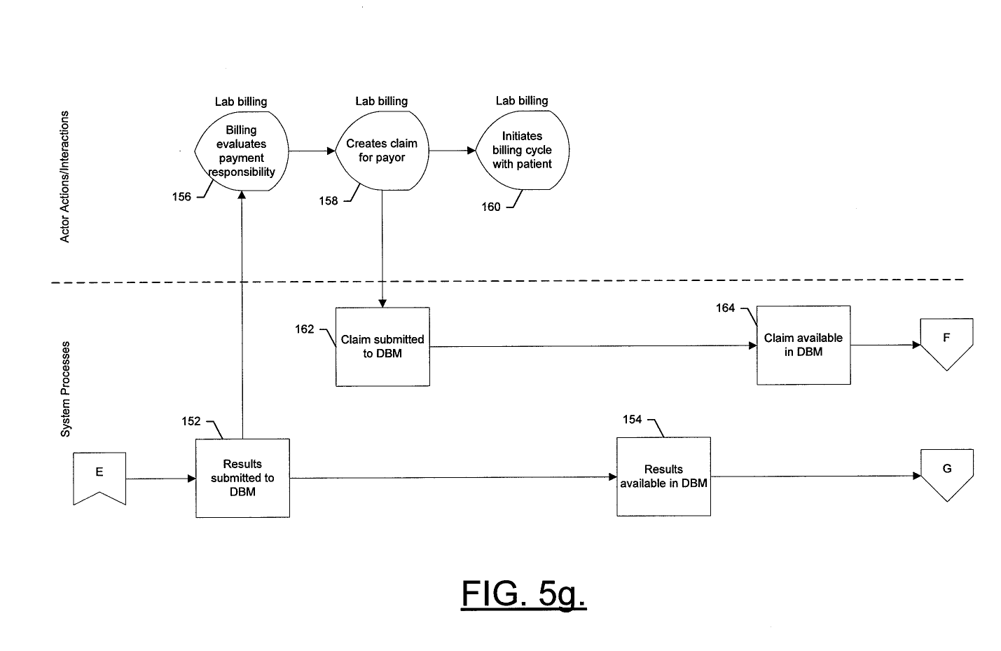

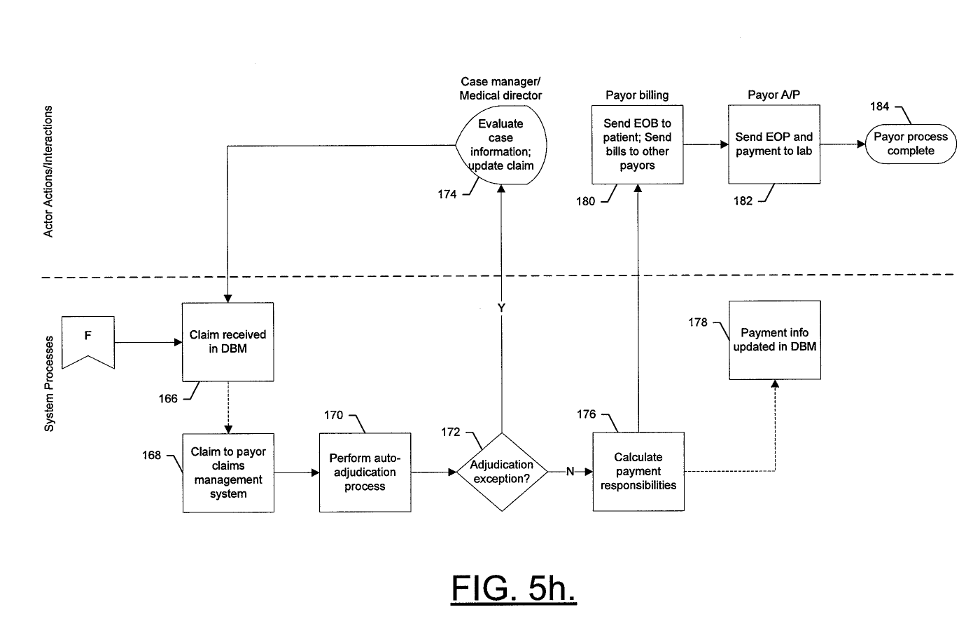

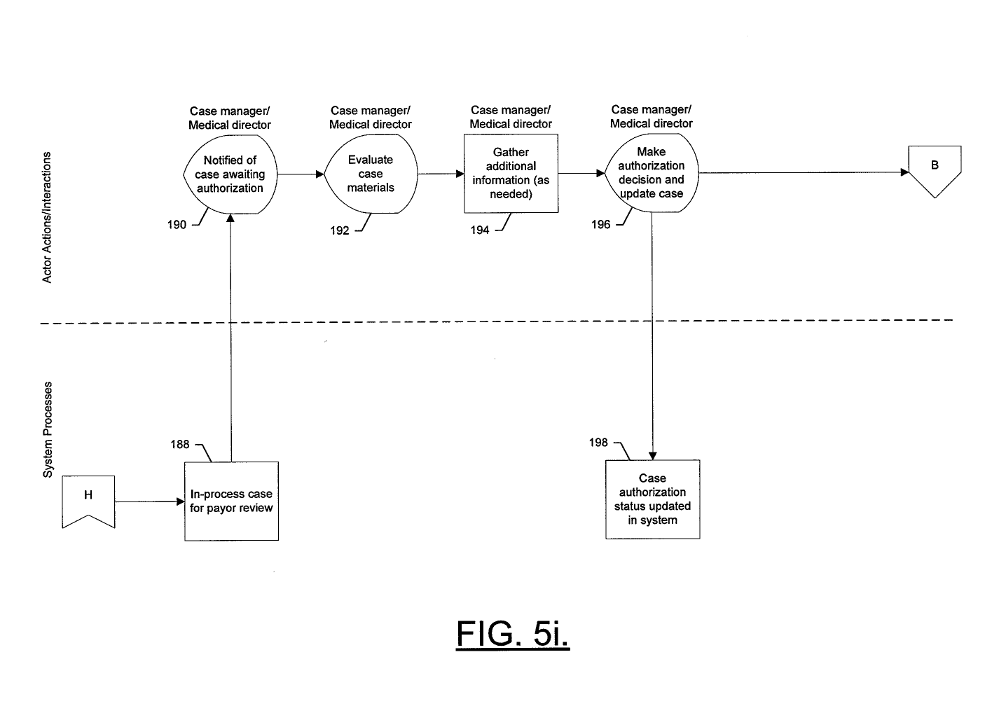

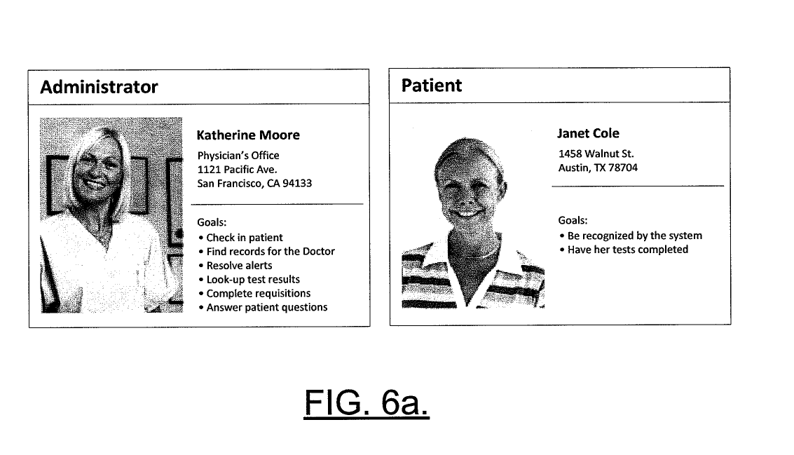

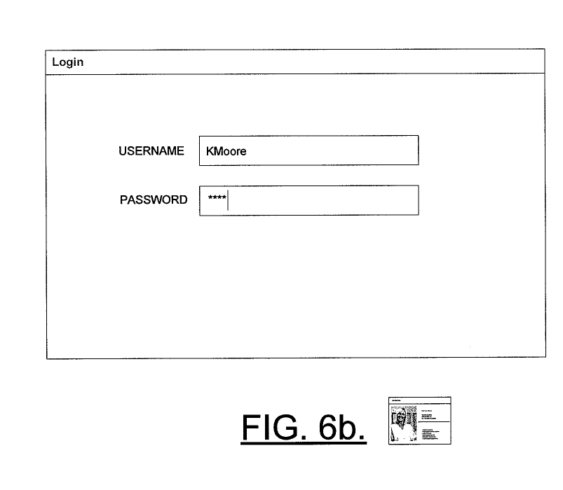

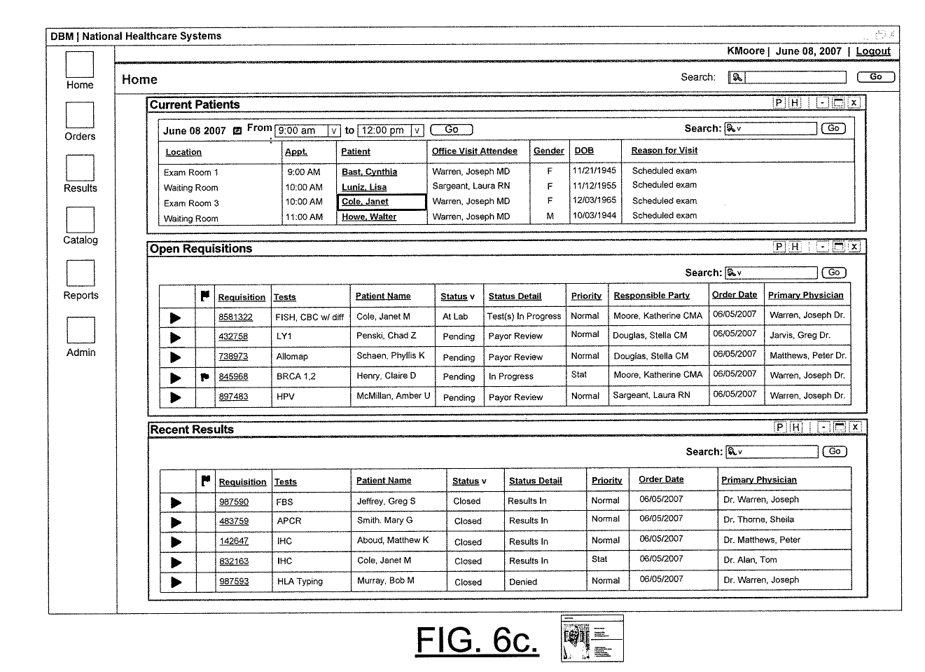

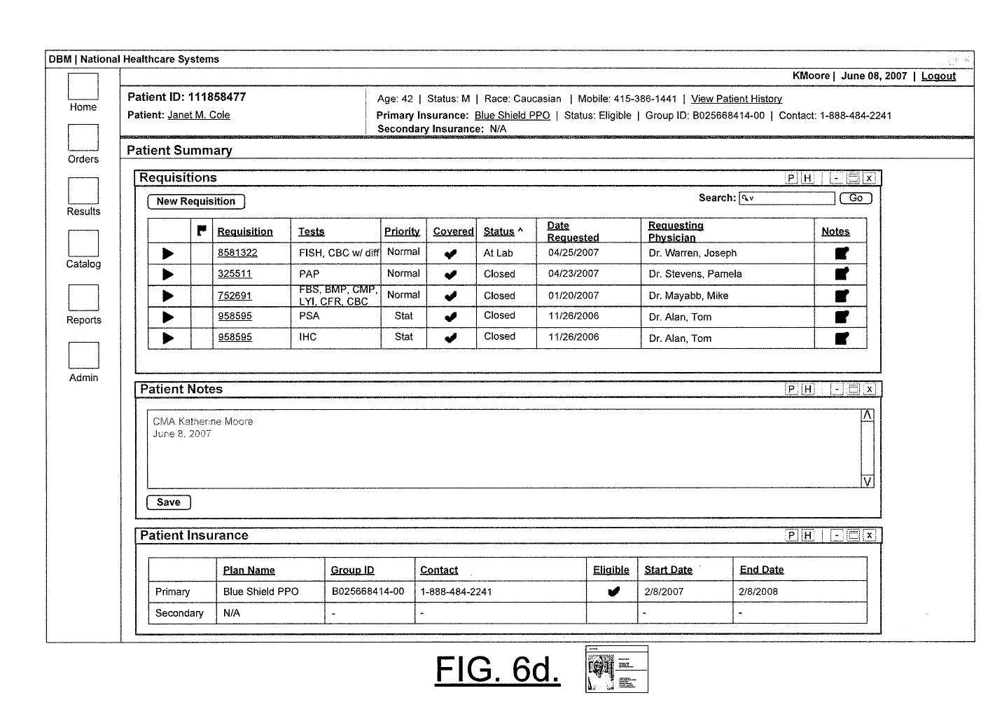

Reference is now made to FIGS. 5 and 5a-5i, which illustrate flowcharts including various steps in an exemplary method of selecting, determining, or facilitating determination of medical procedures and a lab/facility for effectuating those or other procedures according to various embodiments of the present invention. The method of FIGS. 5a-5i will be described herein in the context of a scenario in which a patient (e.g., patient 12) interacts with a physician and employees at the physician's office (e.g., clinician 14). The physician, or employees at the physician's office, and thus the patient, in turn, may interact with a lab or other facility (e.g., lab/facility 16), and the paying entity (e.g., payor 18) who may be providing some type of plan coverage to the patient such as an insurance company providing a health plan to the patient. In describing the method of FIGS. 5a-5i, reference will be additionally be made to FIGS. 6-21, which illustrate exemplary parties carrying out the system and method of exemplary embodiments, and exemplary user interface displays that may be presented to those parties (e.g., by the respective parties processing elements). It should be understood, however, that exemplary embodiments of the present invention may be equally applicable to other contexts involving other parties/entities that may function as a patient, clinician, lab/facility, payor, and/or service provider.

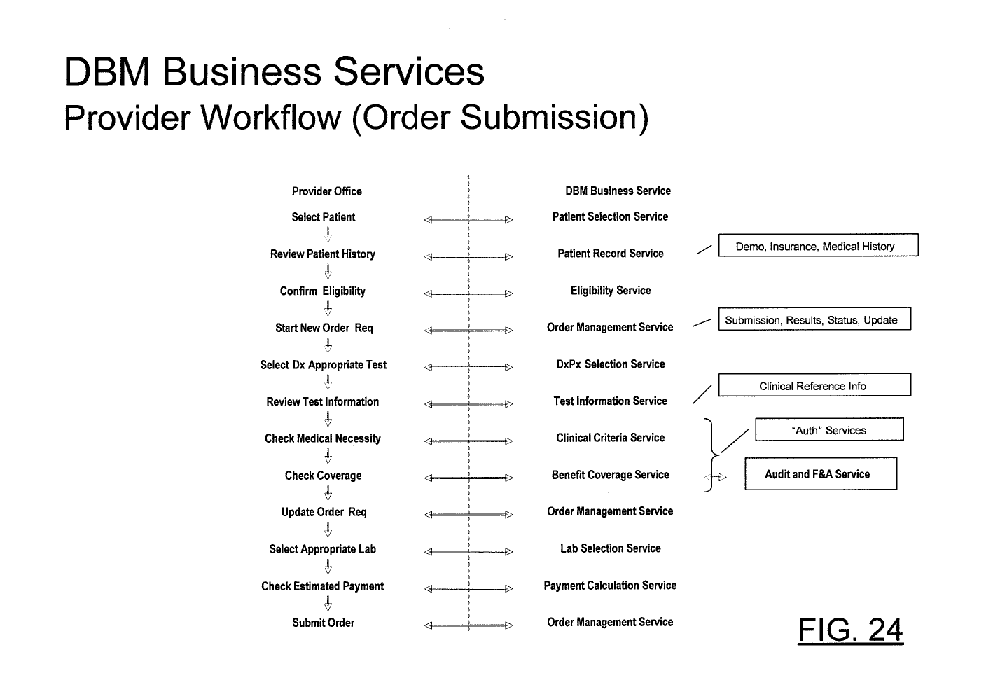

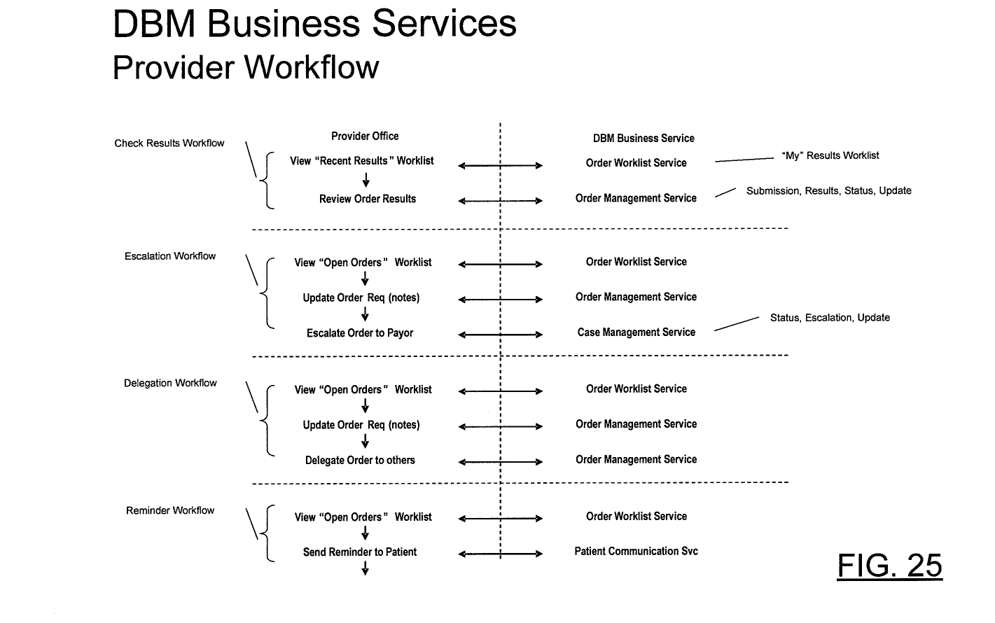

Referring to the flowchart of FIG. 5a, the method of one exemplary embodiment begins with an initial patient (e.g., patient 12) and physician (e.g., clinician 14) encounter for diagnosis selection. For an overview of the clinician aspects see FIGS. 24 and 25. As shown at block 40 of FIG. 5a, the patient-physician encounter may begin with an administrator at the physician's office, here Katherine Moore (see FIG. 6a), checking in a patent, here Janet Cole (see FIG. 6a) at the physician's office. The system 10 of exemplary embodiments of the present invention may enable the office administrator to check in the patient, find records for a physician, resolve alerts, look up test/procedure status and results, complete authorizations, order/requisitions, and/or answer a number of patient questions. In this regard, Katherine may begin checking in Janet by logging into the system, after which Katherine may be presented with a dashboard configured for her use (see FIGS. 6b and 6c). As shown in block 42 of FIG. 5a, Katherine may locate Janet's patient record from Katherine's dashboard, and determine that Janet is already in a patient queue with her appointment time and reason for visit. This information, as well as other information provided by the exemplary system, may be maintained by the physician's office, or alternatively, may be downloaded from the service provider 20 or other appropriate entity.

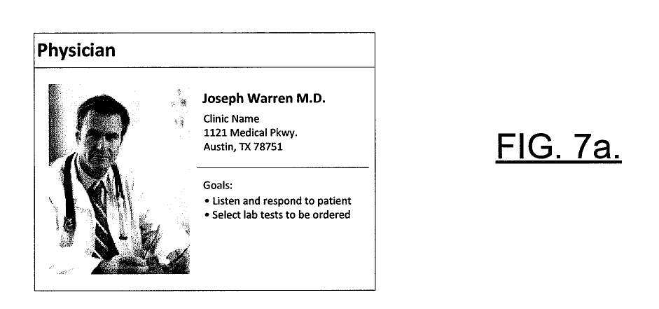

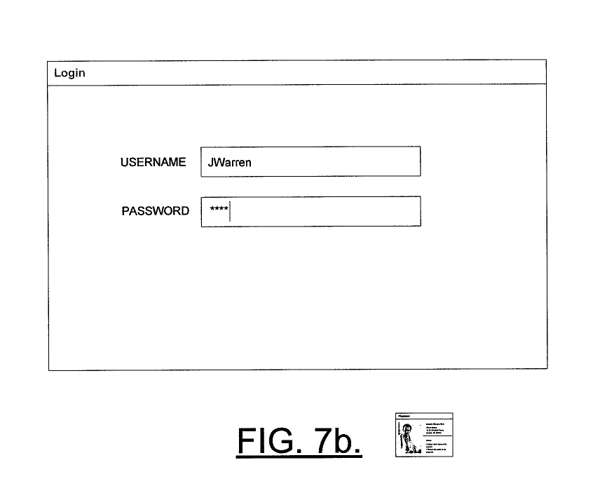

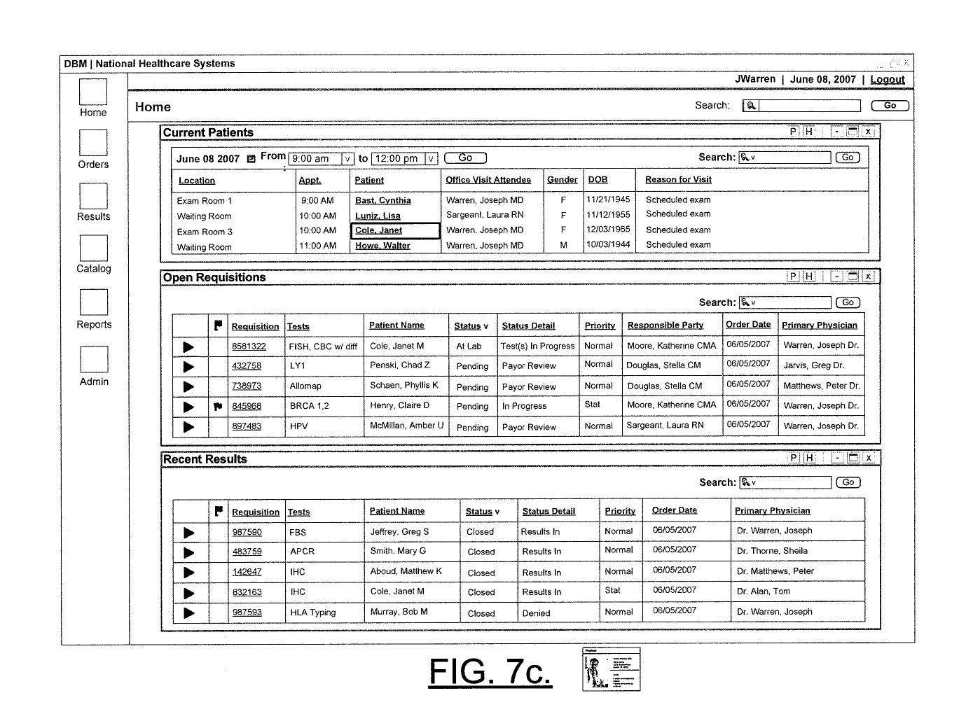

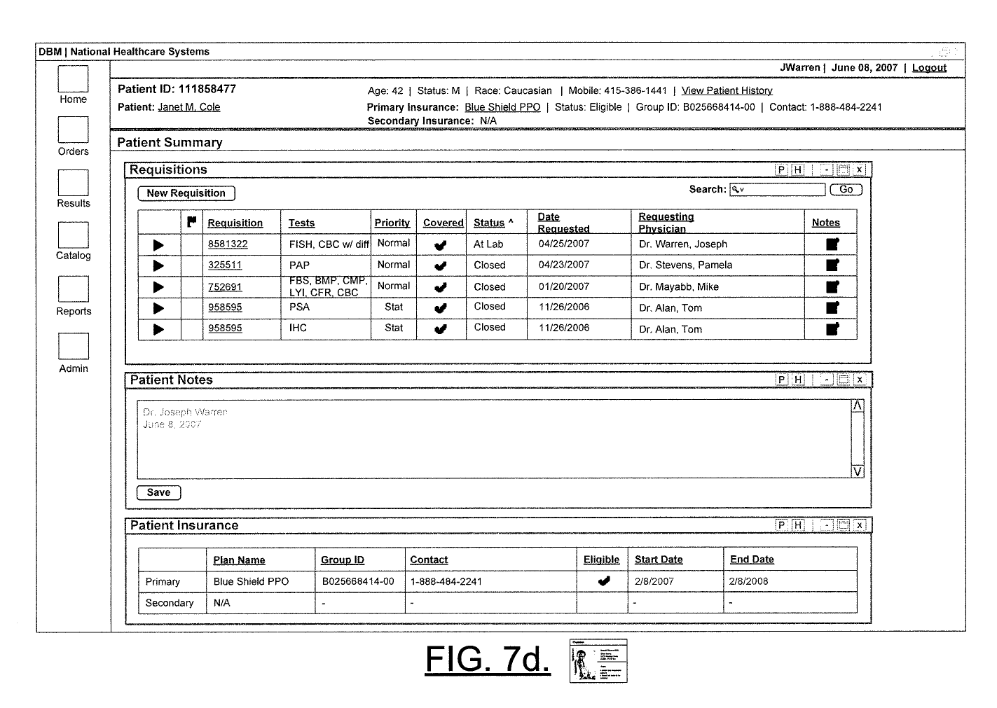

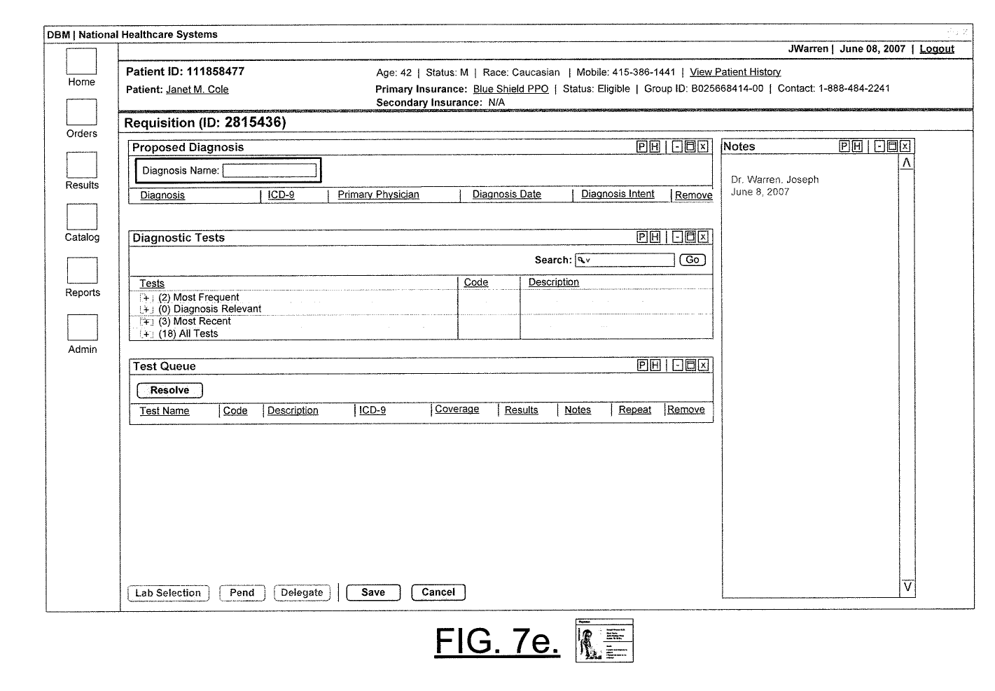

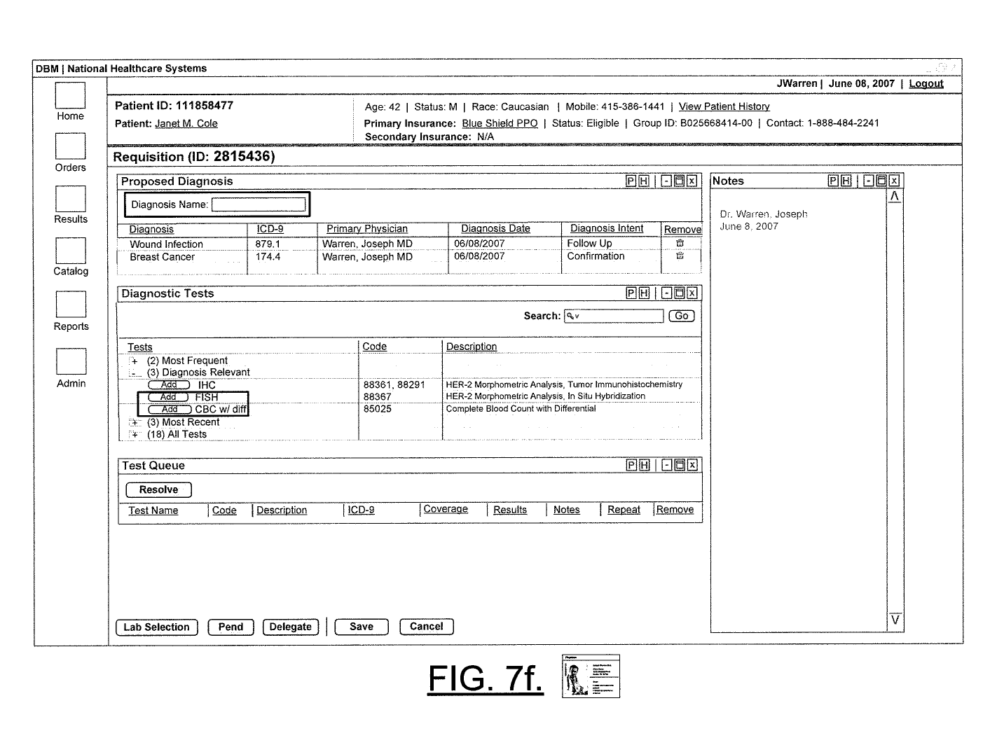

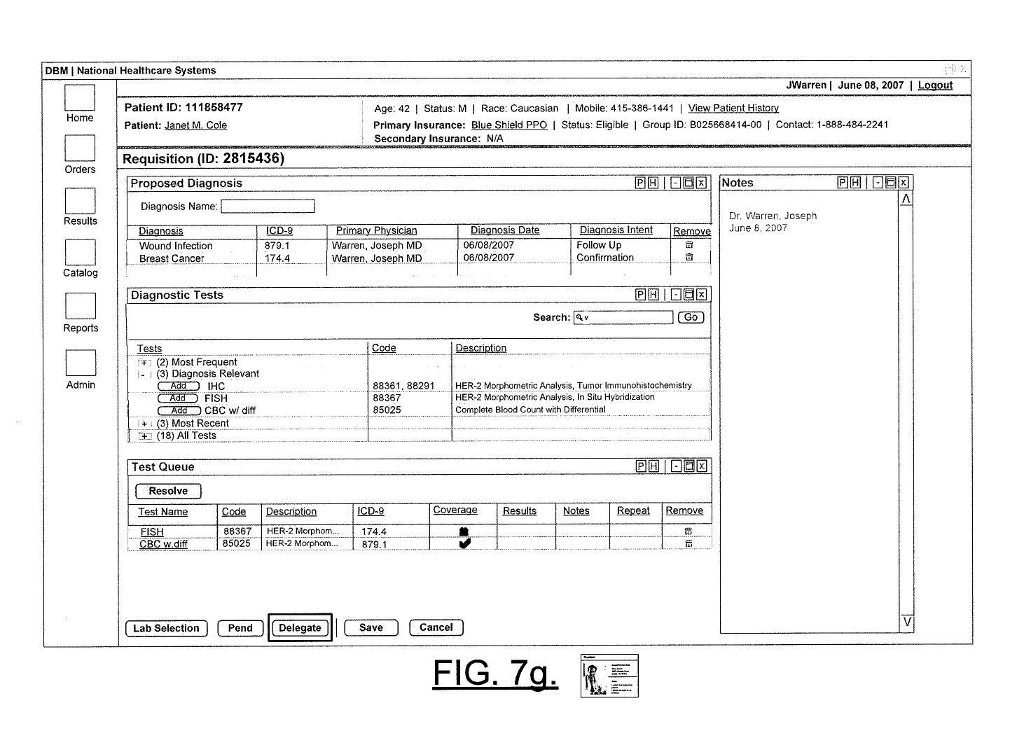

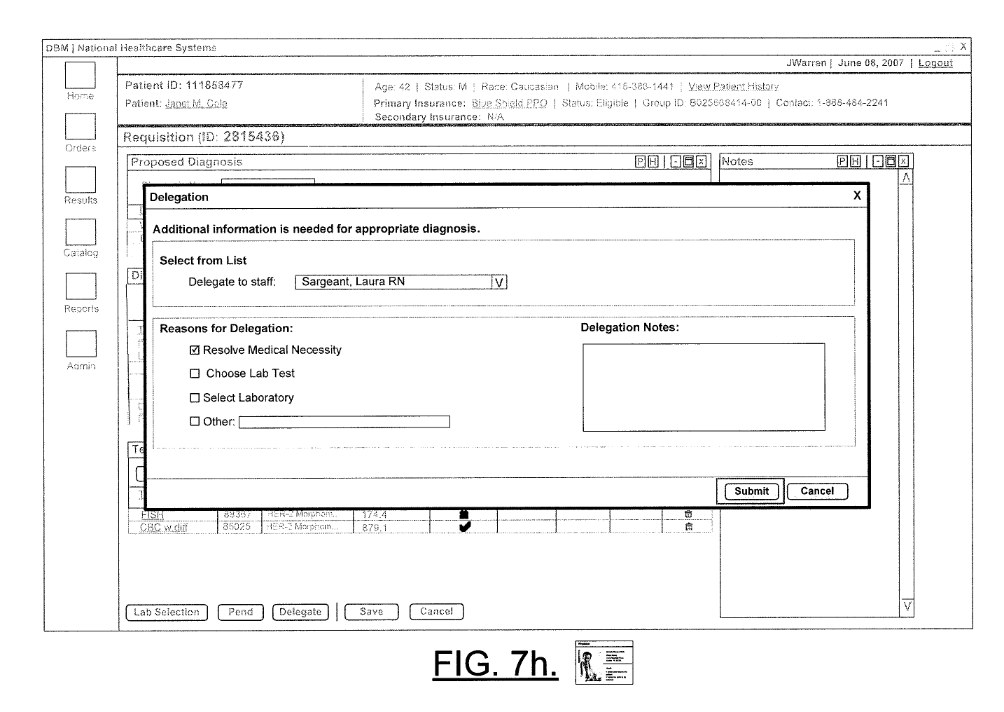

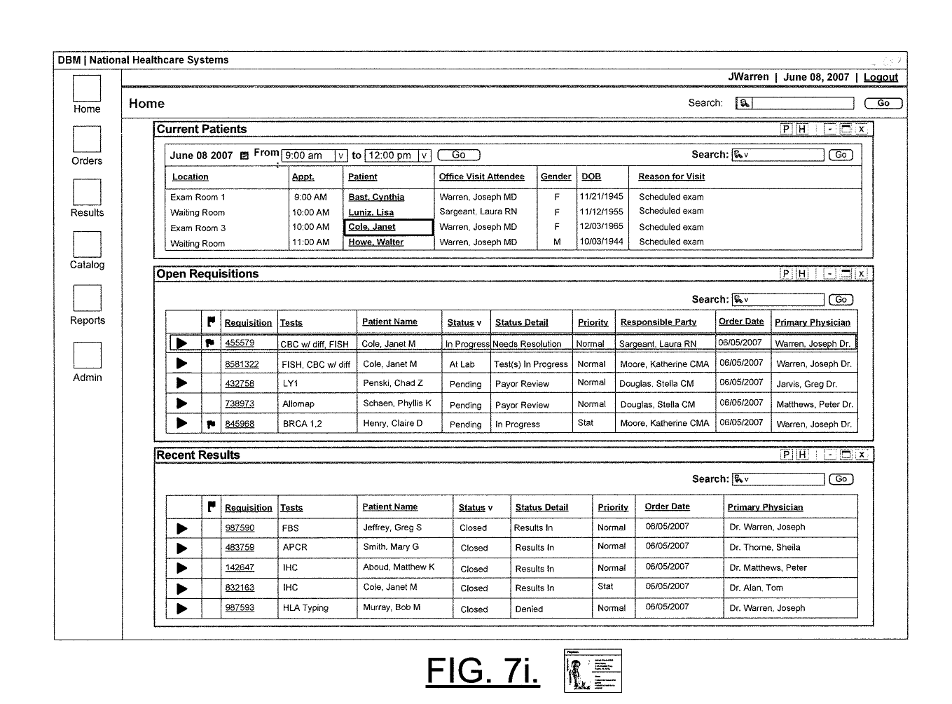

Also from her dashboard, Katherine may load and/or review a patient summary (see FIG. 6d) from which Katherine may update any information, such as patient insurance information, payment type and information, and/or eligibility information, as also shown in blocks 42-46. In addition, Katherine may view a history of Janet's orders/requisitions in the patient summary screen and view details of Janet's insurance coverage. The patient summary may further include a brief summary of the tests/procedures ordered on behalf of Janet, and include a report of Janet's primary complaint(s) and reason for the scheduling of the current visit, such as within a patient notes section. In one exemplary scenario, Katherine may then direct Janet to an exam room to await the physician, here Dr. Joseph Warren (see FIG. 7a).

Sometime after Janet enters the exam room, Dr. Warren enters and begins questioning and examining Janet, as shown in block 48. From a processing element in the exam room, Dr. Warren logs into the system, after which Dr. Warren may be presented with a dashboard configured for his use (see FIGS. 7b and 7c). From his dashboard (directly or indirectly), Dr. Warren may review Janet's medical history, add new requisitions, enter diagnoses and/or delegate any further tests, procedures, or follow-ups as appropriate. As shown in block 50, Dr. Warren (or his/her delegate such as a physician's assistant) may locate Janet's patient record and update the record as appropriate. In this regard, Dr. Warren may load Janet's patient summary (see FIG. 7d) from which Dr. Warren may update any information. From Janet's patient summary, Dr. Warren can view the reason for Janet's visit appointment, which may have been entered into the system by Katherine upon scheduling Janet's appointment. Dr. Warren may also add notes of his own or to add a new requisition for Janet.

Based on Janet Cole's history, Dr. Warren may, for example, decide to (a) follow up with a post-surgical wound infection check, and check Janet's white blood cell count, and (b) confirm HER2+ result to lead to herceptin as adjuvant chemo for her treatment regimen. Dr. Warren may then select to posit diagnoses for Janet by entering a new order/requisition for Janet, and open a new requisition or diagnosis screen (see FIG. 7e) from which Dr. Warren may enter proposed diagnoses and select any appropriate lab tests/procedures, as shown in blocks 54 and 56. In this regard, from the diagnosis screen, Dr. Warren may proceed by typing his proposed diagnoses into a diagnosis field, which after receiving a portion of the diagnosis, may auto-populate the field with the appropriate diagnosis. For example, Dr. Warren may type in the diagnosis “wound infection” into the diagnosis field (see FIG. 7f), and then choose the diagnosis intent as “follow up.” Dr. Warren may then continue to add another diagnosis, entering “breast cancer” into the diagnosis field and “confirmation” as the intent. As the system receives Dr. Warren's proposed diagnoses, the system may proceed to filter a service/procedure catalog based on diagnoses, such as based on a number of business and or clinical rules built into the system, where these business rules may be implemented by one or more analytics engines and/or through various stakeholder entities as described above. A test/procedure portion of the diagnosis screen may list tests that may be ordered for Dr. Warren, but may additionally note and (at least initially) include more detailed information for tests deemed appropriate for the entered diagnoses, as filtered from the test/procedure catalog.

Turning now to FIG. 5b, Dr. Warren may select one or more tests/procedures from the catalog, as reflected in the test/procedure portion of the diagnosis screen, as shown in block 60. For example, Dr. Warren may select to add “FISH” and “CBC w/diff” tests to the new requisition based on his diagnosis. Dr. Warren may then respond to any appropriate questions related to the procedure and its necessity (if he is required and/or would like to determine coverage), and may enter any other required information, as shown in blocks 62-66. As Dr. Warren selects the tests/procedures and supplies, directly or automatically via system connections to stored data, any appropriate information (including question responses, current and past clinical, administrative, financial data), the system automatically determines Janet's eligibility for the selected tests/procedures based on her paying entities rules such as insurance coverage via her health plan, including whether the desired procedure is covered by her health plan and considered medically necessary (if required by Janet's health plan), whether there are any other coverage and/or authorization requirements, and payment rules (such as co-payment, co-insurance, deductibles) and/or as shown in blocks 68-74. If Janet is not eligible, the procedure is not covered or considered medically necessary, or any other coverage requirements are not met, the procedure may be pended and sent to the payor for further review and authorization, as shown in blocks 78-86. Likewise, if Janet is eligible, the procedure is covered and considered medically necessary (if required or desired), and any other coverage requirements are met, but additional payor review and/or authorization is required as per the paying entity's configured rules (such as rules per the patient, provider, setting, history, diagnosis, procedure, plan, clinical/financial and/or practice history), the procedure may be sent to the payor, as shown in blocks 76 and 86. Otherwise, the procedure may be judged authorized, and its authorization may be communicated to Dr. Warren (see FIG. 7g, indicating initial coverage rejection of a FISH test, but authorization of a CBC w/diff test), as shown in blocks 88 and 90 of FIG. 5c. This would also be communicated to the payor/paying entity and servicing lab/facility conducting the procedure as appropriate.

Procedure authorization and/or coverage determination can be derived within the system processes as shown in block 88.1, 88.2, and 88.3 of FIG. 5c. In block 88.1 through an electronic data interchange with the payor, authorization and/or coverage determination may be derived, resulting in block 90 notification. In block 88.2 the system processes may derive the authorization/determination using the rules within the system as configured by the service provider or by the appropriate participating entities (such as payor/paying entity and/or the lab/facility, resulting in a notification at block 90. In block 88.3 the authorization action is taken by the payor using a manual authorization and/or coverage determination workflow.

In various instances, coverage of a procedure may be resolved by further action by the physician or physician's office. In such instances, for example, from the diagnosis screen, as appropriate, Dr. Warren may delegate one or more unresolved tasks in completing Janet's diagnoses to others in his office by selecting a “Delegate” or assignment option, from which the system presents a delegation or assignment screen (see FIG. 7h). From the delegation screen, Dr. Warren may choose an employee, stakeholder, or appropriate entity within or outside his practice, the lab/facility, or the paying entity to whom to delegate one or more tasks, and choose the unresolved task(s) to delegate, such as to resolve medical necessity for a particular procedure, choose a lab test/procedure, select a facility/laboratory, or the like. As shown in FIG. 7h, for example, Dr. Warren may choose to delegate to his nurse, Laura Sargeant, the task of resolving medical necessity (e.g., for the FISH test initially pended coverage). Dr. Warren may then select a “submit” option to send the delegation to Laura, and return to his dashboard from which Dr. Warren may now see the status of the aforementioned new requisition and its indication of Laura as the responsible party (see FIG. 7i).

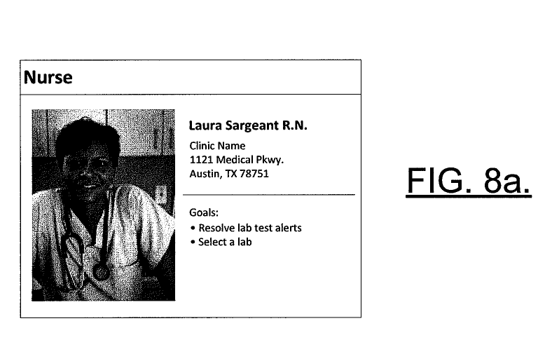

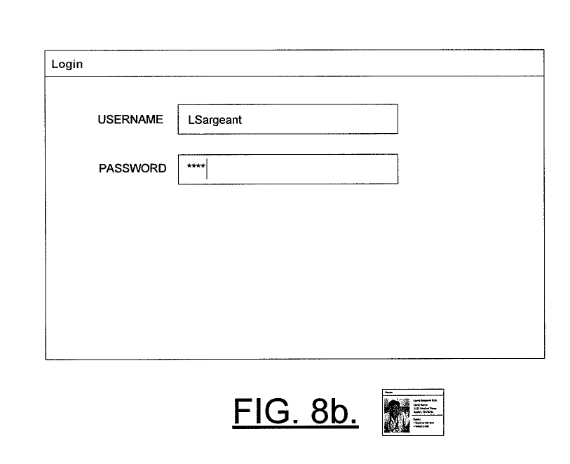

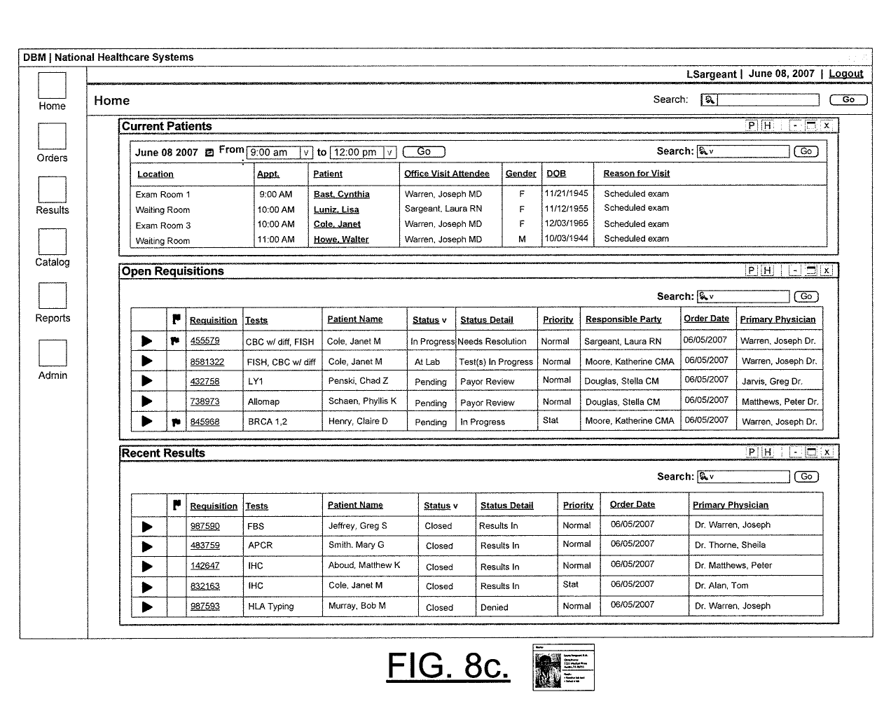

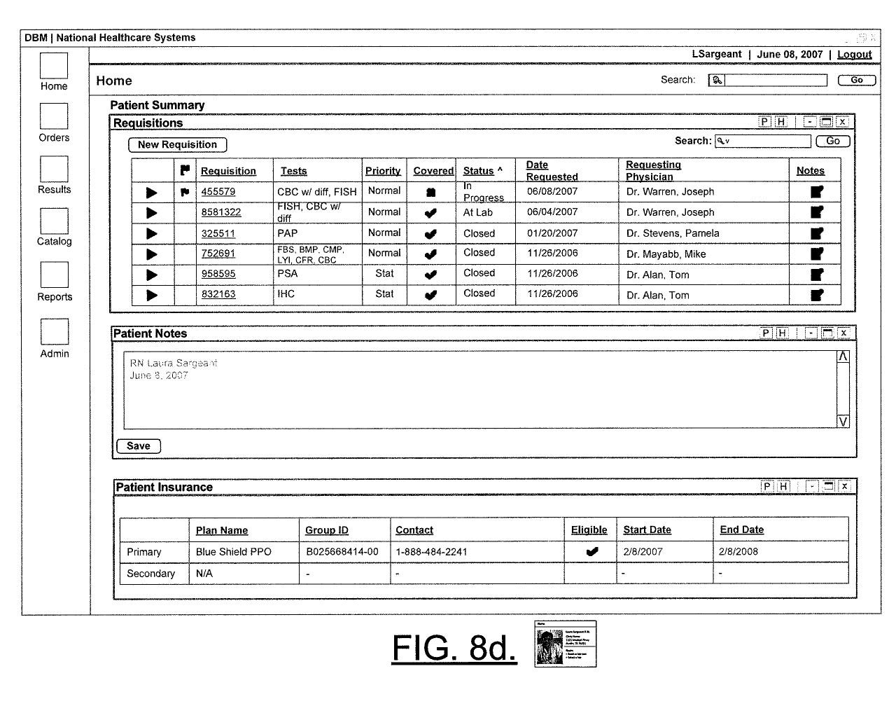

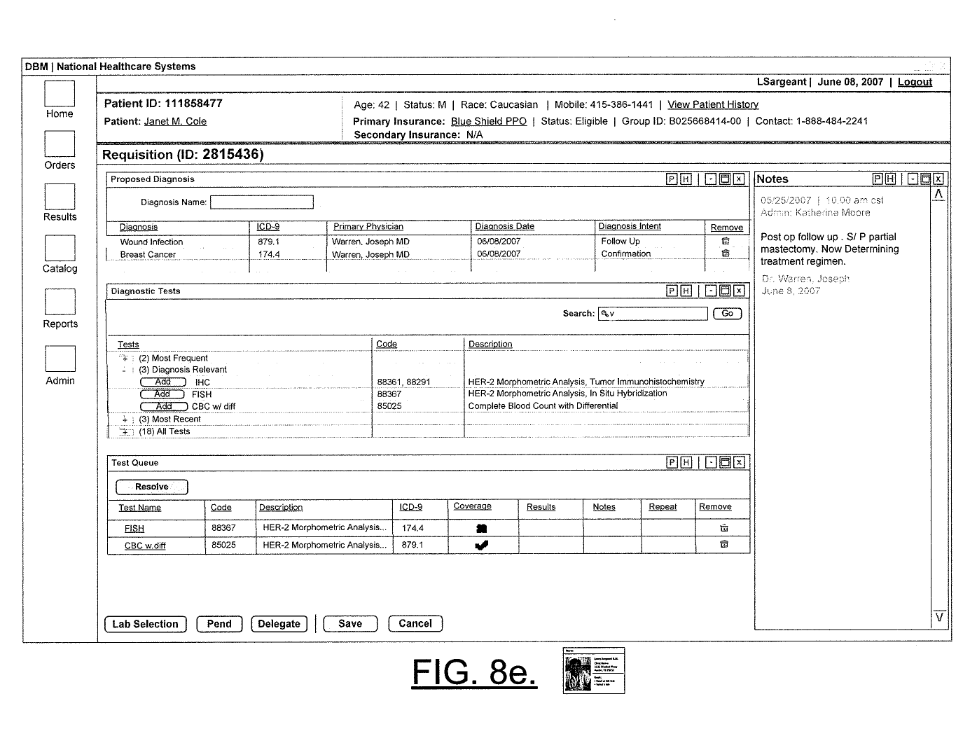

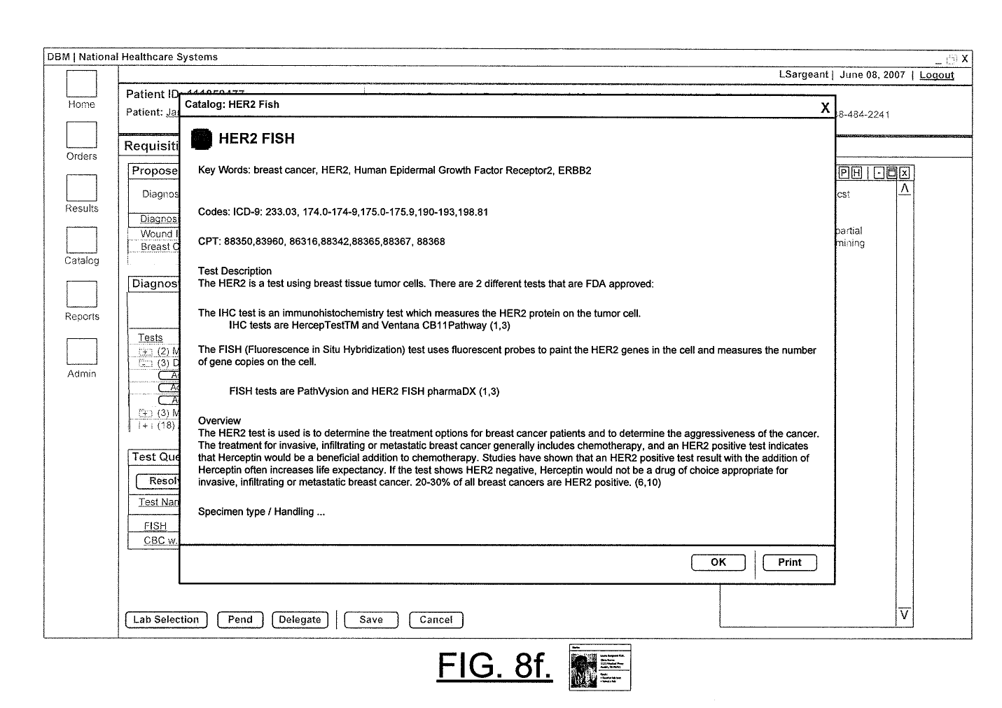

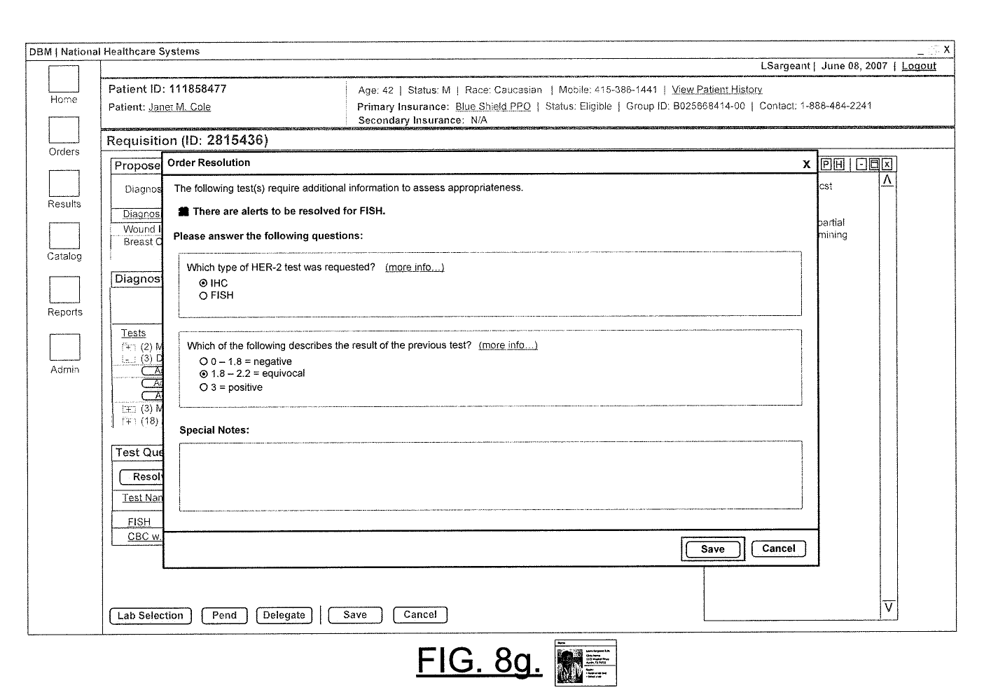

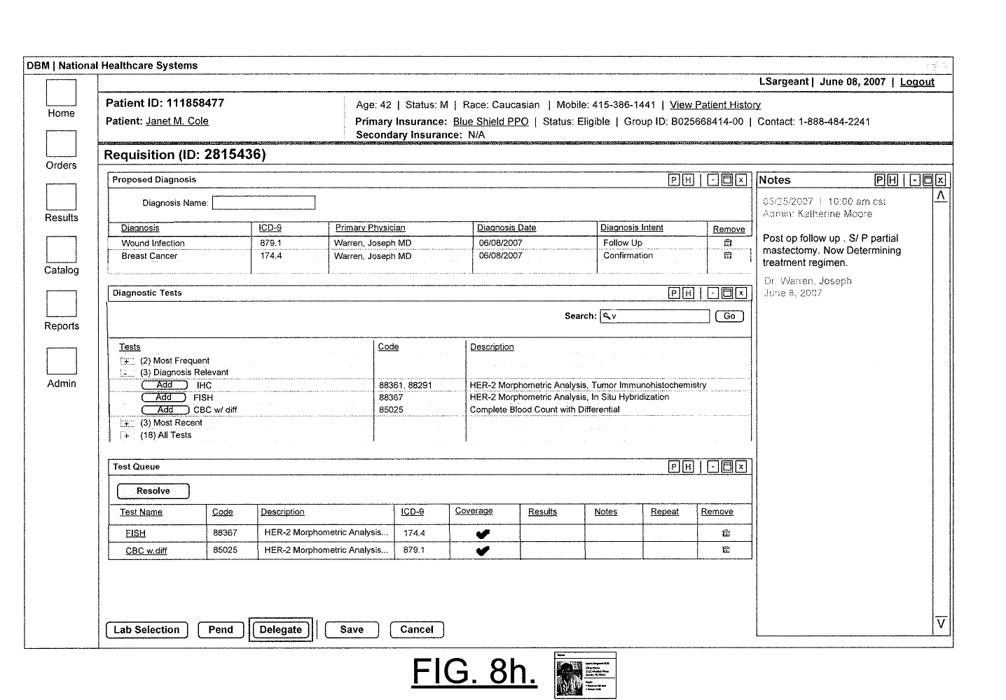

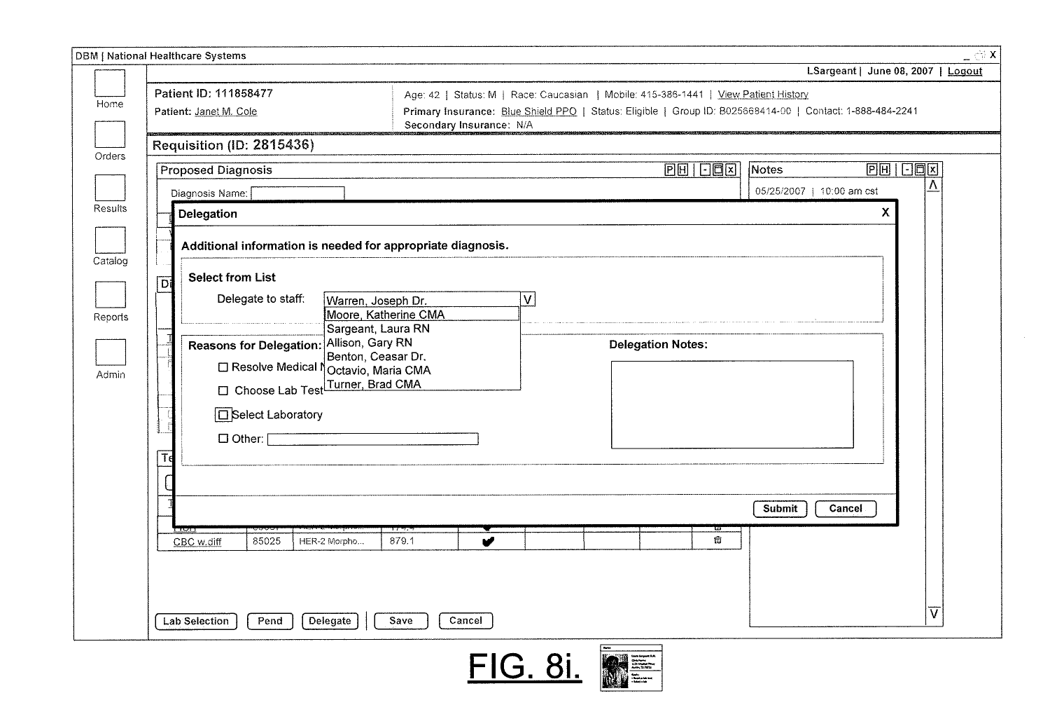

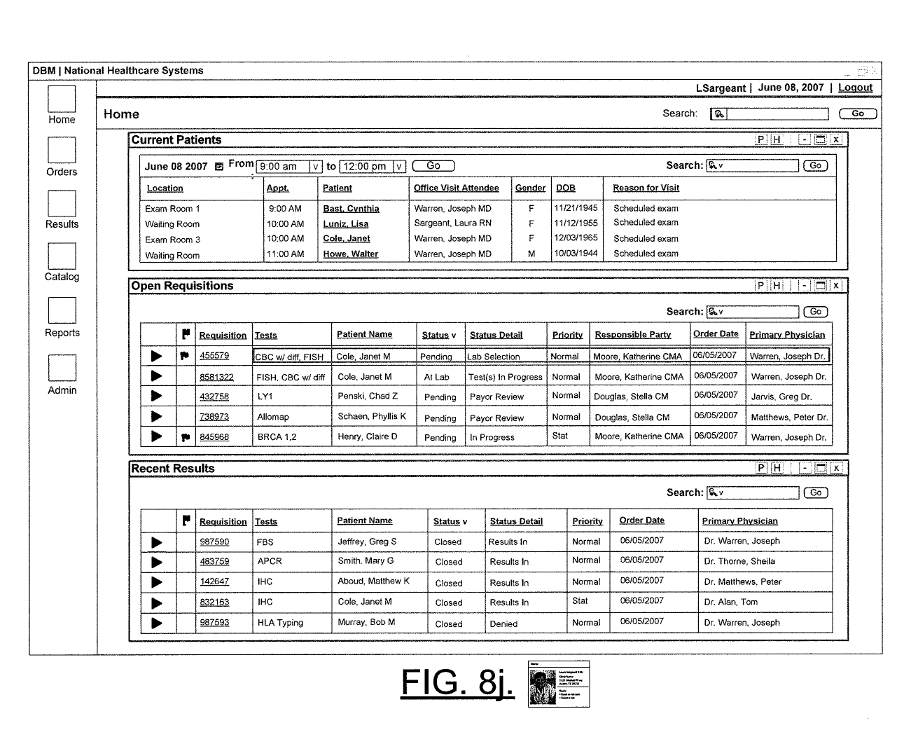

Sometime after Dr. Warren enters the new requisition, his nurse, Laura Sargeant (see FIG. 8a) enters Janet's exam room and logs into the system, after which Laura may be presented with a dashboard configured for her use (see FIGS. 8b and 8c), such as to complete Dr. Warren's lab test/procedure orders. From Laura's dashboard, she may select Janet's requisition in an open requisitions queue. Alternatively, Laura may open Janet's patient summary (see FIG. 8d) from which Laura may select Janet's open and in progress requisition, as well as review Janet's requisition history. In either instance, selecting Janet's requisition may direct the system to open the diagnosis screen for the respective requisition (see FIG. 8e).

From the diagnosis screen, Laura may (but need not) select a particular test/procedure to retrieve details regarding the respective procedure, such as to familiarize herself with its details (see FIG. 8f). For example, Laura may select a test for which coverage under Janet's health plan is initially pended, or needs more information so that she may familiarize herself with the test's details. In the case in which coverage for a test is initially indicated pended, then, Laura may select to resolve the coverage issue, to which the system responds by presenting an order resolution screen including a number of questions the answers to which may resolve the coverage issue. In this regard, the system may receive the answers to the questions on the order resolution screen, and based on business, clinical, administrative rules, or other requirements or information (that may be implemented by analytics engine(s) or as configured by the appropriate entity), may automatically resolve the coverage issue. In instances in which the coverage issue is positively resolved, the order resolution screen (see FIG. 8g) may notify Laura of its authorization (see FIG. 8h, now indicating, relative to FIG. 8e, the authorization of the FISH test). If the coverage issue still is not positively resolved at this point or if at any time the user would like to know more information about it, the procedure may be submitted to the payor for resolution or the lab/facility for more information, again as shown at block 86.

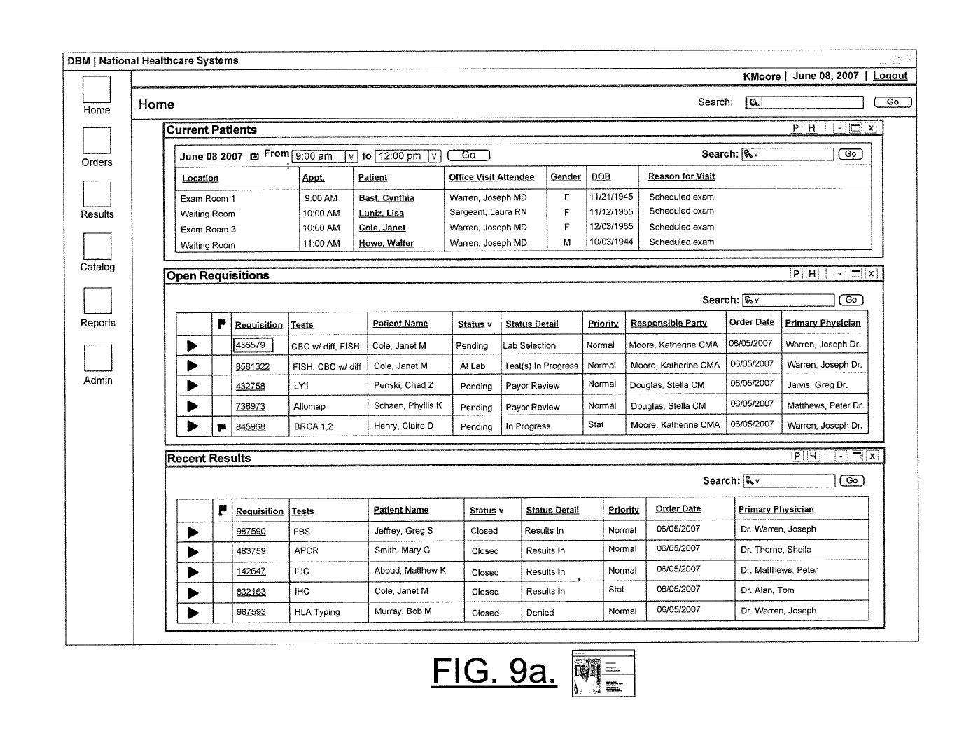

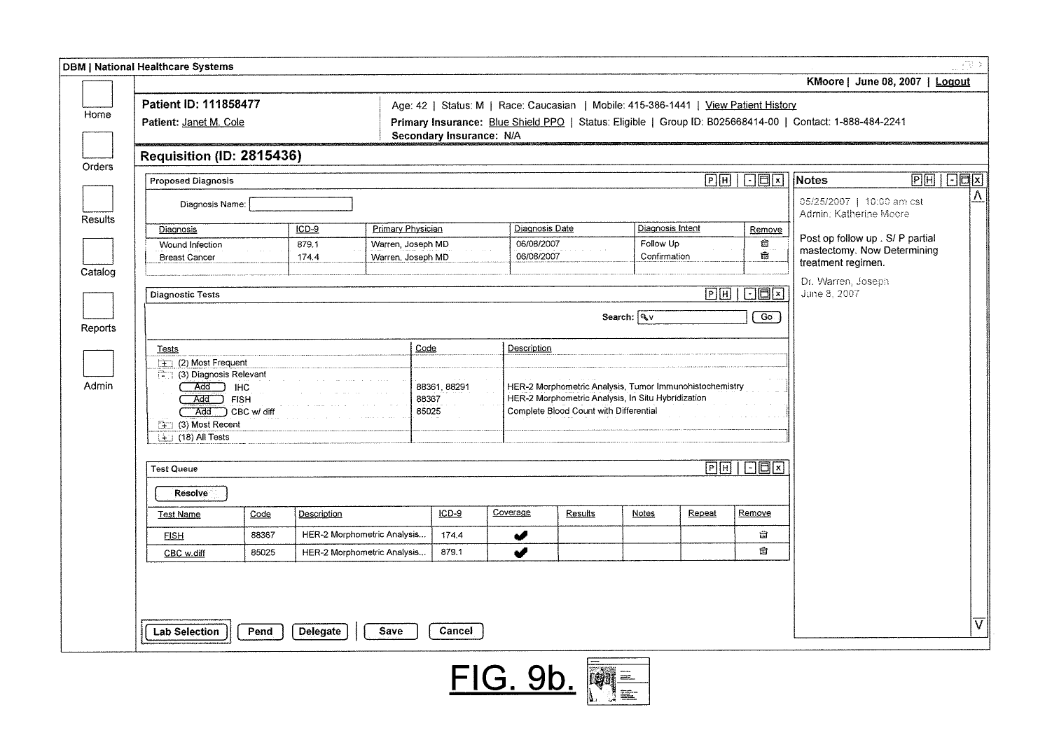

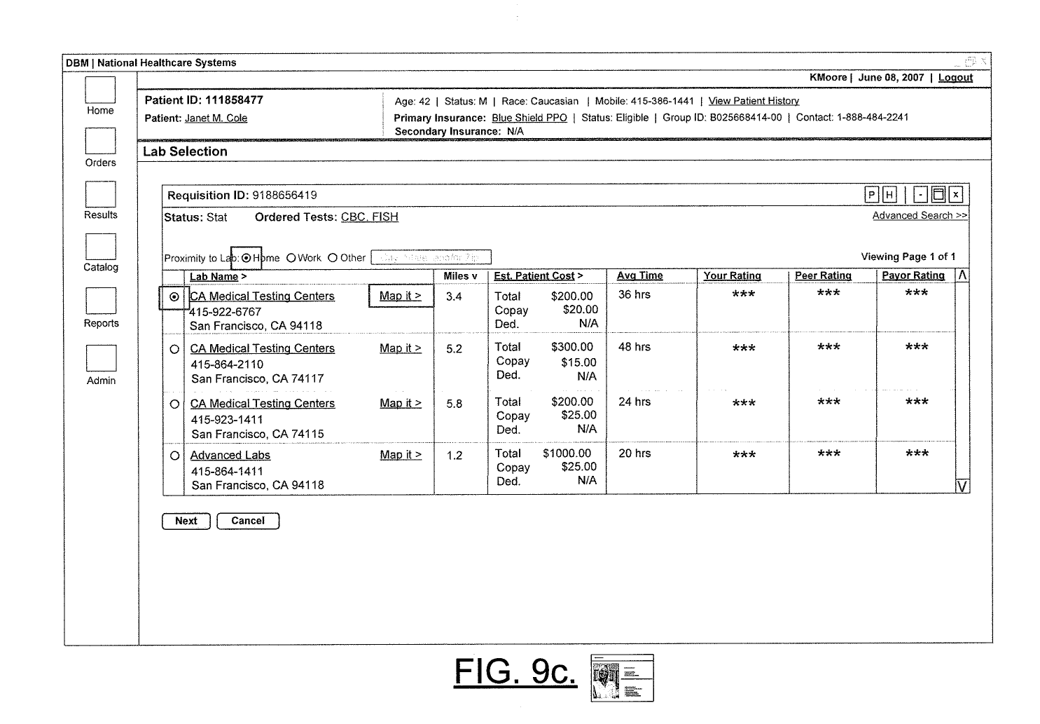

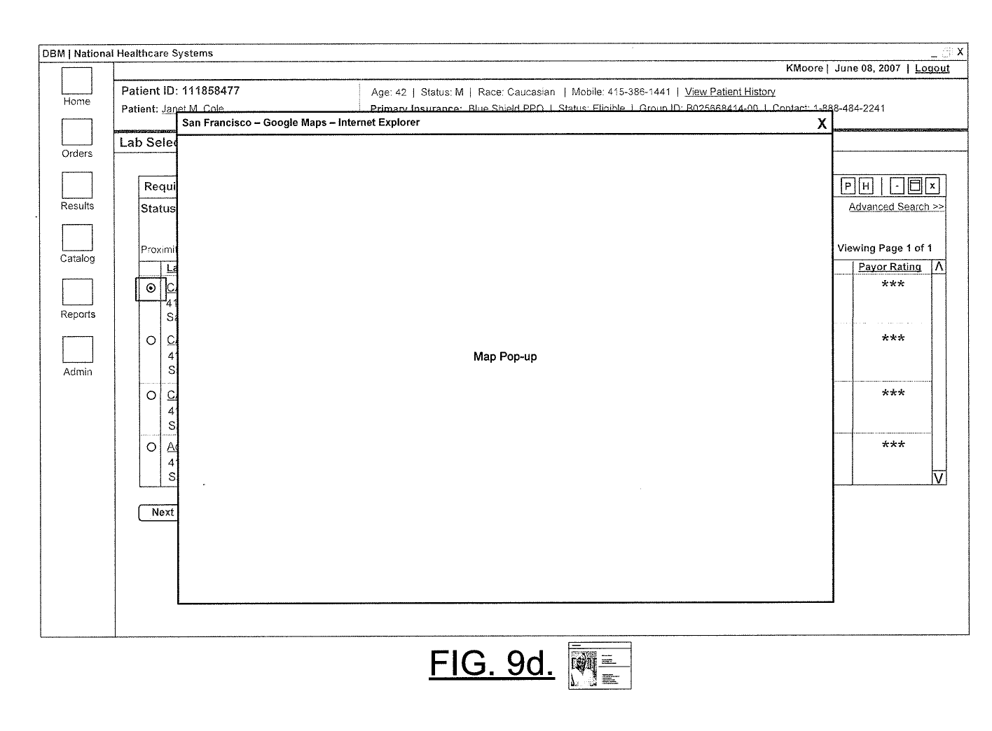

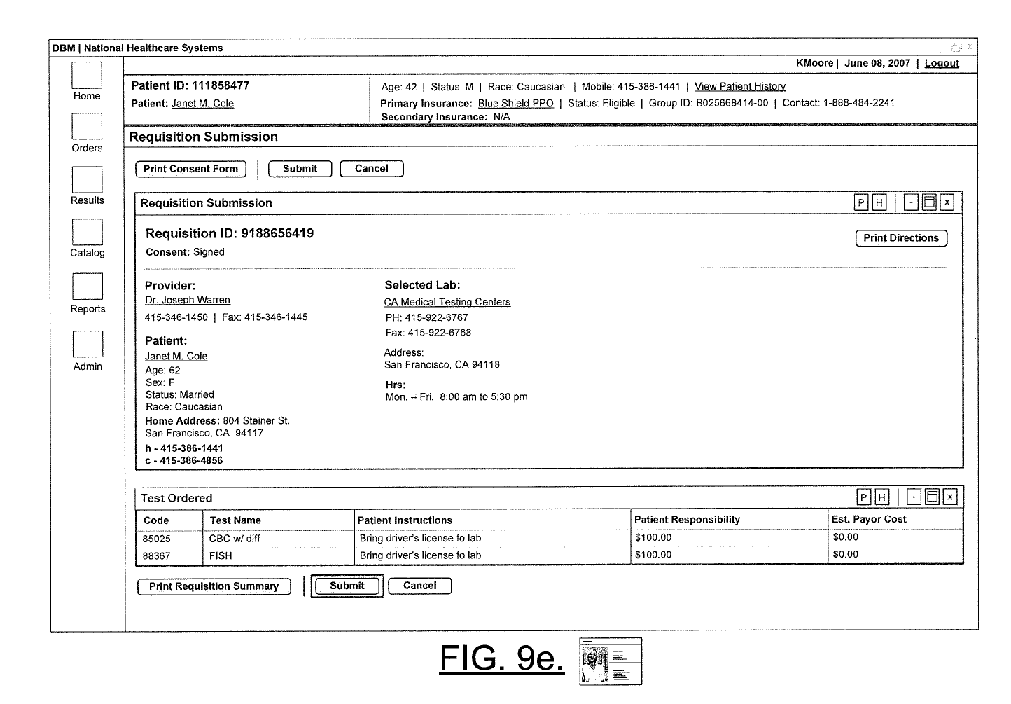

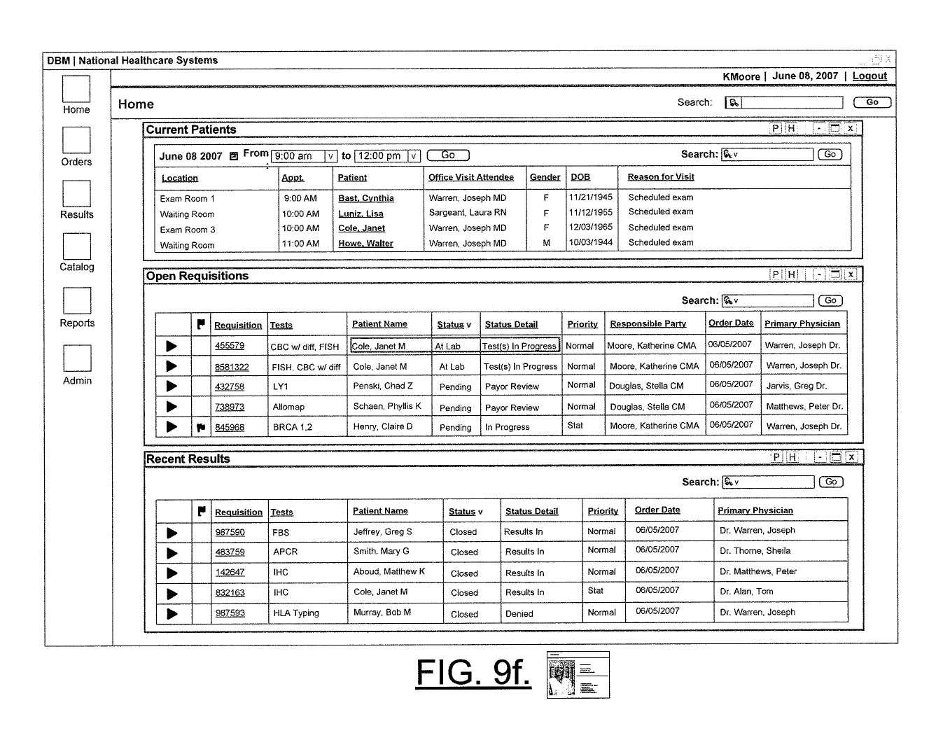

In addition to facilitating diagnosis and resolution of coverage of particular procedures, the system may further facilitate selection of particular labs/facilities 16 to perform the respective procedures. This selection process may be carried out by the patient or physician (or employee/delegate of the physician's office). In the illustrated scenario, for example, Laura delegates to Katherine the task of selecting the lab/facility to perform Janet's procedures (see FIGS. 8i and 8j). Thus, Katherine may again log into the system (if necessary or as desired) to bring up her dashboard (see FIGS. 6b and 9a). From her dashboard, Katherine may select Janet's requisition in an open requisitions queue, or select to open Janet's patient summary from which Katherine may select Janet's requisition that is open and in progress. In either instance, selecting Janet's requisition may direct the system to open the appropriate screen for the respective requisition (see FIG. 9b).

From the diagnosis, summary, screen, or other appropriate screen, Katherine may choose to begin selection of a lab/facility 16 to perform the tests/procedures included in the requisition. Again referring to FIG. 5, and FIG. 5c in particular, the system may determine one or more potential labs/facilities for performing the tests in the requisition, and determine (based on the particular test, Janet's authorization and/or coverage, the requesting provider, the location, and any other appropriate information) the financial responsibility for the patient and/or other appropriate entity associated with the respective labs/facilities to perform the respective tests, as shown in blocks 92 and 94. This cost may be an actual, estimated or approximated cost, or the like. The labs/facilities may be determined in any of a number of different manners, such as based on quality metrics (imputed or derived from within or outside the system), turn-around-times, network coverage, previous patient experience, clinical preference, their proximity to Janet's home or work, or based on any other identifiable location. Regardless of how the labs/facilities are determined, however, the system may then present Katherine with a lab/facility-selection screen including a sortable/filterable list of lab/facility options with associated patient and/or other costs (see FIG. 9c), as shown in block 96. From the list of lab/facility options, Katherine may view appropriate metrics and characteristics described above and ultimately view and print a map for a particular lab/facility to facilitate Janet selecting and, if selected, locating the respective lab/facility (see FIG. 9d).

From the list of lab/facility options, Katherine (or Janet) may select a desired lab/facility 16, as shown in block 98. After selecting a particular lab/facility, the system may present a requisition submission confirmation screen for the particular requisition (see FIG. 9e). If the system or the user determines that an advance beneficiary notice (ABN) or comparable commercial paying entity form, or other release is required, these may be selected for printing from the confirmation or other appropriate screen. Katherine may then obtain the requisite signatures from Janet, as shown in blocks 100 and 102. After collecting the requisite signatures from Janet, or if an ABN or other release is not required, Katherine may print any appropriate procedure/test information, instructions, benefit/coverage details, cost/payment information, and/or lab/facility instructions as well as the lab/facility's directions (in addition to or in lieu of the above map to the lab/facility), as shown in block 104. Also following selection of the desired lab/facility, Katherine may direct the system to submit the requisition order directly or indirectly to the respective lab/facility, and direct Janet to proceed to the lab/facility to have the lab/facility conduct the respective tests, as shown in blocks 106 and 108. The payment of the test/procedure conducted and the appropriate fee may also be collected and processed through the system. Katherine may then return to her dashboard, on which she will now note that the status of Janet's requisition has changed to indicate that the respective tests are in progress (see FIG. 9f).

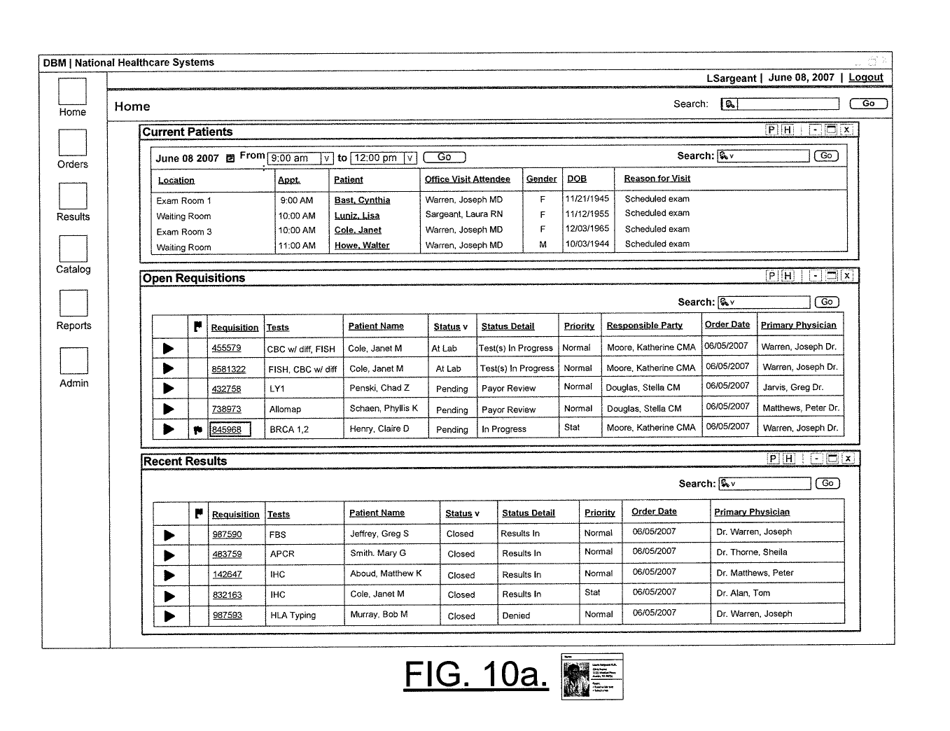

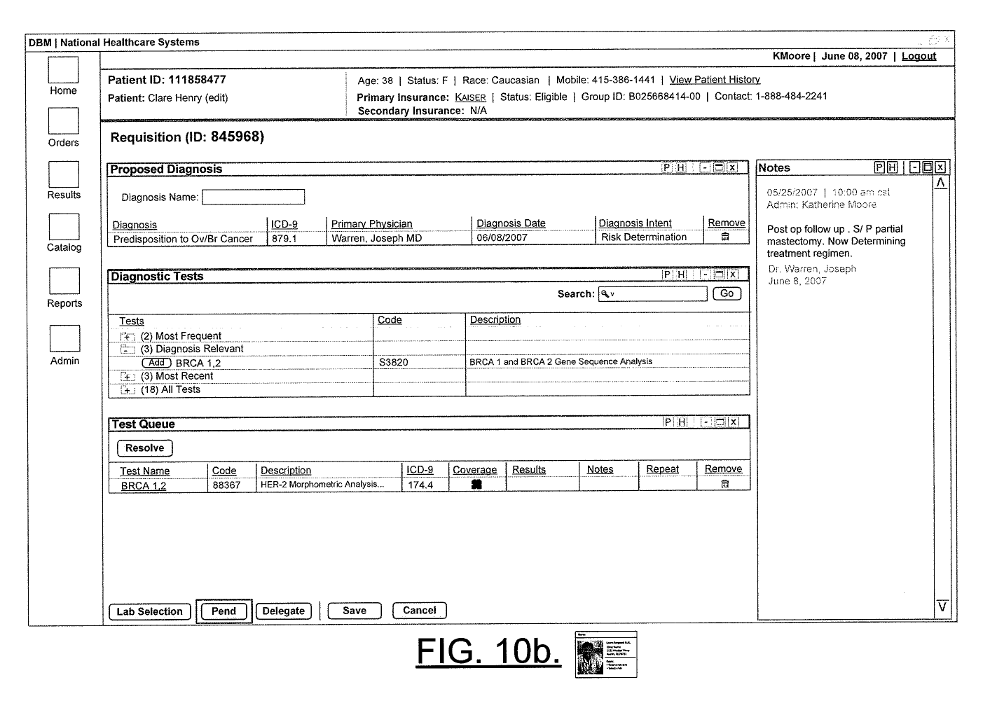

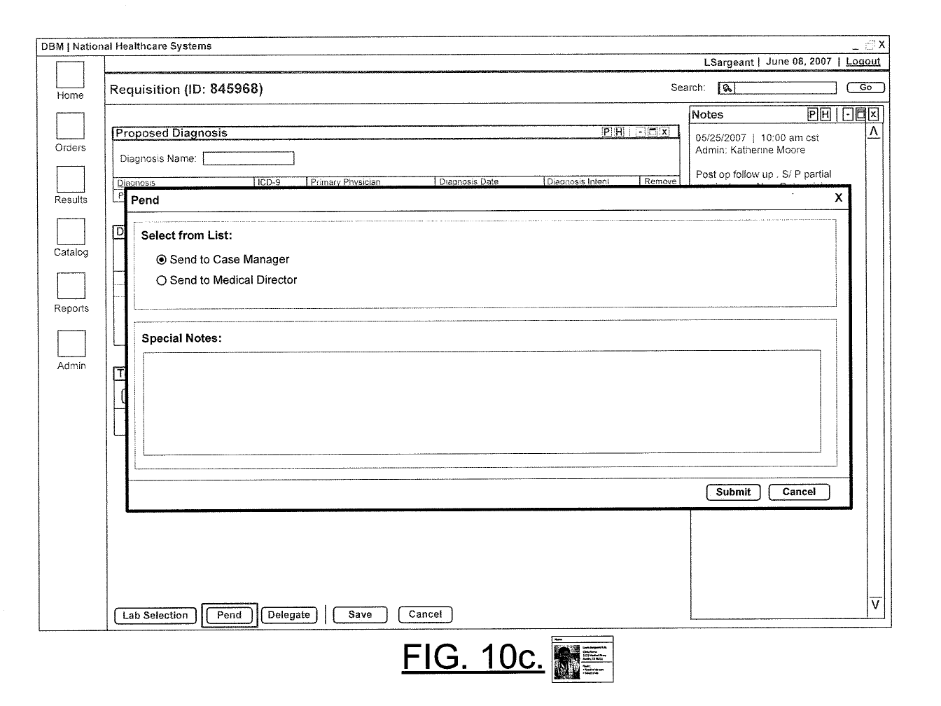

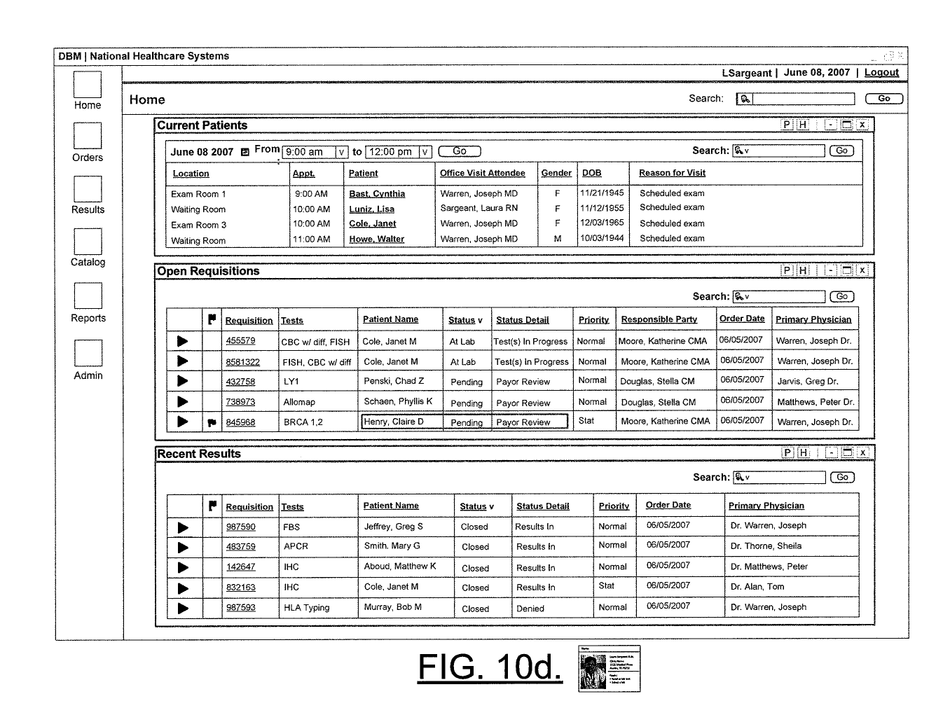

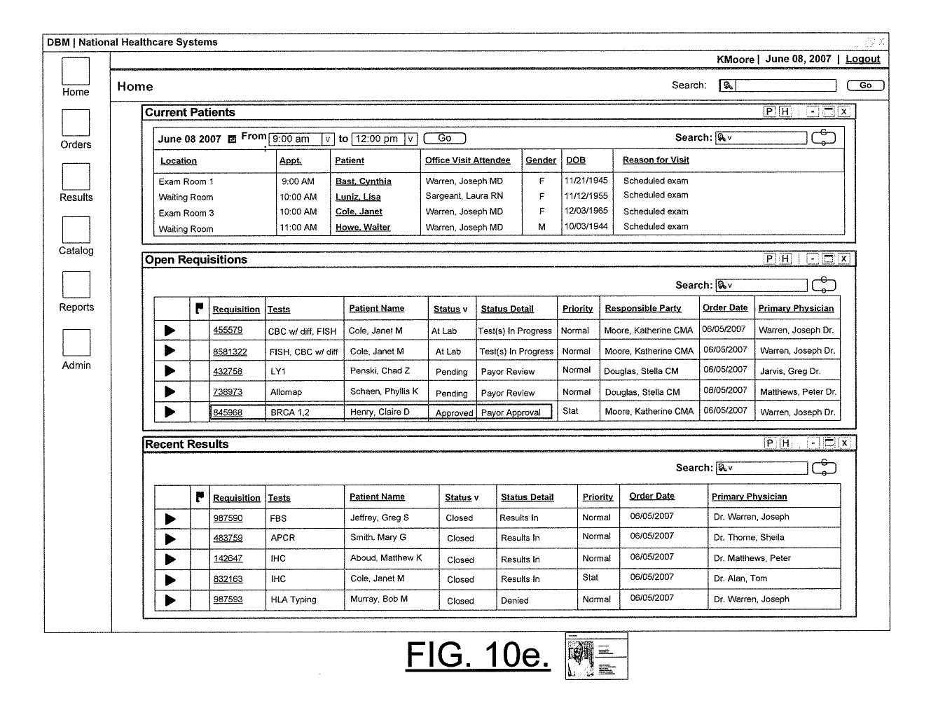

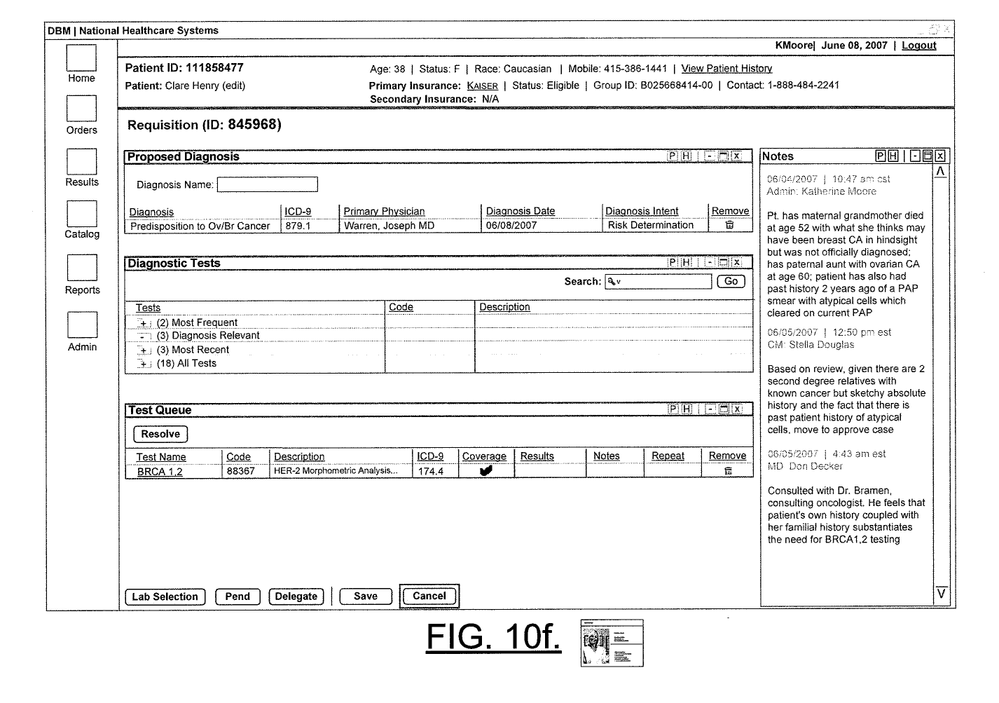

To illustrate further clinician aspects, consider the case of another patient, Clair Henry, for which Dr. Warren has also entered a new requisition. Similar to before, Dr. Warren's nurse, Laura Sargeant (see FIG. 8a) logs into the system to view her dashboard (see FIG. 10a). From Laura's dashboard, she may select Claire's requisition in an open requisitions queue. Alternatively, Laura may open Claire's patient summary from which Laura may select Claire's open, completed, and in progress requisitions, as well as review Claire's requisition history and appropriate patient, clinical, financial information. In either instance, selecting Claire's requisition may direct the system to open the appropriate screen for the respective requisition (see FIG. 10b). Laura again selects to resolve the coverage issue, to which the system responds by presenting a resolution screen including a number of questions the answers to which may resolve the coverage issue. For Claire, however, the answers to the presented questions do not result in an automatic authorization and/or coverage determination for the requested procedure, and Laura decides to submit the procedure to the payor for further review and resolution (see block 86).

Referring now to FIG. 5d, to submit the procedure to the payor for resolution, Laura chooses a “pend” option from the diagnosis screen for the respective requisition. The system presents Laura with a further screen from which Laura may direct the procedure coverage issue to a particular party at the paying entity or payor, such as a case manager or medical director, and may enter any special notes (e.g., regarding the procedure) (see FIG. 10c). Laura may send the coverage issue to the payor for further action, such as to approve or deny Claire's coverage for the procedure, as shown in block 110. Laura may then return to her dashboard, which may now indicate that the requisition has an issue that has been sent for payor review (see FIG. 10d).

Prior to receiving payor review (or in lieu of receiving payor review), Dr. Warren may choose (alone or in consultation with Claire) to proceed without payor coverage authorization or determination for the respective procedure, as shown in blocks 112 and 114. In such instances, Dr. Warren may inform Claire of the costs and risks associated with proceeding without first receiving coverage authorization, and may obtain a sign-off from Claire to proceed, as shown in blocks 116. Then, if so desired, the method may then proceed with lab/facility selection, in a manner similar to before, and with the associated costs for the potential labs/facilities reflecting Claire's cost if the tests are ultimately not covered or covered based on the information currently present and confirmed correct. On the other hand, if Dr. Warren or Claire decides to wait for payor coverage authorization and/or determination, Dr. Warren may wait for the authorization result before proceeding, but may proceed with test/procedure selection (or additional test selection), as shown in blocks 118 and 120.

Sometime after Claire's coverage issue is sent to the payor for review, the payor enters a coverage decision into the system, after which Dr. Warren's office may review the results and proceed accordingly. In this regard, following the payor's coverage decision, Katherine Moore logs into the system to access her dashboard to review the payor's decision regarding Claire's coverage (see FIGS. 6b and 10e). From her dashboard, Katherine may see that the status of Claire's open requisition has changed from payor review to having received payor approval. Katherine may respond back to the payor with further questions about the decision, or choose to assign the requisition to the appropriate entity for next steps. If so desired, Katherine may also select Claire's requisition to direct the system to present the appropriate screen for the respective requisition, from which Katherine may review any notes from the payor review (see FIG. 10f).

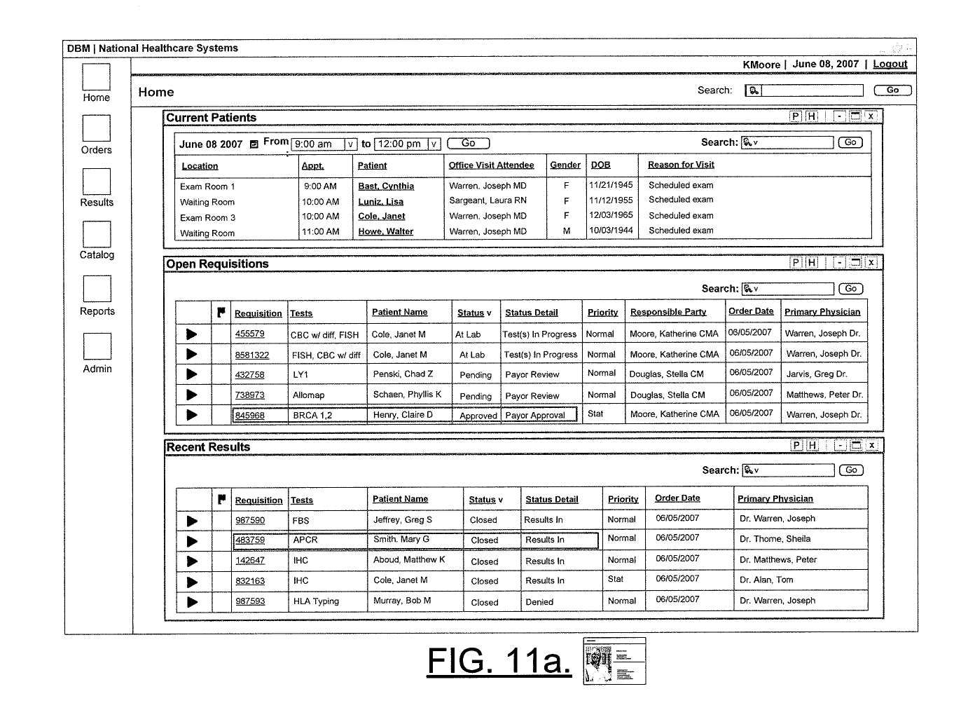

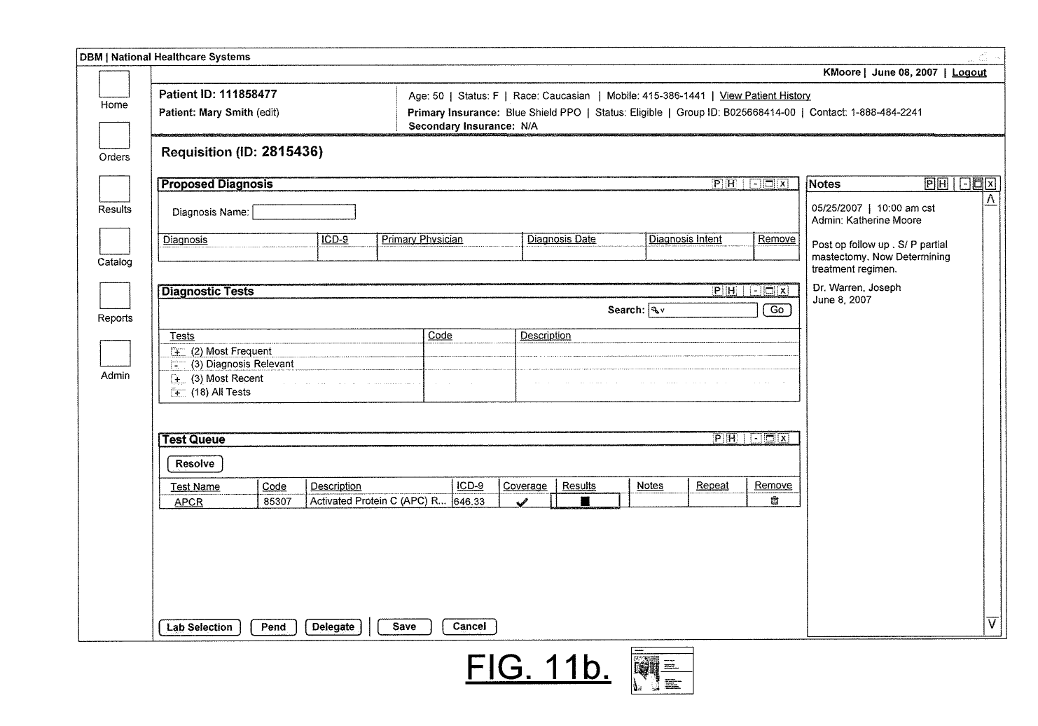

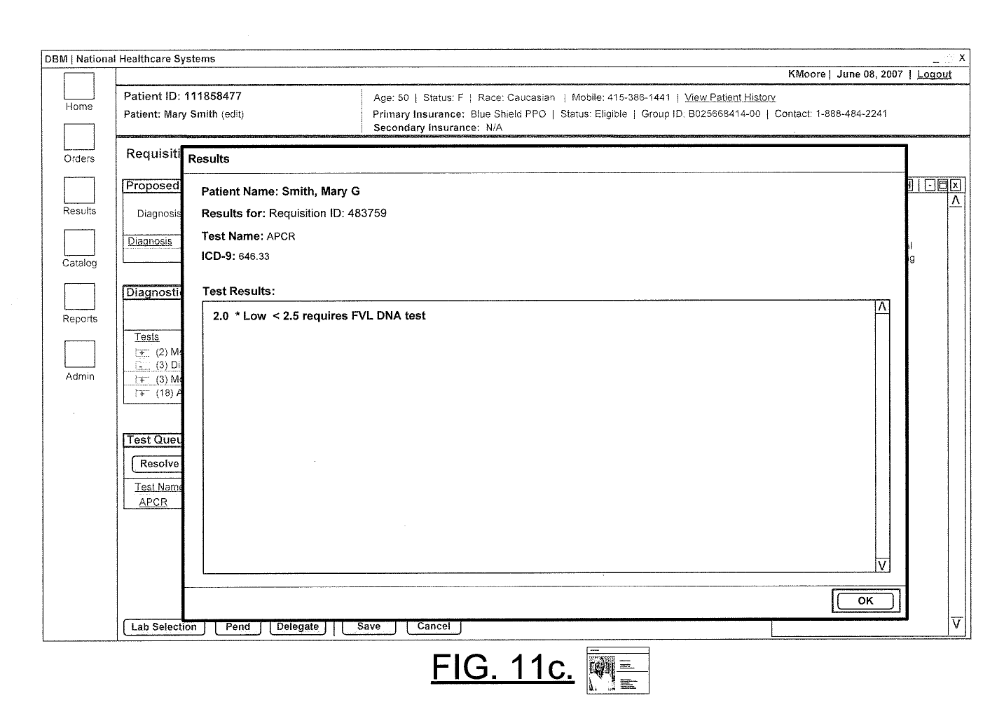

As shown in FIG. 5e, to illustrate another clinician aspect, consider the case of yet another patient, Mary Smith, who another physician in the same office, Dr. Sheila Thorne, recently sent to a lab/facility to have an active protein C (APC) resistance (APCR) test conducted. Following the lab/facility conducting the test, the lab/facility may enter the test results into the system, which may then generate a notification to Dr. Thorne's office or directly to the patient, as shown in blocks 122 and 124. Sometime thereafter, Katherine logs into the system to access her dashboard to review Mary's test results (see FIGS. 6b and 11a). From Katherine's dashboard, she may select Mary's requisition in a recent results or appropriate frame of her dashboard. In response, the system may present the appropriate screen for the respective requisition (see FIG. 11b). From the diagnosis screen, Katherine may then choose to review Mary's test results (see FIG. 11b, selecting an icon under a “results” column in a test queue). The system may then present a results screen, from which Katherine may review and print Mary's test results (see FIG. 11c), as shown in block 126. The results may then be forwarded to Dr. Thorne, who may communicate with lab/facility regarding those results and/or send them directly to Mary and proceed with the appropriate course of care, at which point the provider process is complete at that time, as shown in blocks 128-132.

Based on the individual and aggregate transactions that are performed by the physician/physician's office within the office and between the lab/facility and the payor/paying entity, the physician/physician's office can review data as appropriately reported in order to better understand the performance of those transactions and how to better improve performance, the decisions, the outcomes associated with the decisions, and best practices based on those transactions with or without context of the system entities such as the payor and labs rules for those transactions. These may be accompanied by incentive programs such as pay for performance, pay for quality, gold/red carding, and auditing purposes,

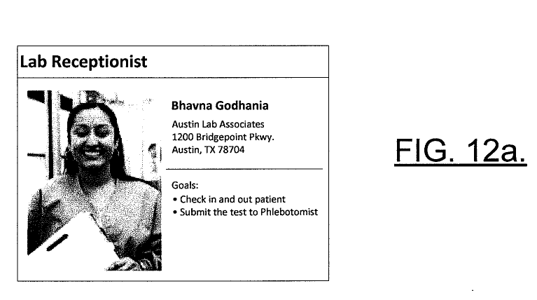

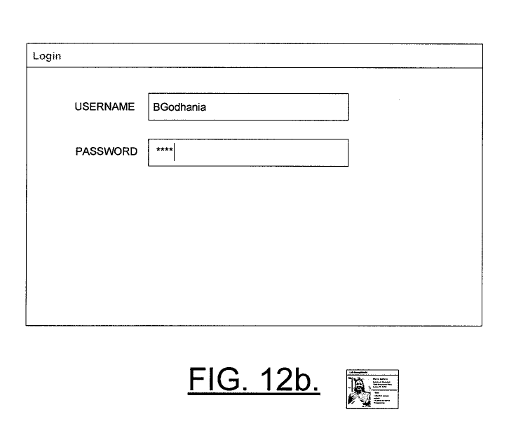

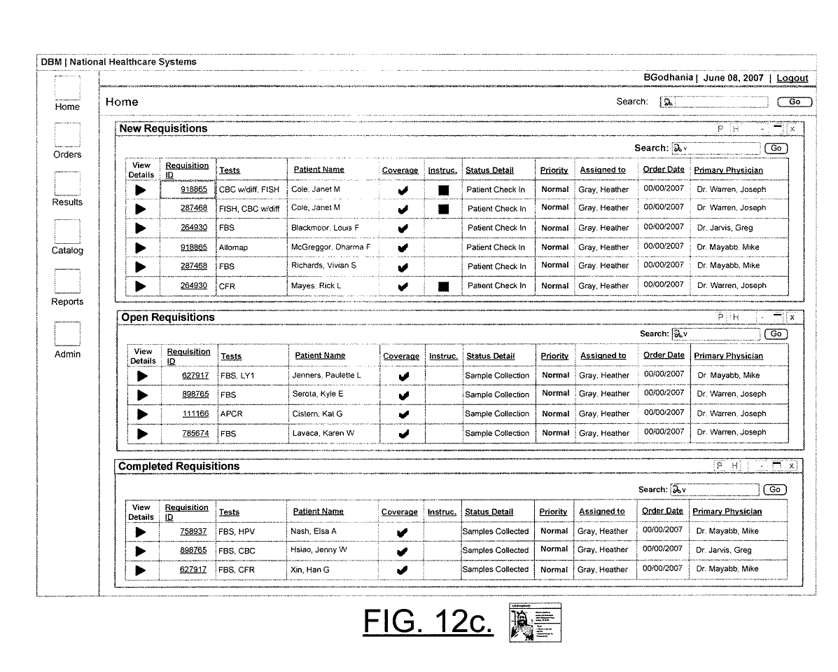

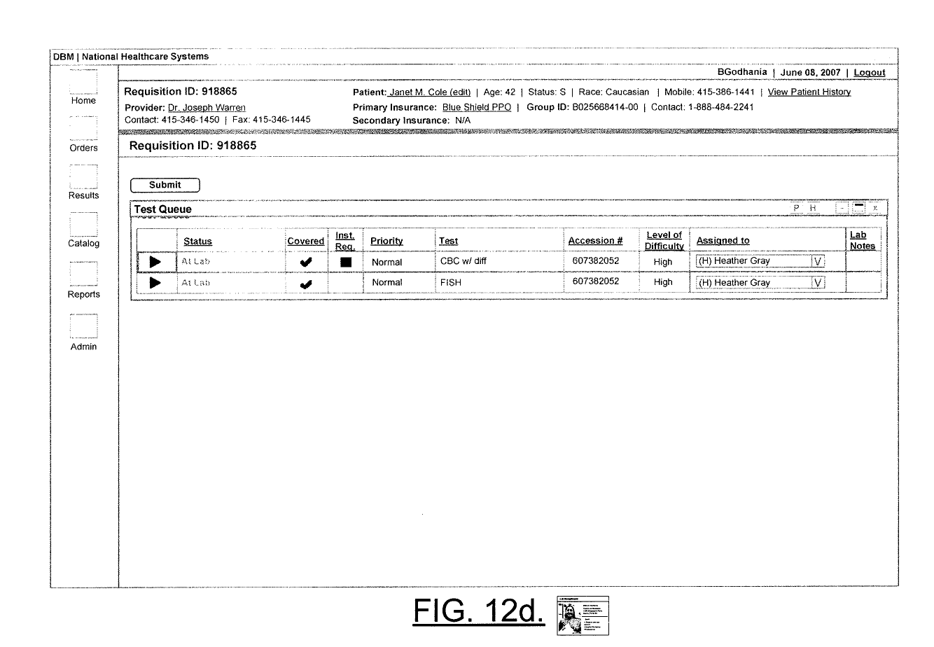

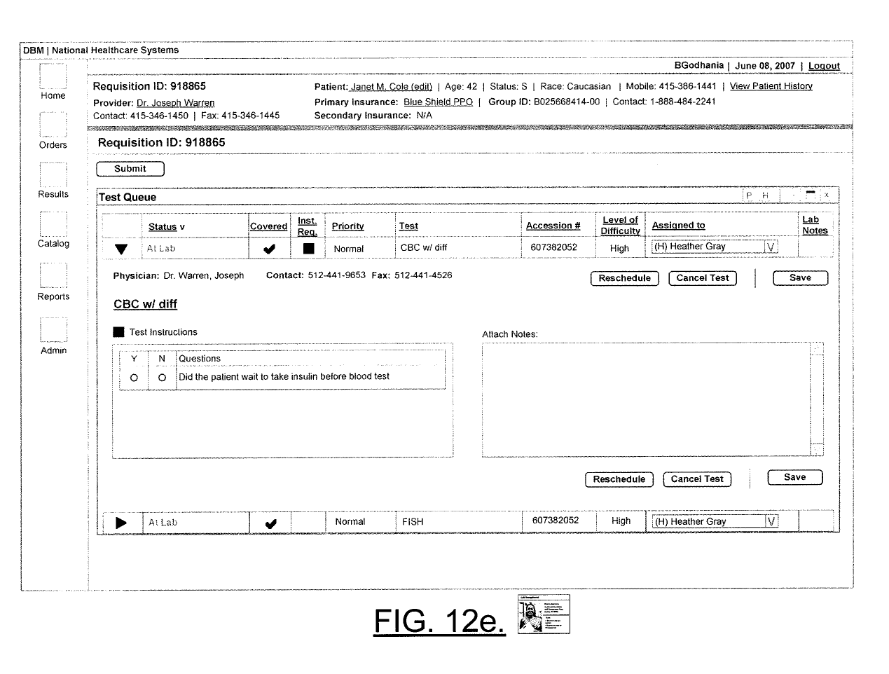

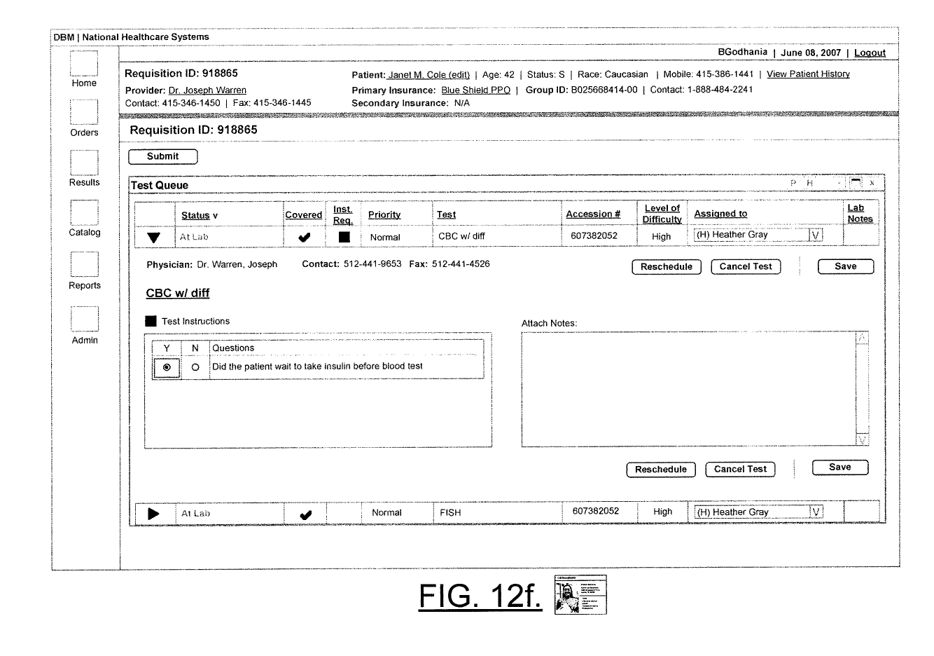

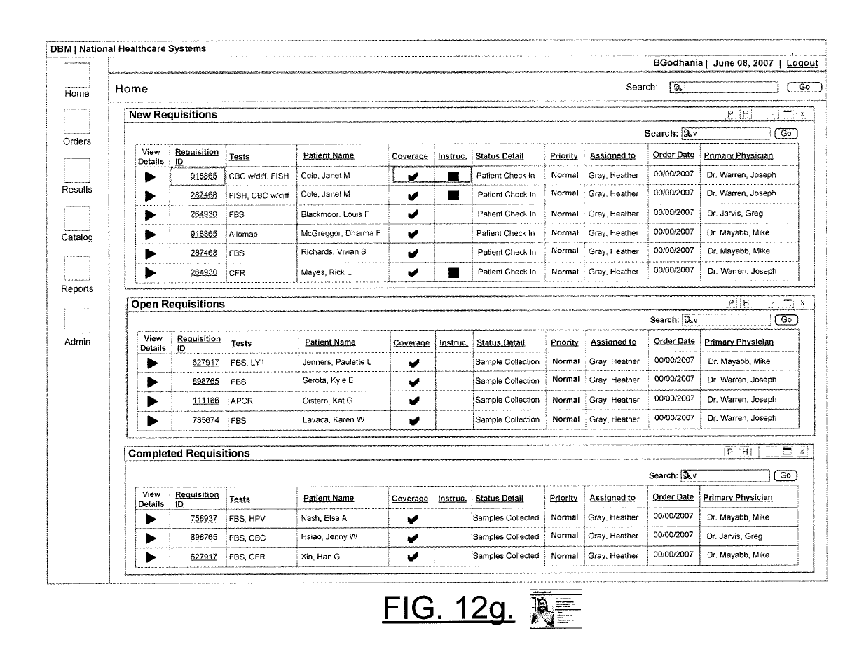

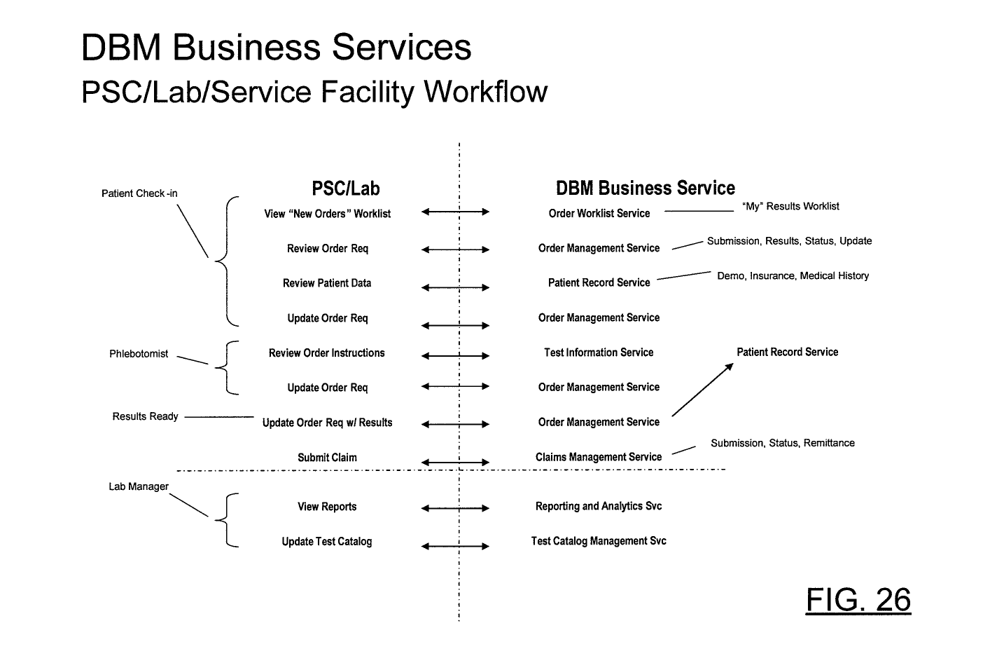

From the lab/facility's perspective, referring now to FIG. 5f and FIG. 26 for an overview of the lab/facility aspects, the method may include a patient, again Janet Cole, arriving at a particular lab/facility to have one or more tests or procedures performed, as shown in block 134. A receptionist at the lab/facility, here Bhavna Godhania (see FIG. 12a), logs into the system to check in Janet, after which Bhavna may be presented with a dashboard configured for her use (see FIGS. 12b and 12c). From Bhavna's dashboard, she may match Janet to a particular requisition or order, such as from in a new requisitions queue, as shown in block 136 or from a paper order received by Bhavna. Also from her dashboard, Bhavna may view various pieces of information regarding Janet's requisition including, for example, whether coverage for the particular procedures has been authorized and determined, or at least initially incomplete or pended (any of which may be resolvable by Bhavna or the appropriate staff at the lab/facility), and whether there are any unresolved instructions or other questions that need to be followed or answered before proceeding with the test/procedure. Bhavna may select Janet's requisition to open a requisition screen, which includes further details regarding Janet's requisition including the test(s) to be performed, Janet's eligibility and coverage, medical necessity information, test information and/or guidelines, and billing/payment status (see FIG. 12d). From the requisition screen, Bhavna may select a test (e.g., CBC w/diff) to view additional details regarding the test, and take care of any unresolved instructions/questions (see FIG. 12e). As shown in FIG. 12e, for example, a blood test for which Janet is scheduled may require that she wait to take insulin. If not, Janet may be required to reschedule her test. If so, however, Bhavna may answer the question in the positive, save, and submit the answer to the system, as shown in FIG. 12f. In addition to viewing the test details and any instructions, Bhavna may print the details and/or instructions, as necessary, as shown in block 138. Bhavna may then return to her dashboard, which may now indicate that there are no unresolved instructions/questions (see FIG. 12g). If there are unresolved questions that need to be directed to appropriate roles or persons within the lab, Bhavna may assign them to that person or role. Further, if questions must be resolved by the requesting provider, or paying entity, she may also have the ability to assign and add notes to the requisition and send it to the appropriate entity(s).

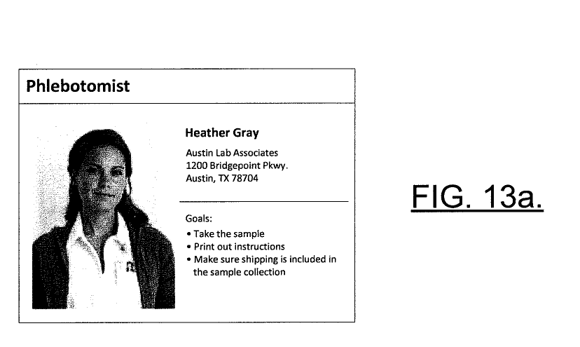

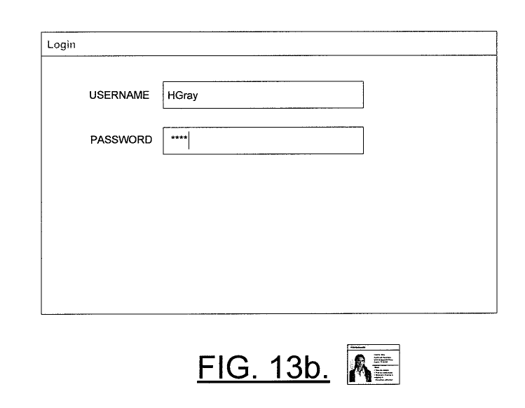

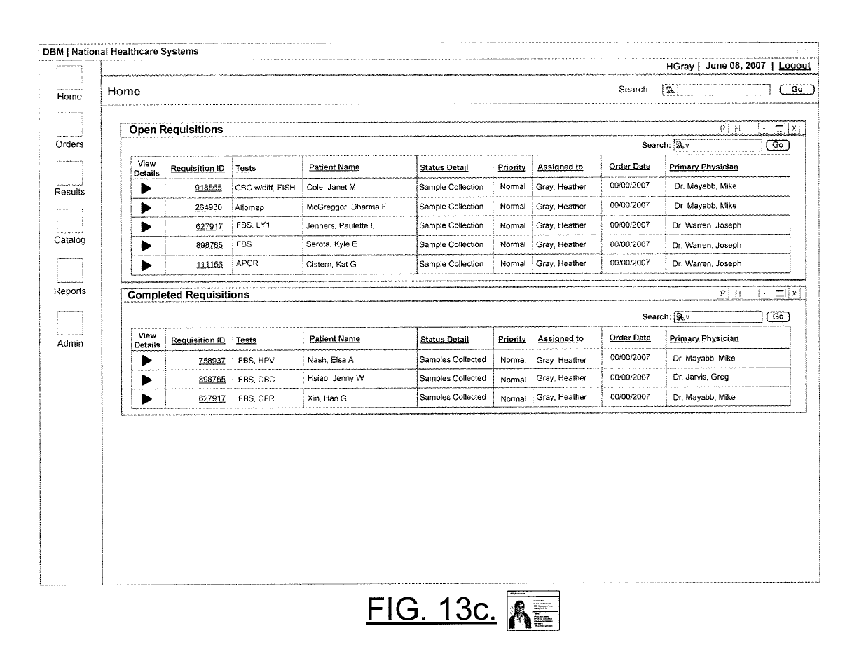

After Bhavna checks in Janet, she may direct Janet to a phlebotomist at the lab/facility, here Heather Grey (see FIG. 13a), who may log into the system to access her dashboard (i.e., dashboard configured for her use) (see FIGS. 13b and 13c) to continue processing Janet at the lab/facility. From her dashboard, Heather may select Janet's requisition to load Janet's requisition (see FIG. 13d), from which Heather may view any particular instructions for conducting Janet's test. Per Janet's particular test(s), Heather may collect, label, and courier to another location (if necessary) the requisite sample(s), as shown in block 140. Heather may then indicate that the sample(s) have been collected, such as by choosing a “done” option from Janet's requisition screen. The sample(s) may then be received by the lab or sent with the order to another lab, which may also receive Janet's order into the lab's LIS, Lab Information System, as shown in blocks 142 and 144. The system may update the status of Janet's requisition, as shown in block 146.

A lab technician may perform the requisite test(s), and enter the test results into the lab's LIS from which the results may be made available, as shown in blocks 148 and 150. For example, the LIS may submit the results to the system, which in turn, may make those results available, as shown in blocks 152 and 154 of FIG. 5g. The system may also notify the lab/facility's billing department at any point during this process to ensure the billing department can provide coverage and payment via the system and/or an appropriate dashboard. They will also be notified of the results to review, complete and collect any uncollected payment responsibility for the test, and either create a claim for the payor or initiate a billing cycle for the patient, as shown in blocks 156-160. In this regard, if a claim is created for the payor, the claim may be submitted to the system, which may make the claim available, as shown in blocks 162 and 164. Instead, the system may create and process the claim by fully adjudicating the claim via appropriately configured rules (such as fee schedules, contracts and term, payment history, among others) entered by each entity (such as the patient, lab, and payor) for that adjudication determination.

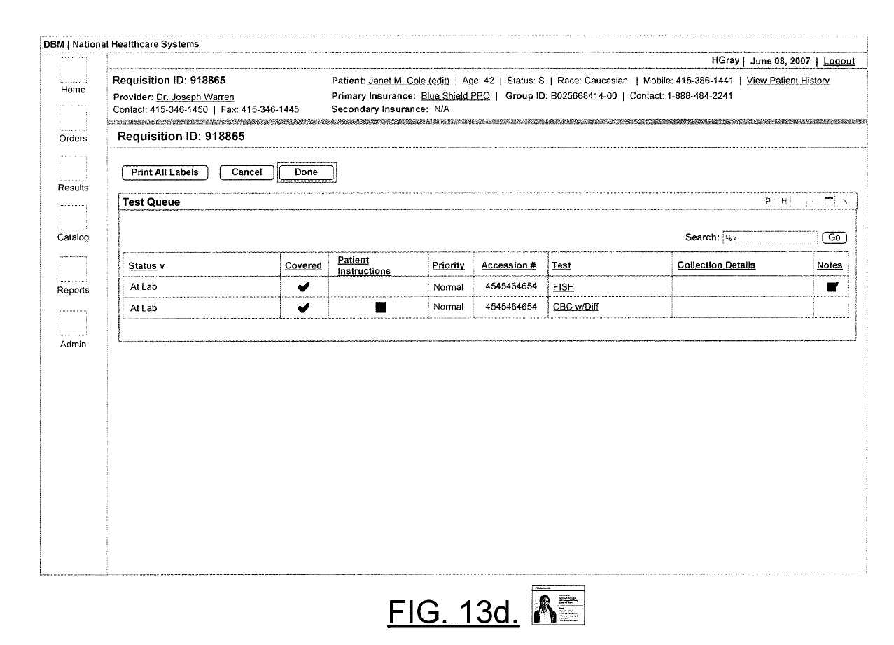

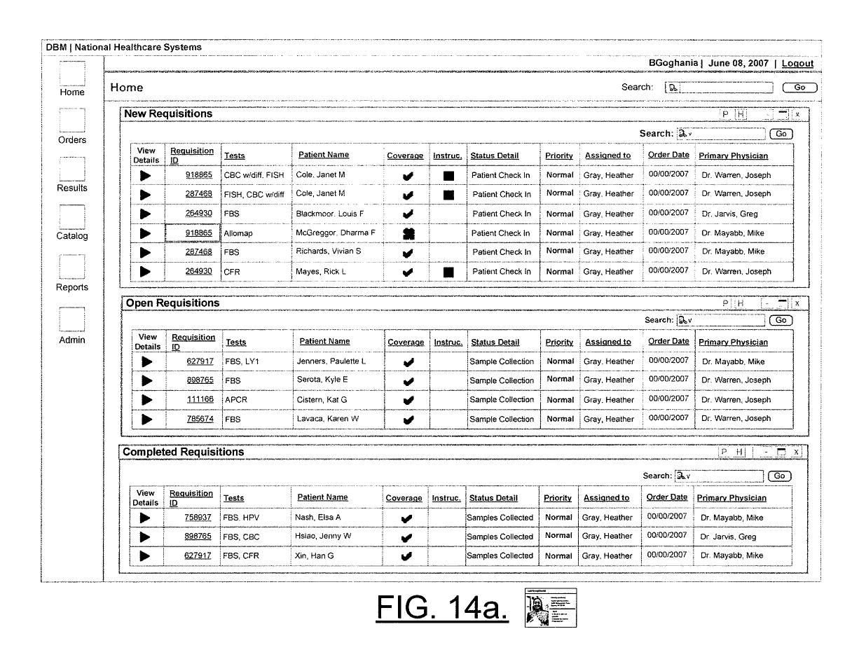

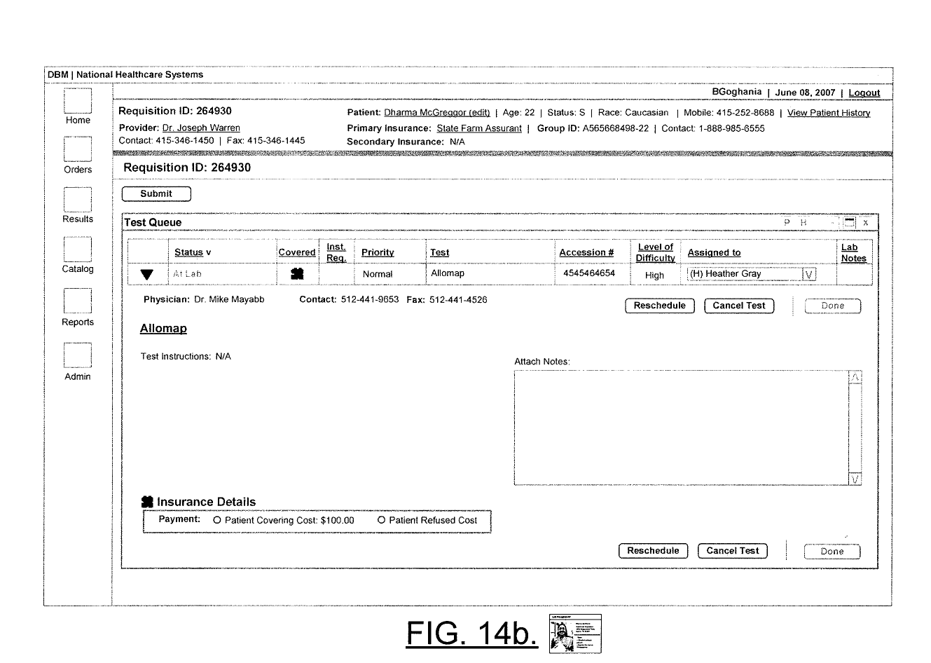

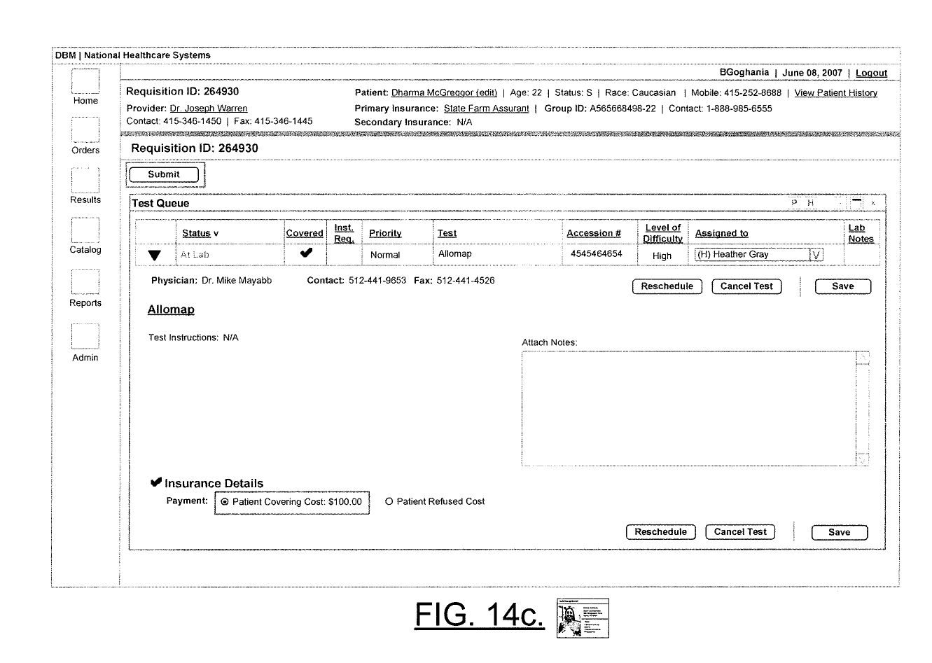

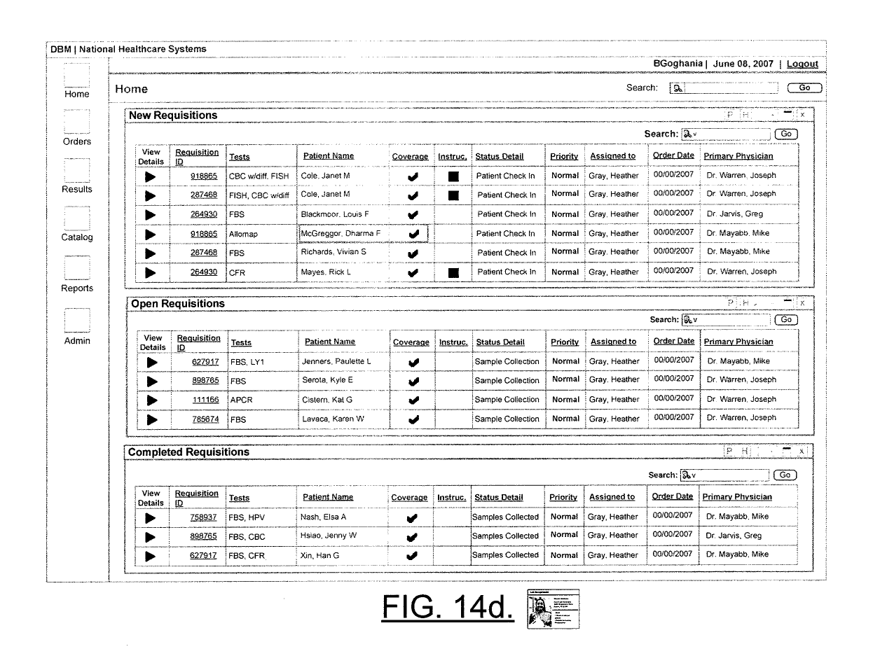

To illustrate further lab/facility aspects, consider the case of another patient, Dharma McGreggor, who arrives at the lab/facility to have one or more tests or procedures performed. In this instance, Bhavna again logs into the system to access her dashboard (see FIGS. 12b and 12c). From Bhavna's dashboard, she may match Dharma to a particular requisition or order, and may view various pieces of information regarding Dharma's requisition including, for example, whether coverage for the particular procedures has been authorized or at least initially pended (denial of which may be resolvable). Having noted that coverage for Dharma's test has initially been pended from her dashboard (see FIG. 14a), Bhavna may select Dharma's requisition to open a requisition screen to access further details regarding Dharma's requisition including the test(s) to be performed, coverage, medical necessity, and payment details (see FIG. 14b). From the requisition screen, Bhavna may attempt to resolve any coverage issue regarding the requisition. As shown in FIGS. 14b and 14c, for example, Bhavna may resolve a coverage issue in the system by indicating that Dharma plans to cover the cost of the test to be performed by the lab/facility or assigning the test to the appropriate entity as described above. Bhavna may then return to her dashboard to note that the coverage issue for Dharma's requisition has been resolved (see FIG. 14d).

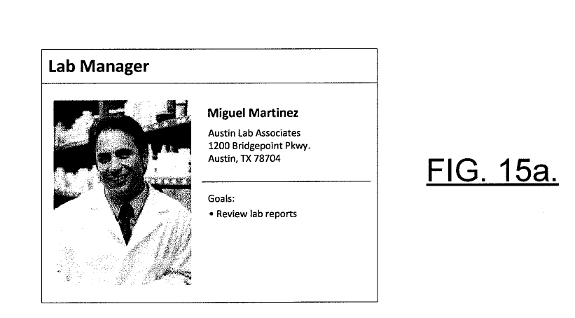

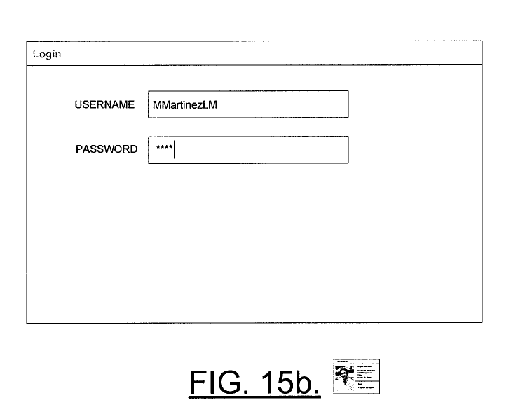

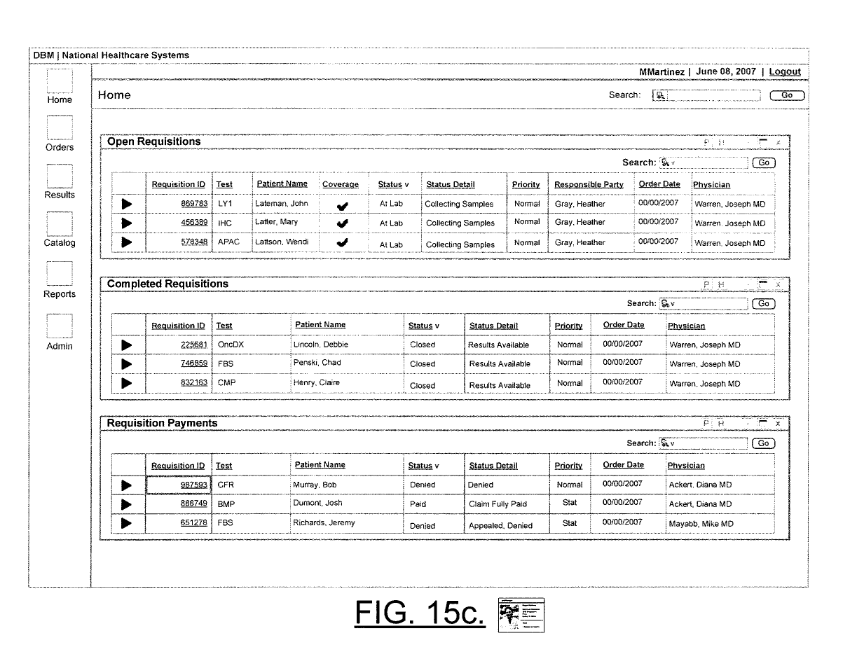

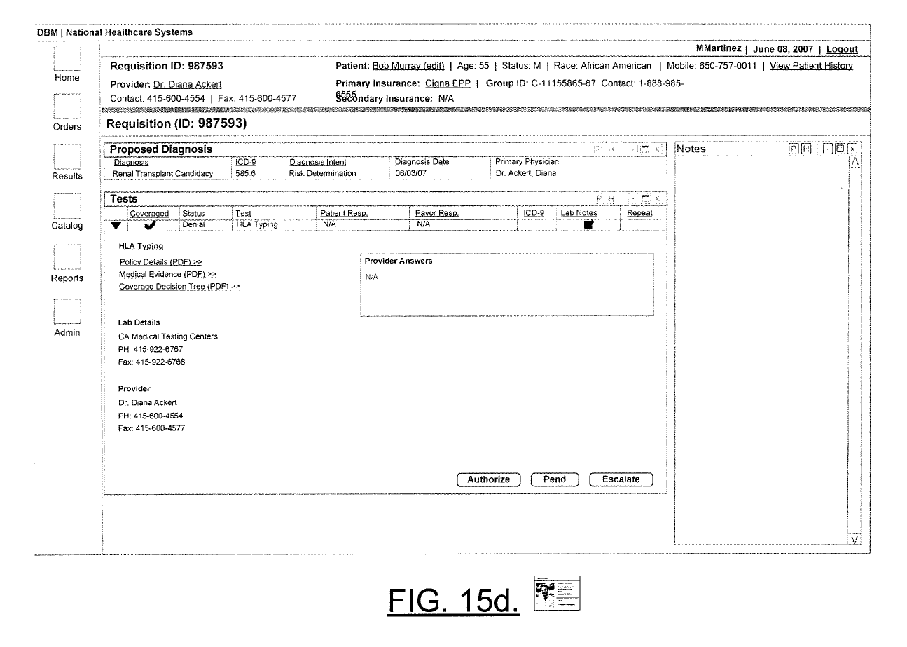

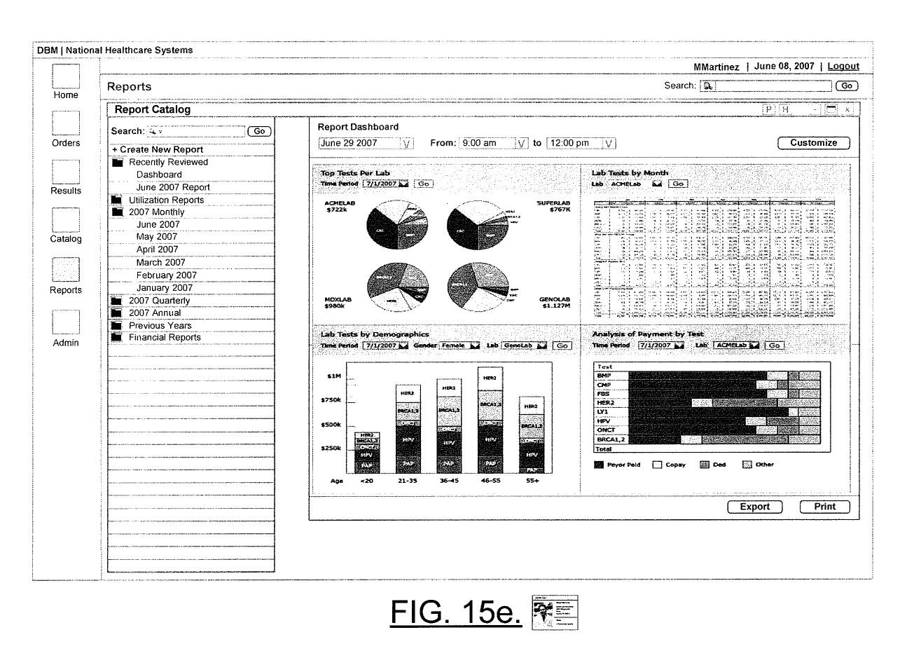

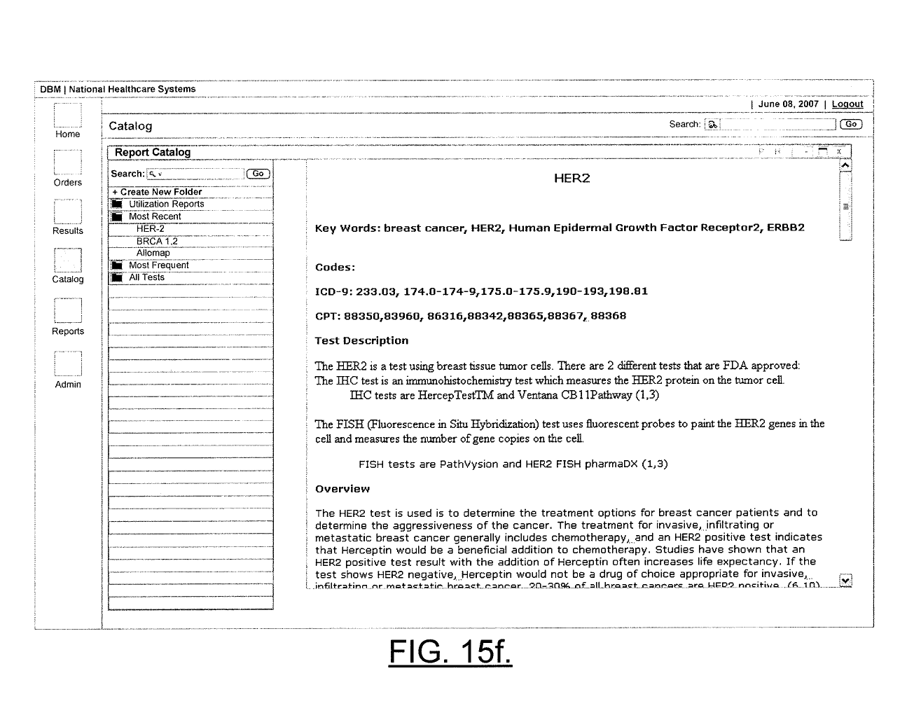

To illustrate another lab/facility aspect, consider the case of a lab manager, here Miguel Martinez (see FIG. 15a), who desires to review various lab reports. In such instances, Miguel may log in to the system to access his dashboard (see FIGS. 15b and 15c), from which he may review the lab report for a particular patient, Bob Murray in this instance. In this regard, Miguel may select Bob's requisition from Miguel's dashboard to load the requisition screen for Bob's requisition (see FIG. 15d), from which Miguel may review one or more lab/facility reports related to Bob's requisition and his history. Based on this Miguel will be able to view a requisition, ensure it has the appropriate information from the patient and requesting provider, view the results and any other pertinent information, and can then code based on the mapped codes of the meta-catalog. These codes represent the naming and billing convention most appropriate for the requisition. This can then be billed, claimed for, adjudicated, and cleared as appropriate. In addition to viewing lab reports related to Bob's requisition, Miguel may also view more comprehensive lab reports for Miguel's lab (or across one or more labs), such as by accessing a “reports” feature of the system (see FIG. 15e). Further, by accessing a “catalog” feature of the system, Miguel (and/or a number of other users) may access a catalog of available tests/procedures (see FIG. 15f). Through the system, Miguel may use this information to configure his inputted rules to the system to optimize his catalog offering and his profitability based on the lab's capacity, the lab/facility relationships with other reference labs/facilities, and the contracts and terms with the paying entities for the tests/procedures. In doing so, he may review the performance and analyze the transactions within the lab and between its providers and paying entities and with respect to industry standards as collected by or entered into the system to ensure optimal participation in the system.

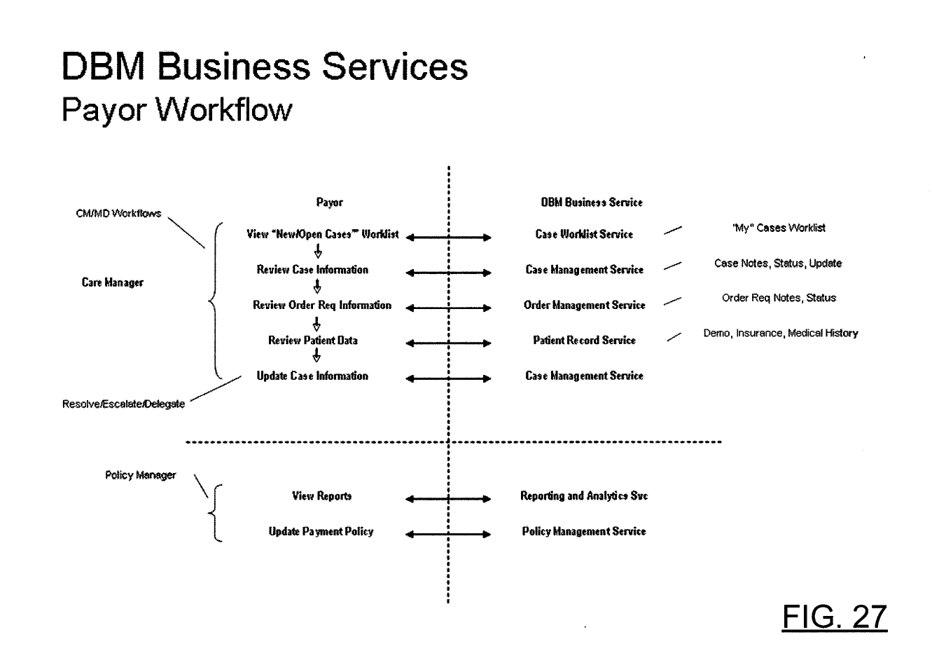

From the payor's perspective, referring now to FIG. 5h and FIG. 27 for an overview of the payor aspects, the method may include a claim/bill being received into the system, such as from the lab/facility (see FIG. 5g, block 164), as shown in block 166. The system may process it or forward the claim to the payor's claims management system. In either case, the system or the payor's system may perform an automatic adjudication of the claim according to that system's rules such as business, financial, clinical, policy, and payment rules, as shown in blocks 168 and 170. If an adjudication exception exists for the particular claim, that system may direct the claim to the attention of a case manager or medical director for their evaluation, after which the claim may be re-fed back into the system of exemplary embodiments of the present invention, as shown in block 174. If there is not an adjudication exception, that system may calculate payment responsibilities for the particular claim, update payment information in the system of exemplary embodiments, and direct the payor's billing department to send the patient an explanation of benefits (EOB), and send bills to any other payors, as shown in blocks 176-180. The payor may additionally send an explanation of payment (EOP) and payment to the respective lab/facility to complete the process, as shown in blocks 182 and 184.

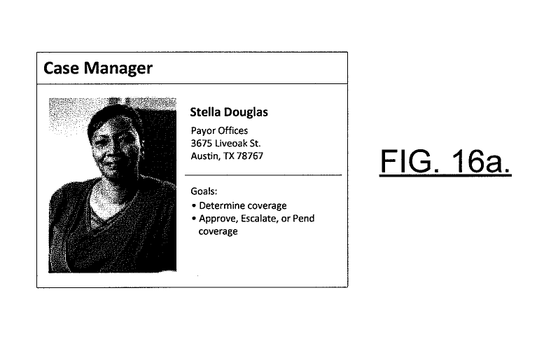

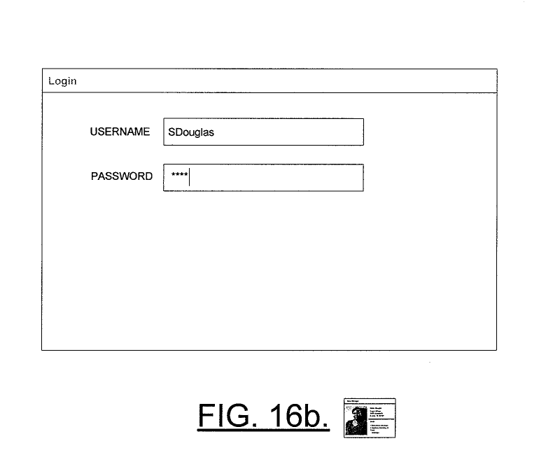

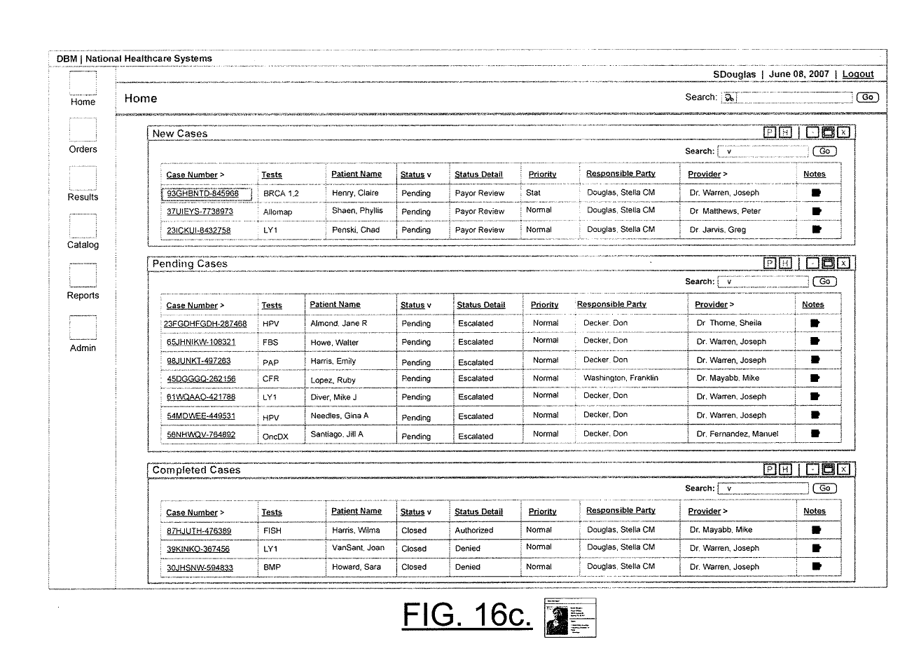

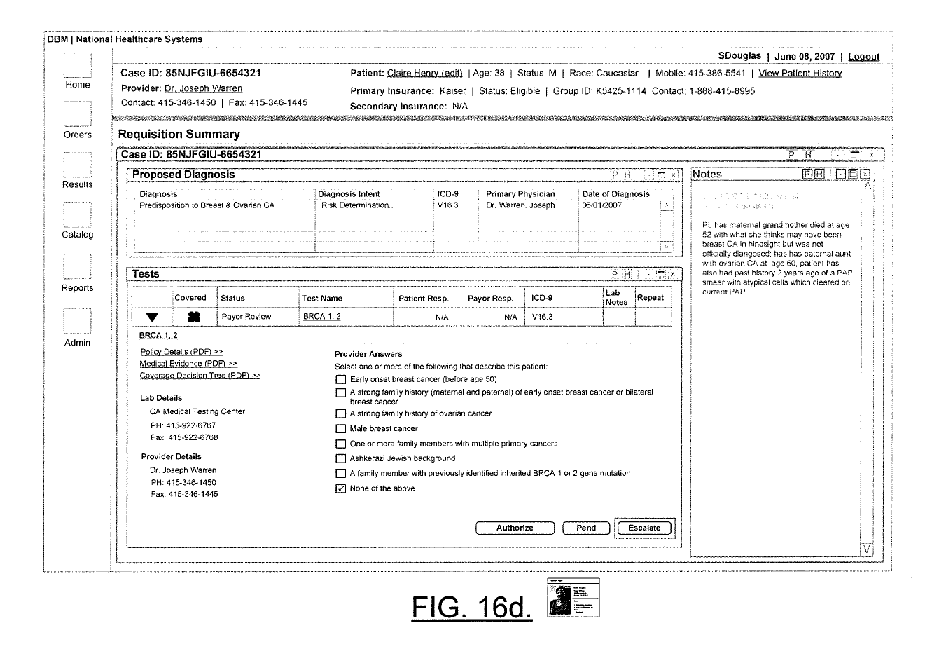

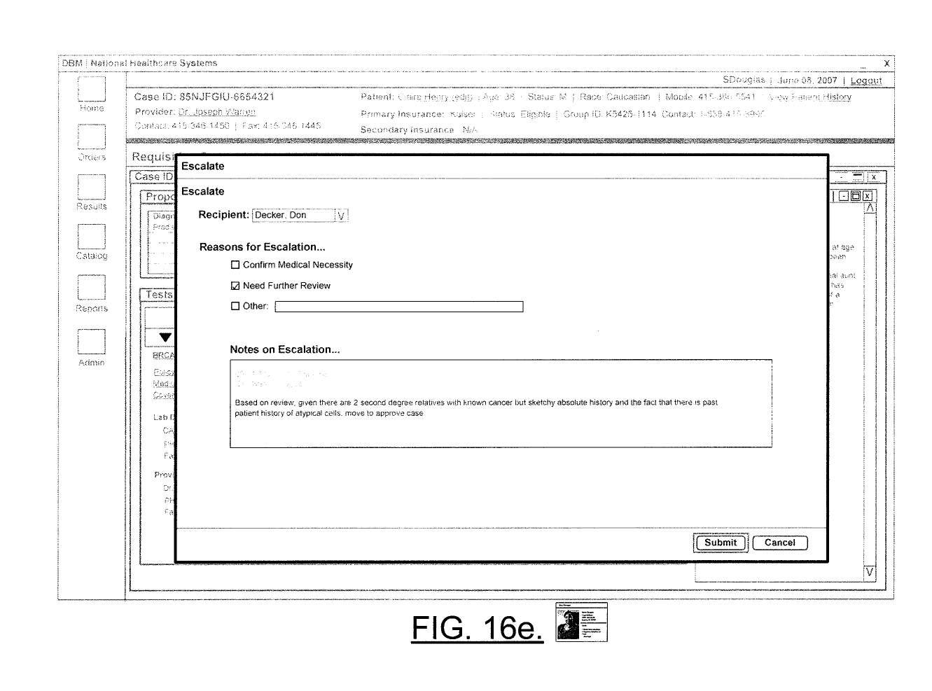

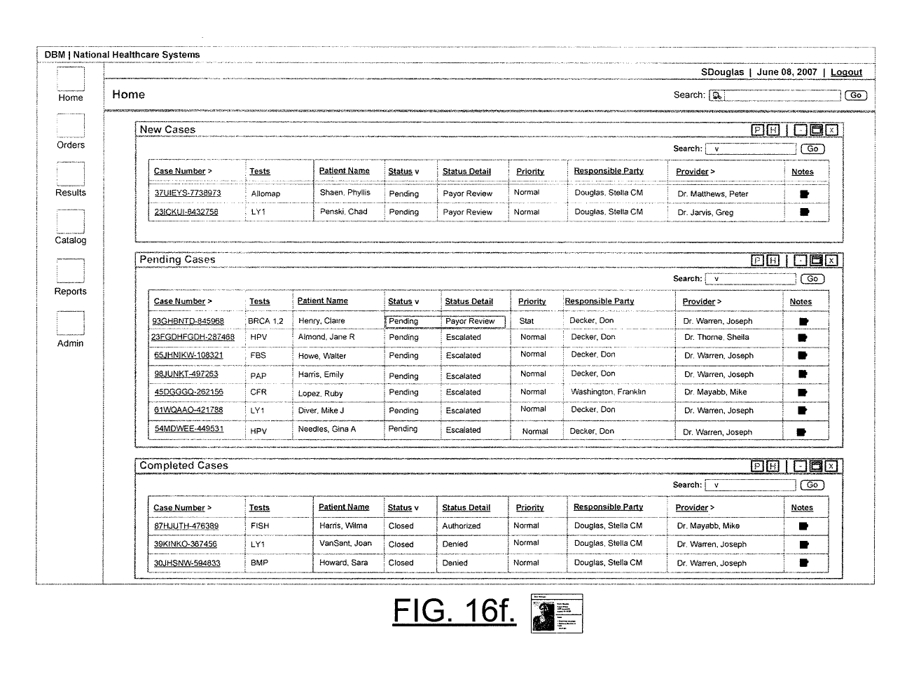

In instances in which the payor action is required during the coverage authorization/determination process for a particular test or procedure, an in-progress case may be presented for payor review, as shown in block 188 of FIG. 5i. To illustrate this aspect, a case manager, here Stella Douglas (see FIG. 16a), logs into the system to review coverage for different tests/procedures, after which Stella may be presented with a dashboard configured for her use (see FIGS. 16b and 16c). From Stella's dashboard, she may be notified of a case awaiting her authorization, as shown in block 190. Again returning to patient Claire Henry, Stella may note Claire's case in a new case queue in her dashboard, and select her case to load Claire's requisition summary (see FIG. 16d). From Claire's requisition summary, Stella may review Claire's case and evaluate appropriate case material, as shown in block 192. This may be done with the system or directly inside the payor's system as appropriate. As needed, Stella may also gather any additional information that may be required for making an authorization/coverage decision, as shown in block 194 and explained below with respect to another patient, Phyllis Shaen.

From the available information, Stella may make a coverage decision regarding Claire's claim, from which the system may update Claire's coverage status and notify the clinician of that status (see FIG. 4c, blocks 88 and 90), as shown in blocks 196 and 198 of FIG. 5i. In various instances, however, Stella may need to involve the payor's medical director in the coverage decision. In these instances, Stella may escalate the case to the medical director, here Dr. Don Decker. By choosing an escalation option from Claire's requisition summary, the system may present Stella with an escalation form from which Stella may indicate to whom she is escalating the case, the reason for the escalation, and any particular notes regarding the escalation (see FIG. 16e). Stella's dashboard may then be updated as to Claire's claim to indicate that it has been escalated to Dr. Decker (see FIG. 16f).

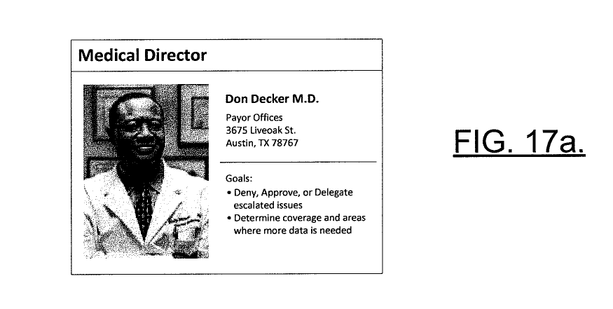

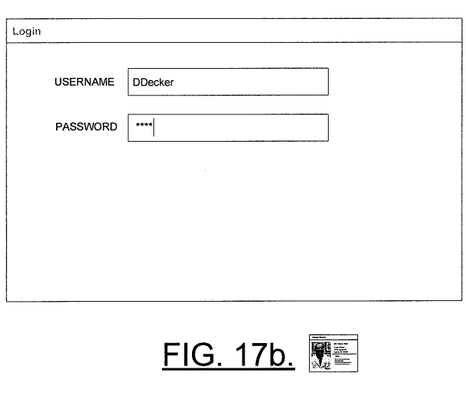

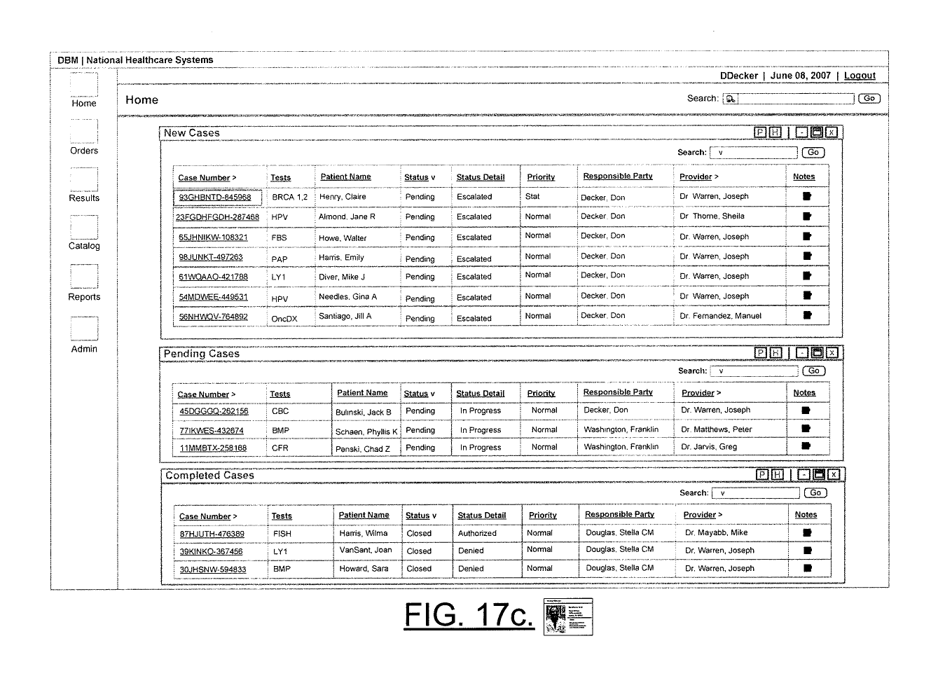

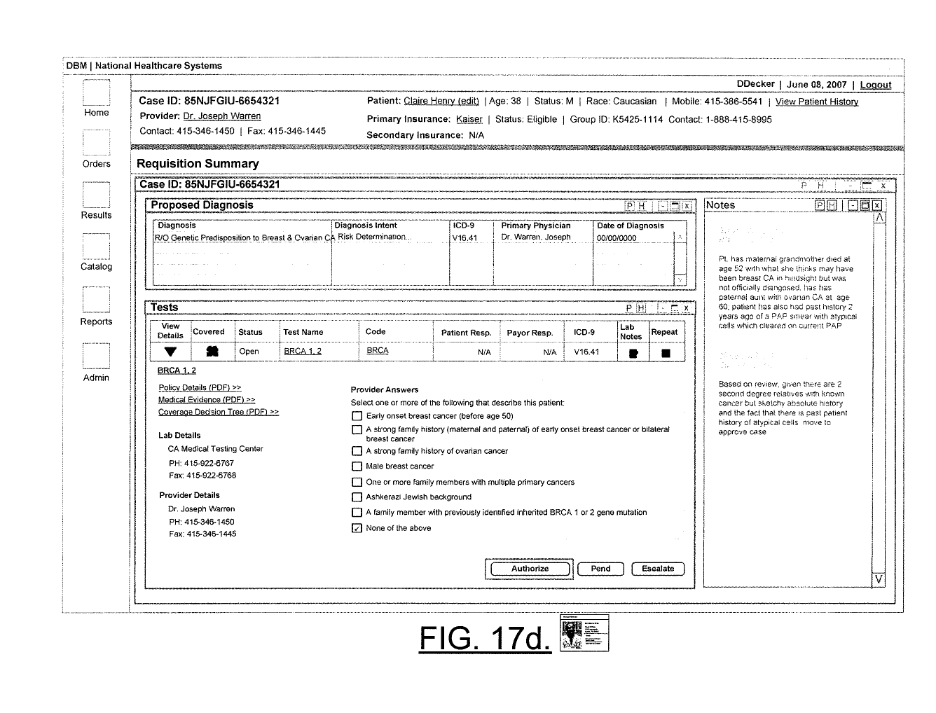

Sometime after Stella escalates Claire's case to Dr. Decker (see FIG. 17a), Dr. Decker logs in to the system to access his dashboard (see FIGS. 17b and 17c), from which Dr. Decker may see Claire's case in his new cases queue. Dr. Decker may then select Claire's case to open her requisition summary from which Dr. Decker may review information associated with her case, including the requested test/procedure (see FIG. 17d). Dr. Decker may then decide to authorize the test, and accordingly choose an authorize option from Claire's requisition summary. By choosing the authorize option, the system may present an authorize screen, from which Dr. Decker may indicate the reason for his authorization, and submit the authorization/coverage determination (see FIG. 17e). Dr. Decker may then return to his dashboard to find that Claire's case has been updated to an authorized, and thus closed, state (see FIG. 17f).

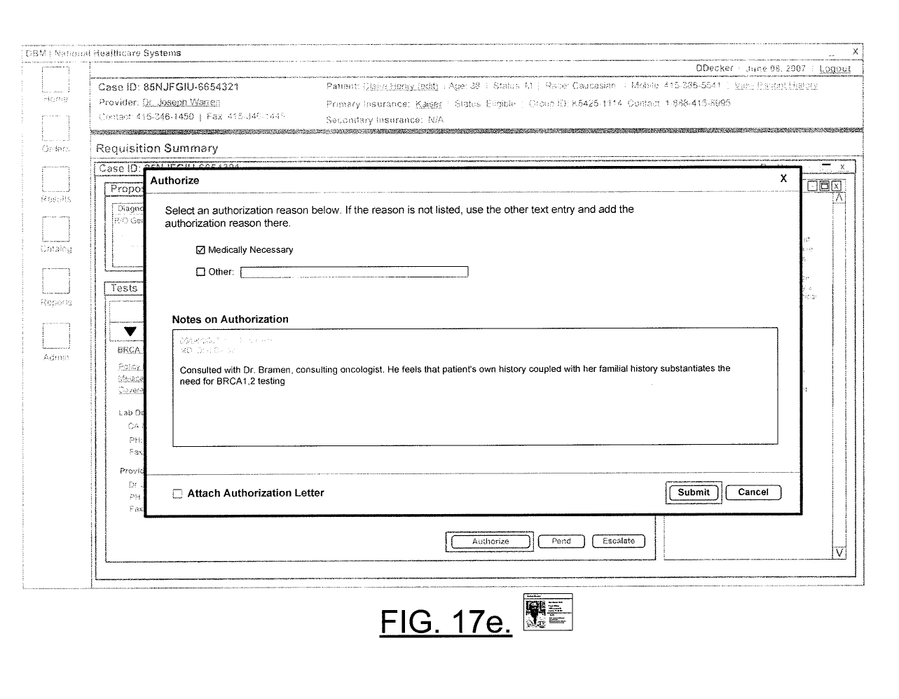

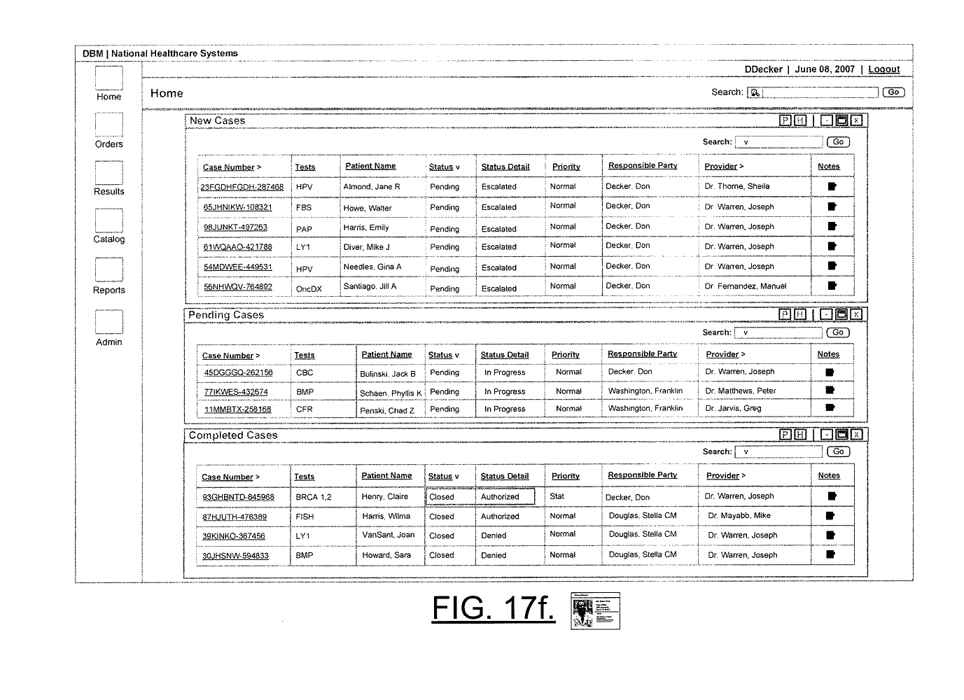

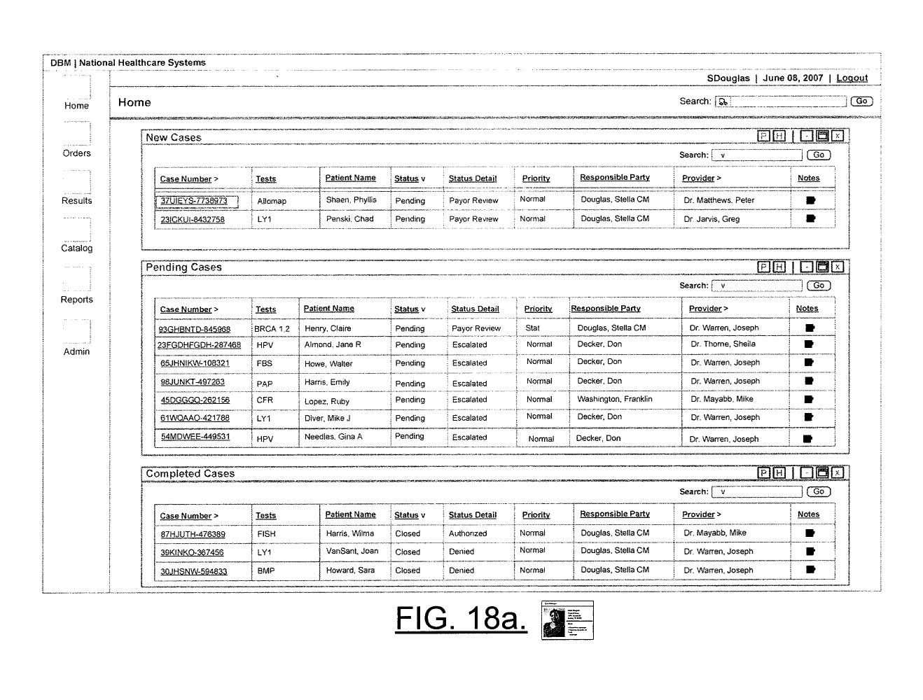

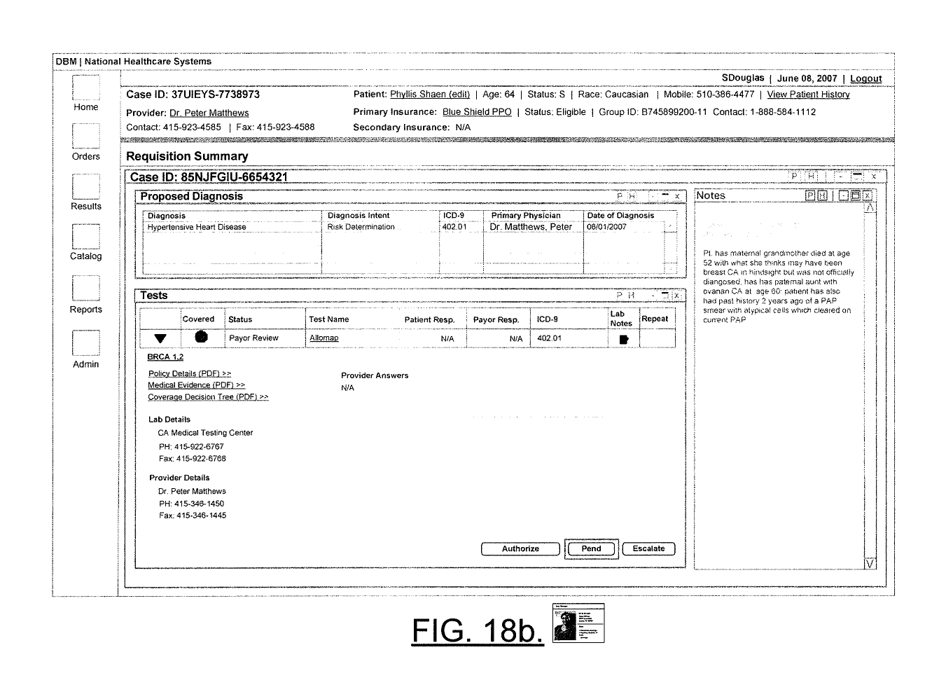

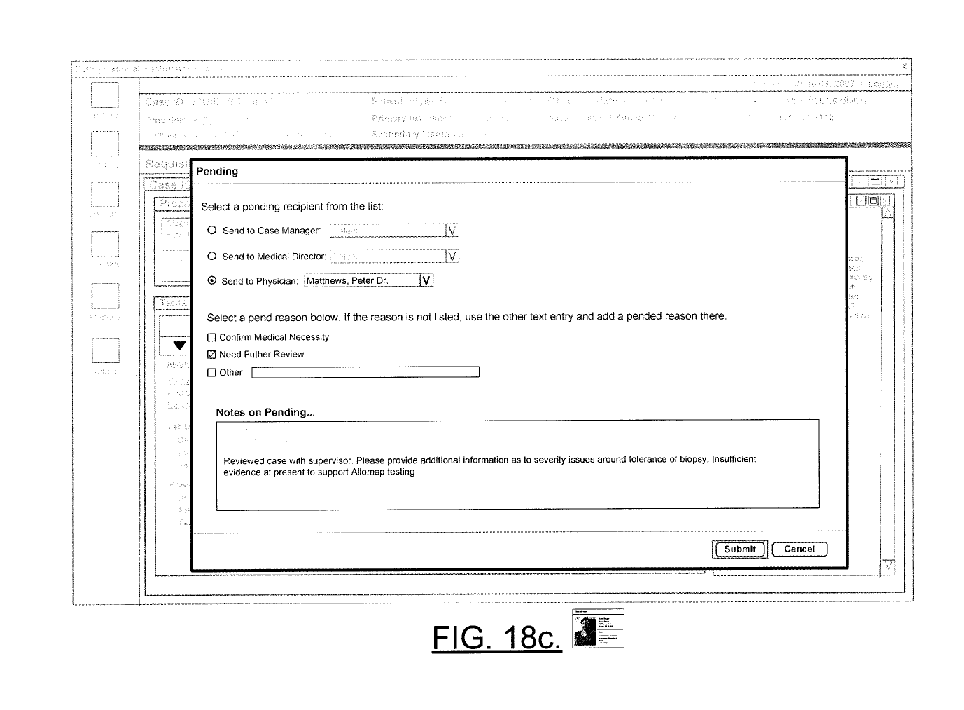

To illustrate further lab/facility aspects, consider the case of another patient, Phyllis Shaen, who also has a case pending before Stella. In this regard, Stella may be reviewing the new cases on her dashboard, and note Phyllis's case (see FIG. 18a). Stella may select Phyllis's case to load Phyllis's requisition summary (see FIG. 18b), from which Stella may review Phyllis's case and evaluate appropriate case material. Being unable to resolve Phyllis's issue based on currently available information, Stella pends the case to another case manager, Chad Becker, by selecting the pend option and entering a number of pieces of information as to her pending the case, including the reason for her pending the case (see FIG. 18c). Stella may then return to her dashboard and note that it has been updated as to Phyllis's claim to indicate that it has been pended to Chad Becker (see FIG. 18d).

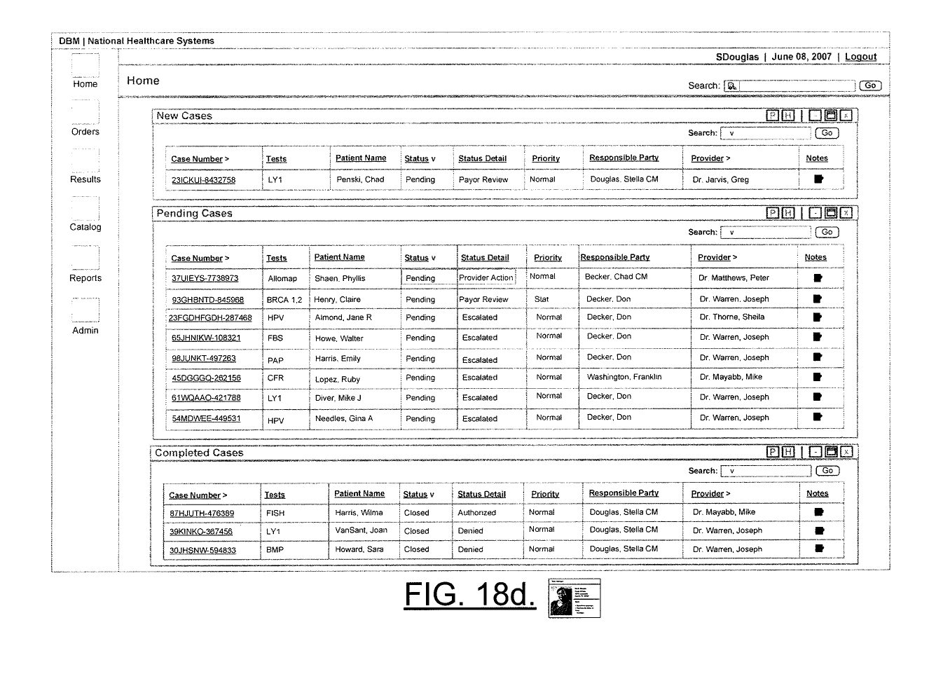

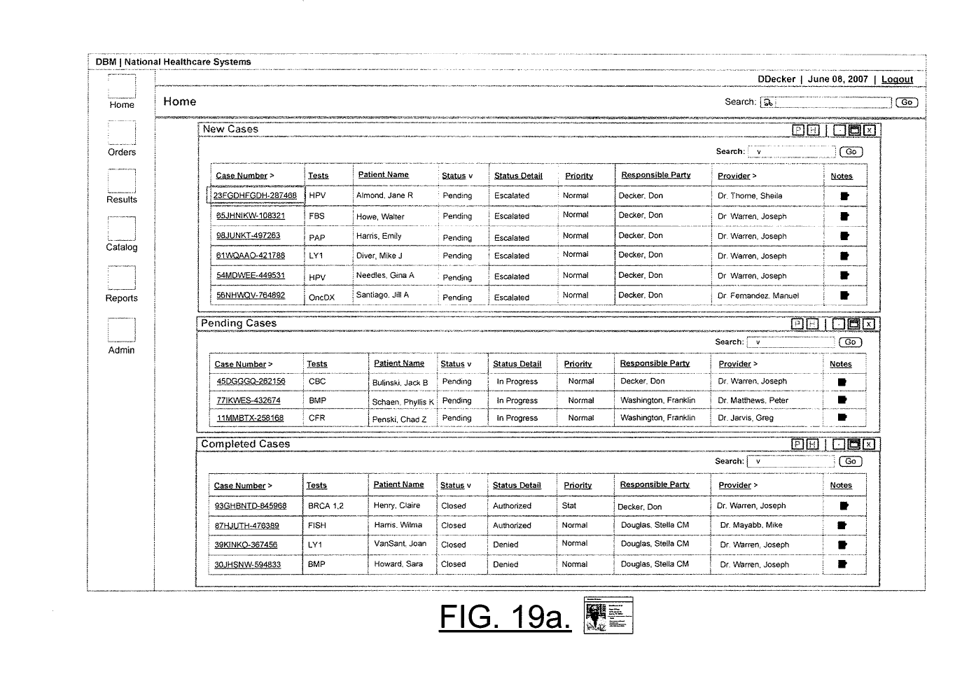

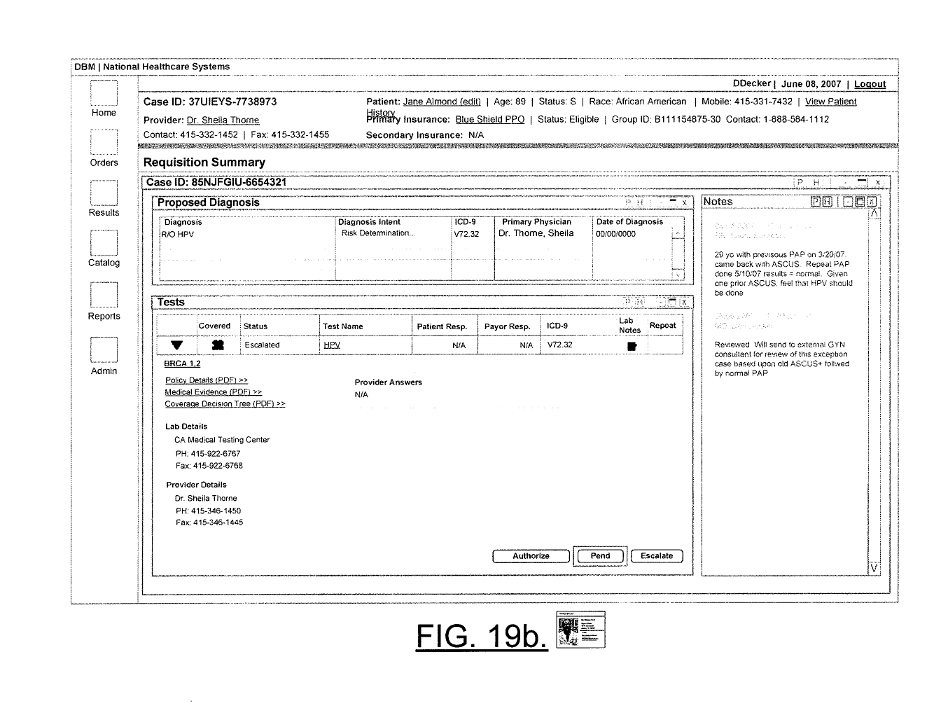

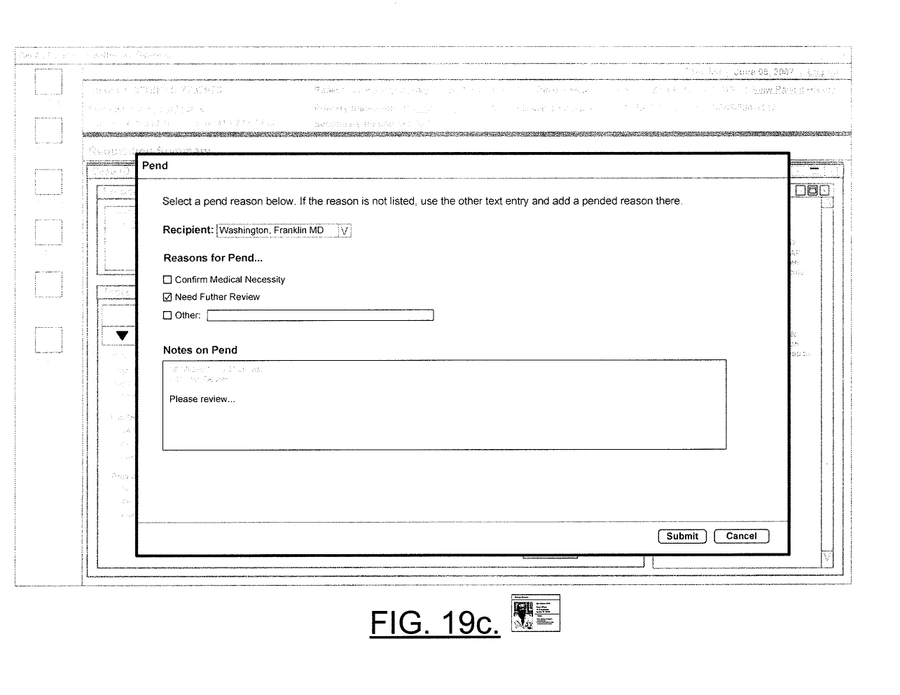

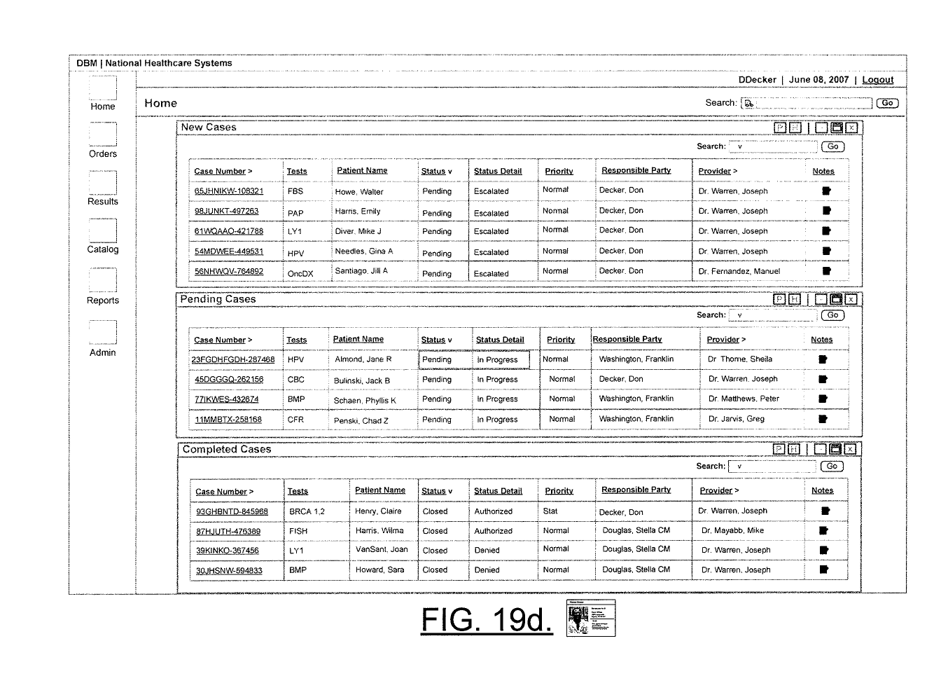

Returning now to Dr. Decker again reviewing his dashboard (see FIG. 19a). Dr. Decker selects the case of another patient, Jane Almond, from his dashboard to load Jane's requisition summary (see FIG. 19b). From Jane's requisition summary, Dr. Decker may review Jane's case and evaluate appropriate case material. Being unable to resolve Jane's issue based on currently available information, Dr. Decker pends the case to another medical director, Dr. Franklin Washington, by selecting the pend option and entering a number of pieces of information as to his pending the case, including the reason for his pending the case (see FIG. 19c). Dr. Decker may then return to his dashboard and note that it has been updated as to Jane's claim to indicate that it has been pended to Dr. Washington (see FIG. 19d).

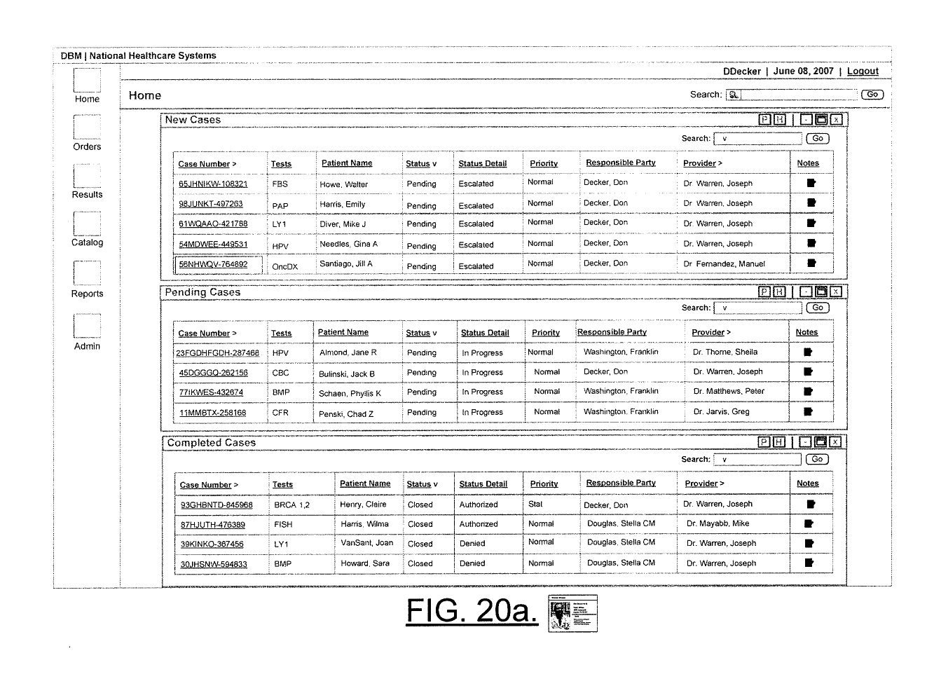

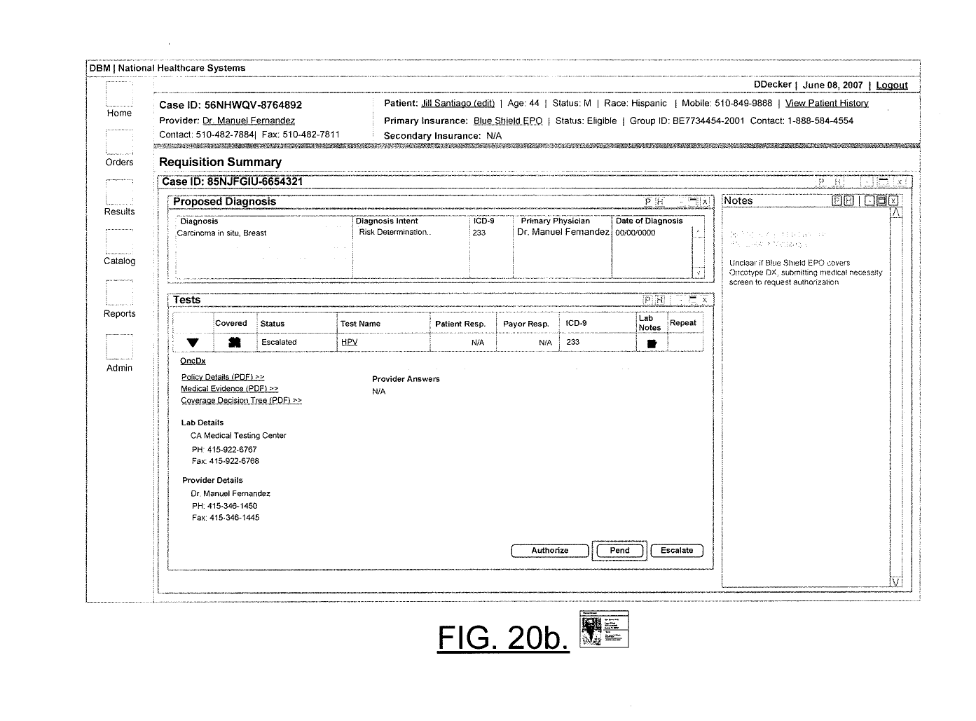

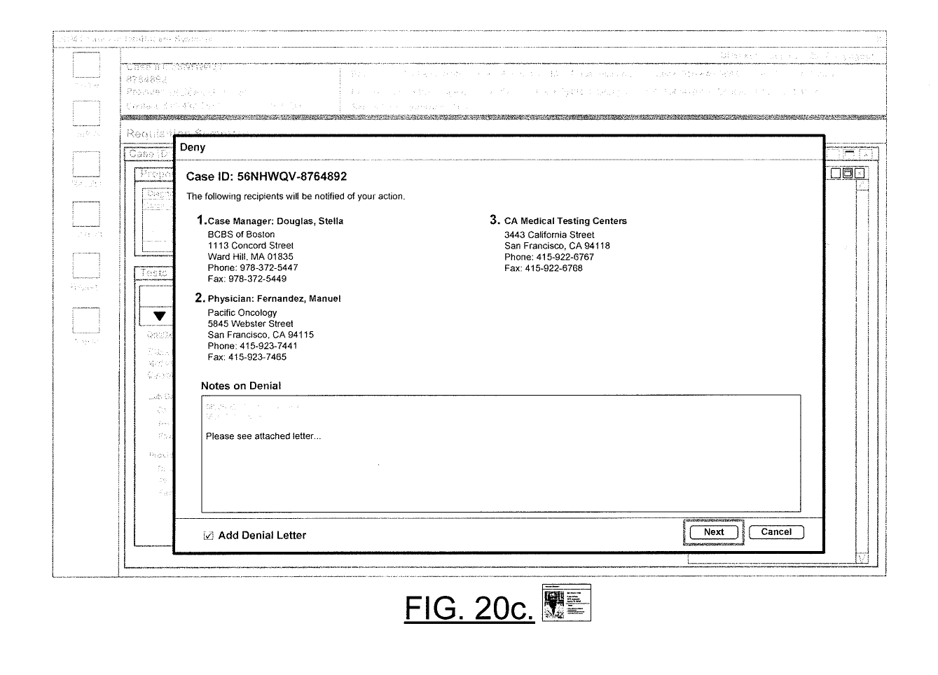

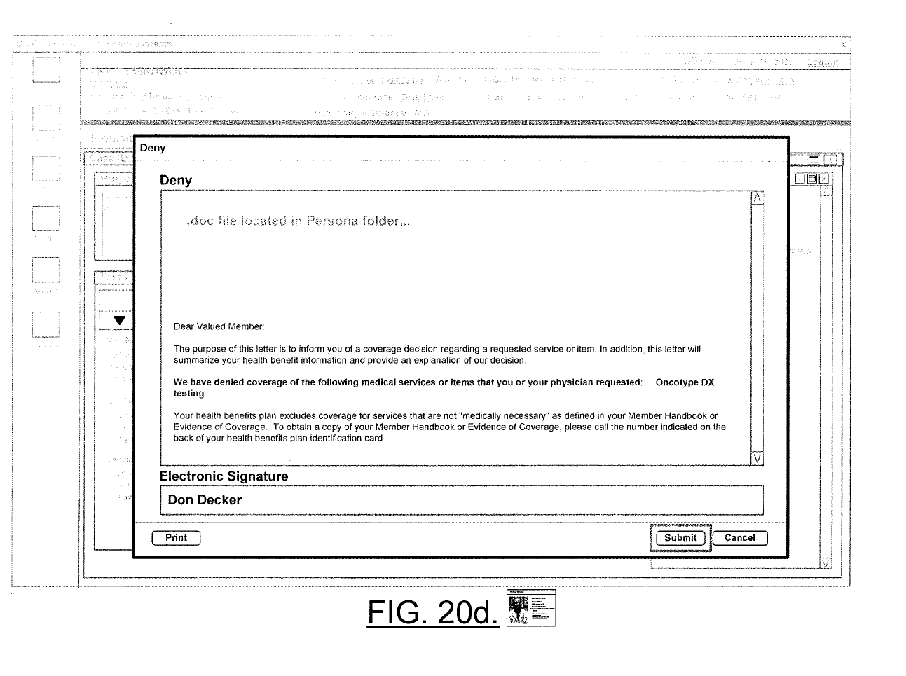

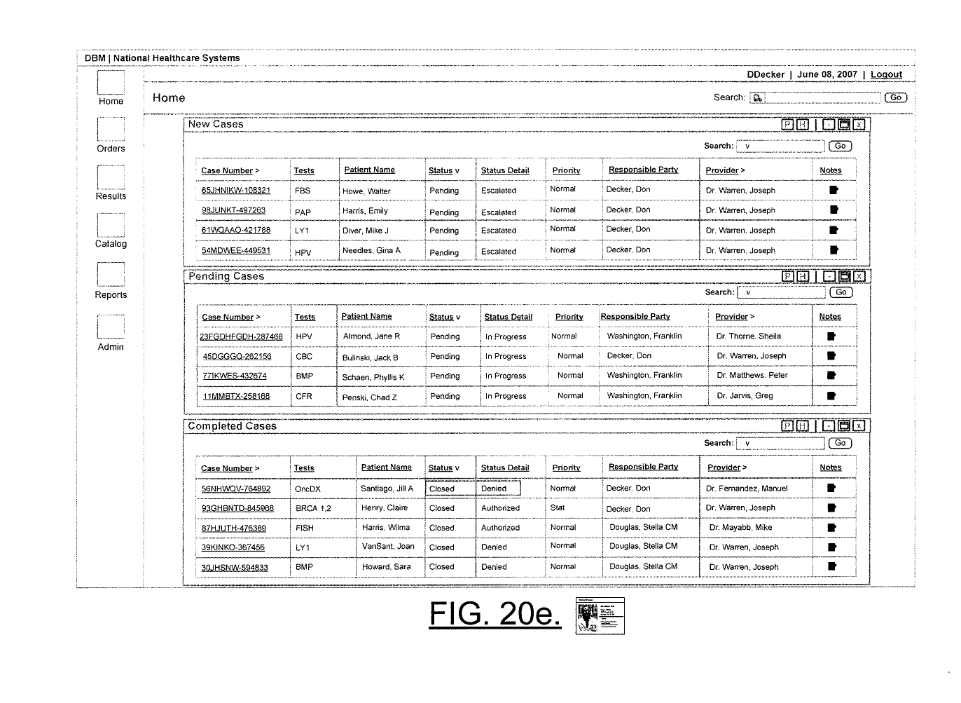

Also on returning to his dashboard, Dr. Decker turns to the case of yet another patient, Jill Santiago, and loads her requisition summary (see FIGS. 20a and 20b). From Jill's requisition summary, Dr. Decker may review Jill's case and evaluate appropriate case material. Having reviewed her proposed diagnosis and selected lab test/procedure, Dr. Decker decides to deny coverage for the test, such as by choosing a deny option from Jill's requisition summary. On choosing to deny coverage for Jill, the system presents Dr. Decker with a deny screen that lists those who will be notified of the coverage denial, and from which Dr. Decker may append any notes regarding the denial (see FIG. 20c). Also from the deny screen, Dr. Decker may choose to add a denial letter, which the system may present for his review and electronic signature (see FIG. 20d). Dr. Decker may then submit the coverage denial, and return to his dashboard which has been updated to reflect the pended coverage for Jill's case (see FIG. 20e).

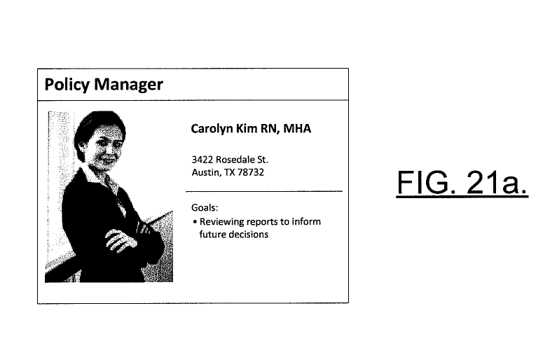

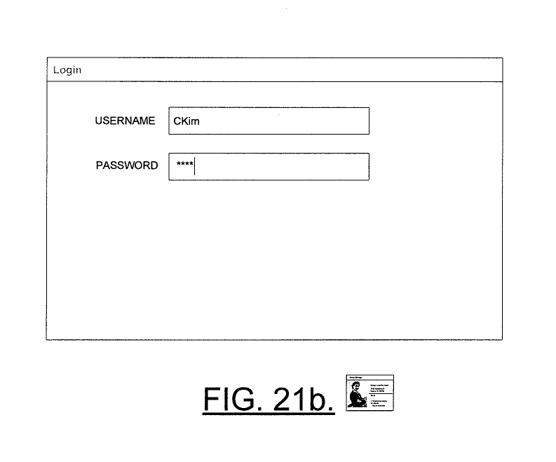

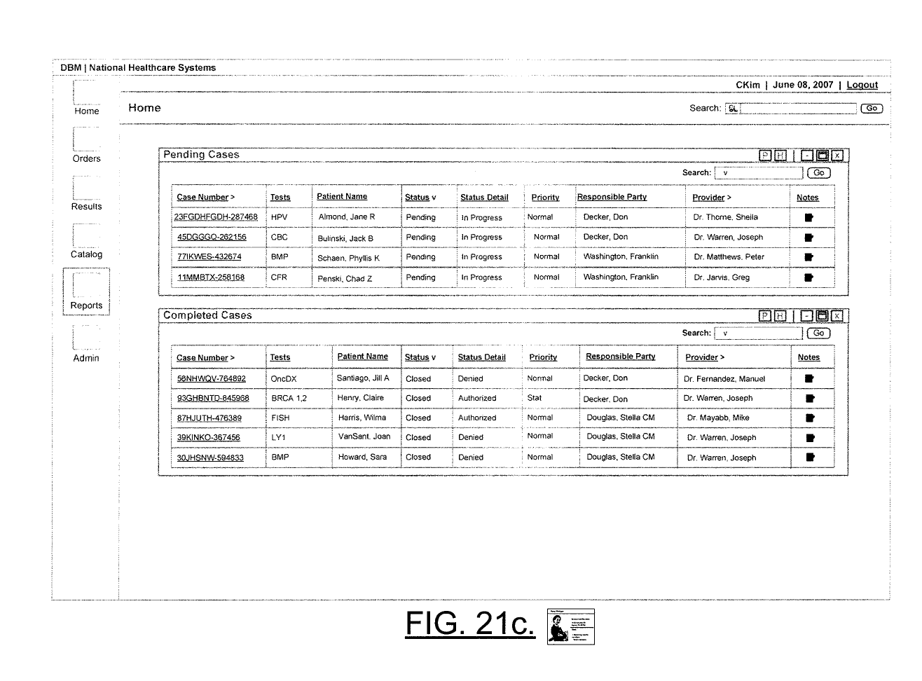

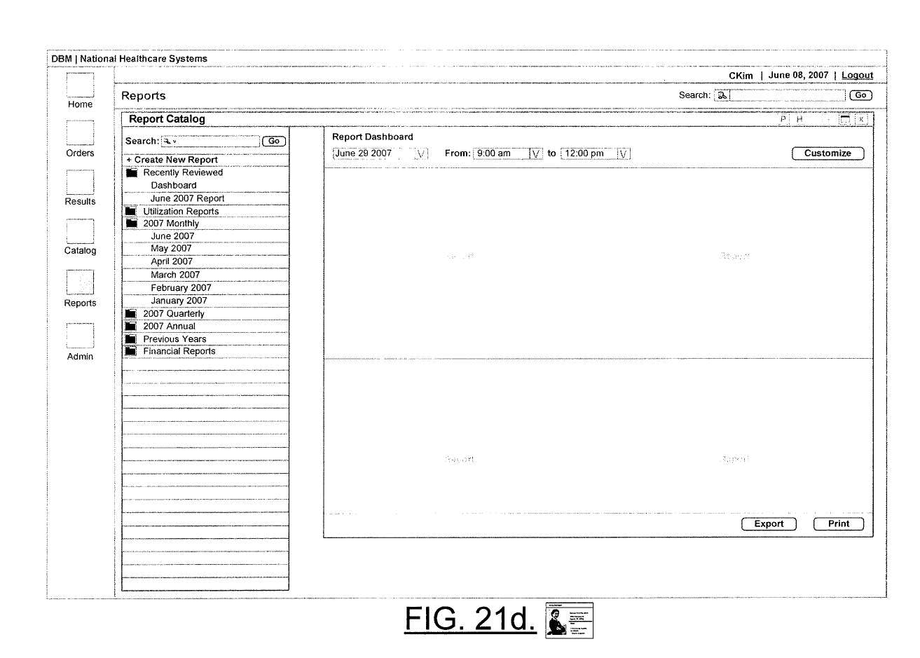

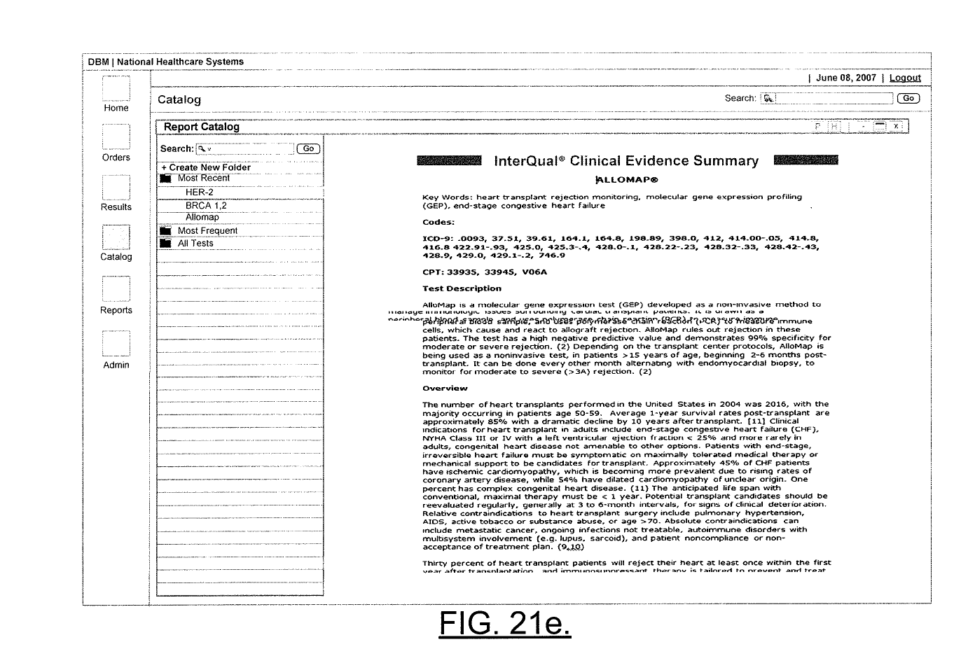

To illustrate another payor aspect, consider the case of a policy manager, here Carolyn Kim (see FIG. 21a), who desires to review various payor-related reports. In such instances, Carolyn may log in to the system to access her dashboard (see FIGS. 21b and 21c), from which she may access a “reports” feature of the system (see FIG. 21d). Further, by accessing a “catalog” feature of the system, Carolyn (and/or a number of other users) may access a catalog of available tests/procedures (see FIG. 21e). Carolyn and other payor/paying entity users will be able to review the system data collected within the paying entity's transactions and in transaction with the labs/facilities, physician's/physician's office, and the patient. These transaction data will be analyzed and reviewed to optimize the policies, contracts, network and coverage rules entered, configured, edited, and reviewed by the payor/paying entity and between its respective system stakeholders (such as patients, labs, and physicians).

According to various exemplary embodiments, each of the users and/or entities to the system may be able to create, edit, configure, review, and test the rules and content that is entered into the system. This function may be delegated to another entity. Transactions will be run against these rules and resulting outcomes will be reported. The data may be used to optimize the performance of the system as per user/entities performance requirements. To do so, the system may incorporate the ability to, for example, enter, manage, and configure a lab/facilities catalog and billing conventions, a payor's coverage, benefit, payment policies, and network, contract, and fee schedules, as well as provider and member rosters. Further a physician/physician office may maintain the office's decision support rules, billing, and appropriate patient information. Patients may be able to include appropriate rules as well including for example data sharing preferences. These data and rules can be automatically retrieved based on integration to the system or through manual/semi-automated management by the user/administrator/entity. Finally the system can transact with each entities' systems for these rules and data, if the rules and/or data are not present in the system. This is enabled by the network services architecture and approach utilized and implemented by this system.

In accordance with another aspect of the present invention, all or a portion of the system of the present invention, such as all or portions of the patients 12, clinicians 14, labs/facilities 16, payors 18, service provider 20, and/or networked service 22, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

Further, FIGS. 5 and 5a-5i are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. It should therefore be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system comprising:
one or more processors configured to receive one or more proposed medical diagnosis of a patient,
wherein the one or more processors are configured to automatically identify one or more potential medical services to be performed with respect to the patient, the identified one or more medical services being deemed relevant to the proposed medical diagnosis,
wherein the one or more processors are configured to receive selection of a potential medical service from the identified one or more potential medical services, and
wherein the one or more processors are configured to present an automated, real-time indication regarding plan coverage for the selected medical service based on the patient and the paying entity/plan rules of the patient.

2. A system according to claim 1, wherein the one or more processors being configured to present an indication regarding plan coverage includes being configured to present an indication of coverage or unresolved coverage for the selected medical service, and
wherein, when the indication is of unresolved coverage, the processor is further configured to receive additional information, and present a real-time update of the indication regarding coverage based on the patient, the paying entity/plan of the patient and the additional information to facilitate resolving the unresolved coverage.

3. A system according to claim 1, wherein the one or more processors are further configured to automatically determine one or more potential facilities to perform the selected medical service, and automatically determine a cost and/or quality metric for performance of the selected medical service by each of the one or more potential facilities, the cost being determined based on the selected medical service, the ordering provider, the servicing facility/lab, and the paying entity/plan coverage for the selected medical service and the network/contract rules that may exist.

4. A system according to claim 3, wherein the one or more processors being configured to determine a cost includes being configured to determine a cost for performance of the selected medical service by each of the one or more potential facilities further based on the respective one or more potential facilities.

5. A system according to claim 1, wherein the one or more processors are configured for use by one or more users during login sessions of the respective one or more users, wherein for a login session of a user, the one or more processors are configured to present one or more displays of a graphical user interface configured to at least one user to present information relevant to the respective user, or receive information from the respective user, and
wherein the one or more processors are configured to receive proposed medical diagnoses, receive selection of potential medical services, and present an indication regarding plan coverage during a login session of a first user.

6. A system according to claim 5, wherein the one or more processors being configured to present an automated, real-time indication includes being configured to present an automated, real-time indication of coverage or unresolved coverage for the selected medical service, and
wherein, when the real-time indication is of unresolved coverage, the one or more processors are further configured to delegate one or more unresolved tasks to a second user, the one or more unresolved tasks being delegated during the login session of the first user and to enable the one or more processors, during a login session of the second user, to receive additional information and present a real-time update of the indication regarding coverage based on the patient, the paying entity/plan of the patient and the additional information to thereby facilitate resolving the unresolved coverage.

7. A system according to claim 5, wherein the one or more processors are configured for use by one or more clinician users responsible for diagnosis of the patient, and at least one or more facility users responsible for performing the selected medical service, or one or more the paying entity/plan users responsible for the coverage of the patient, and
wherein the one or more processors are configured to receive a proposed medical diagnosis, receive selection of a potential medical service, and present an indication regarding plan coverage during a login session of a clinician user.

8. A system according to claim 7, wherein the one or more processors are further configured to present an indication of the selected medical service during a login session of a facility user to thereby enable the facility user to perform and/or bill for the selected medical service, and
wherein the one or more processors are configured to present a result of the selected medical service during a login session of a clinician user.

9. A system according to claim 7, wherein the one or more processors being configured to present an automated, real-time indication includes being configured to present an automated, real-time indication of coverage or unresolved coverage for the selected medical service, and
wherein, when the real-time indication is of unresolved coverage, the one or more processors are further configured to present a request for review of coverage for the selected medical service during a login session of a payor user to thereby enable the payor user to perform the requested review and resolve the unresolved coverage, and configured to present a result of the requested review during a login session of a clinician user.

10. A system according to claim 1, wherein the one or more processors being configured to automatically identify one or more potential medical services includes being configured to filter an electronic catalog based on the proposed medical diagnosis based on one or more business, clinical, financial, or administrative rules.

11. A system according to claim 10, wherein the one or more processors are configured to implement a collection of services across a plurality of systems spanning a plurality of clinicians responsible for diagnoses of respective patients, facilities responsible for performing the selected medical services with respect to respective patients, and the paying entities/plans responsible for the coverage of respective patients, and
wherein the catalog that one or more processors are configured to filter comprises an electronic catalog available to the plurality of clinicians, facilities and paying entities/plans.

12. A system according to claim 1, wherein the one or more processors are configured to aggregate data across a plurality of systems spanning a plurality of clinicians responsible for diagnoses of respective patients, facilities responsible for performing the selected medical services with respect to respective patients, and the paying entities/plans responsible for the coverage of respective patients, and
wherein the one or more processors are configured to at least one of receive the proposed medical diagnosis, identify one or more medical services, receive selection of the potential medical service, or present the real-time indication regarding coverage based on the aggregated data.

13. A system according to claim 12, wherein the one or more processors are configured to implement a collection of services that are configured to implement business, financial, clinical, or administrative rules and logic based on the aggregated data to thereby at least one of receive the proposed medical diagnosis, identify one or more medical services, receive selection of the potential medical service, or present the real-time indication regarding plan coverage based on the aggregated data.

14. A system according to claim 12, wherein the one or more processors being configured to aggregate data across a plurality of systems includes being configured to aggregate data across legacy systems of the plurality of clinicians, facilities and payors, and wherein the one or more processors being configured to implement a collection of services includes being configured to implement the collection of services integrated into the legacy systems of the plurality of clinicians, facilities and the paying entities/plans.

15. A system according to claim 12, wherein the one or more processors are further configured to provide a reporting of the aggregate data against one or more transactions including one or more of receipt of the proposed medical diagnosis, identification of one or more medical services, receipt of selection of the potential medical service, or presentation of the real-time indication.

16. A system according to claim 1, wherein the one or more processors are configured to generate the automated, real-time indication regarding plan coverage from a decision table reflecting the paying entity/plan rules of the patient and medical necessity rules for the selected medical service.

17. A system according to claim 16, wherein the one or more processors being configured to present an automated, real-time indication includes being configured to present an automated, real-time indication of coverage or unresolved coverage for the selected medical service, and
wherein, when the real-time indication is of unresolved coverage, the one or more processors are further configured to request and receive additional information in accordance with the decision table, and present a real-time update of the indication regarding coverage based on the patient, the paying entity/plan of the patient and the additional information to thereby facilitate resolving the unresolved coverage.

18. A system according to claim 16, wherein the decision table is configurable according to a plurality of business, clinical, financial, or administrative rules of one or more clinicians responsible for diagnoses of respective patients, facilities responsible for performing the selected medical services with respect to respective patients, and the paying entities/plans responsible for the coverage of respective patients.

19. A system comprising:
a processor configured to access a catalog of a plurality of medical services spanning a plurality of one or more of clinicians responsible for diagnoses of respective patients, facilities responsible for performing medical services with respect to respective patients, or paying entities responsible for the coverage of respective patients,
wherein the plurality of one or more clinicians, facilities or paying entities have a respective plurality of nomenclatures for identifying the medical services, at least some of the nomenclatures differing in identifying similar medical services, and
wherein the processor is configured to receive identification of a medical service in the nomenclature of one clinician, facility or paying entity, and from the catalog, translate the identification to the nomenclature of another clinician, facility or paying entity for transmission thereto.

20. A system according to claim 19, wherein the catalog includes a unique code for each of the plurality of medical services, and wherein the processor being configured to translate the identification includes being configured to translate the identification based upon the unique code for the respective medical service.

21. A system according to claim 19, wherein the medical services are arranged in a hierarchy including a plurality of divisions, and subordinate to each division, a plurality of families, and wherein the unique code for each medical service reflects the division and family of the respective medical service.

22. A system according to claim 19, wherein the medical services include respective corresponding descriptions, the descriptions of some of the medical services being more specific than the descriptions for others of the medical services, and
wherein the unique codes for the medical services include granularities in line with the descriptions of the respective medical services, the unique codes of some of the medical services having finer granularity than the unique codes for others of the medical services.

23. A method comprising:
receiving, into a computer-based system, a proposed medical diagnosis of a patient;
automatically identifying, by the system, one or more potential medical services to be performed with respect to the patient, the identified one or medical services being deemed relevant to the proposed medical diagnosis;
receiving, into the system, selection of a potential medical service from the identified one or more potential medical services; and
presenting, by the system, an automated, real-time indication regarding coverage for the selected medical service based on the patient and the paying entity/plan coverage of the patient.

24. A method according to claim 23, wherein presenting an indication regarding plan coverage comprises presenting an indication of coverage or unresolved coverage for the selected medical service, and wherein, when the indication is of unresolved coverage, the method further comprises:
receiving additional information into the system; and
presenting, by the system, a real-time update of the indication regarding plan coverage based on the patient, the paying entity/plan of the patient and the additional information to facilitate resolving the unresolved coverage.

25. A method according to claim 23 further comprising:
determining one or more potential facilities to perform the selected medical service; and
determining a cost and/or quality metric for performance of the selected medical service by each of the one or more potential facilities to perform the selected medical service, the cost and/or quality metric being determined based on the selected medical service, the requesting provider, the paying entity/plan coverage for the selected medical service, the one or more potential facilities and cost and/or quality metric for each of the respective one or more potential facilities being automatically determined by the system.

26. A method according to claim 25, wherein determining a cost and/or quality metric comprises determining a cost and/or quality metric for performance of the selected medical service by each of the one or more potential facilities further based on the respective one or more potential facilities.

27. A method according to claim 23, wherein the system is configured for use by one or more users during login sessions of the respective one or more users, wherein for a login session of a user, the system is configured to present one or more displays of a graphical user interface configured to at least one of present information relevant to the respective user, or receive information from the respective user, and
wherein receiving a proposed medical diagnosis, receiving selection of a potential medical service, and presenting an indication regarding plan coverage occur during a login session of a first user.

28. A method according to claim 27, wherein presenting an automated, real-time indication comprises presenting an automated, real-time indication of coverage or unresolved coverage for the selected medical service, and wherein, when the real-time indication is of unresolved coverage, the method further comprises:
delegating one or more unresolved tasks to a second user, the one or more unresolved tasks being delegated during the login session of the first user and to enable the system, during a login session of the second user, to receive additional information and present a real-time update of the indication regarding the paying entity/plan coverage based on the patient, the paying entity/plan of the patient and the additional information to thereby facilitate resolving the unresolved coverage.

29. A method according to claim 27, wherein the system is configured for use by one or more clinician users responsible for diagnosis of the patient, and at least one of one or more facility users responsible for performing the selected medical service, or one or more the paying entity/plan users responsible for coverage of the patient, and
wherein receiving a proposed medical diagnosis, receiving selection of a potential medical service, and presenting an indication regarding plan coverage occur during a login session of a clinician user.

30. A method according to claim 29 further comprising:
presenting an indication of the selected medical service during a login session of a facility user to thereby enable the facility user to perform and/or bill for the selected medical service; and
presenting a result of the selected medical service during a login session of a clinician user.

31. A method according to claim 29, wherein presenting an automated, real-time indication comprises presenting an automated, real-time indication of coverage or unresolved coverage for the selected medical service, and wherein, when the real-time indication is of unresolved coverage, the method further comprises:
presenting a request for review of coverage for the selected medical service during a login session of a payor user to thereby enable the payor user to perform the requested review; and
presenting a result of the requested review during a login session of a clinician user.

32. A method according to claim 23, wherein automatically identifying one or more potential medical services includes filtering an electronic catalog based on the proposed medical diagnosis based on one or more business, clinical, financial, or administrative rules.

33. A method according to claim 32, wherein the computer-based system is configured to implement a collection of services across a plurality of systems spanning a plurality of clinicians responsible for diagnoses of respective patients, facilities responsible for performing the selected medical services with respect to respective patients, and the paying entities/plans responsible for the coverage of respective patients, and
wherein filtering an electronic catalog comprises filtering an electronic catalog available to the plurality of clinicians, facilities and payors.

34. A method according to claim 23, wherein the computer-based system is configured to aggregate data across a plurality of systems spanning a plurality of clinicians responsible for diagnoses of respective patients, facilities responsible for performing the selected medical services with respect to respective patients, and the paying entities/plans responsible for the coverage of respective patients, and
wherein one or more of receiving a proposed medical diagnosis, identifying one or more medical services, receiving selection of the potential medical service, or presenting the real-time indication regarding coverage occur based on the aggregated data.

35. A method according to claim 34, wherein the computer-based system is configured to implement a collection of services, and wherein one or more of receiving a proposed medical diagnosis, identifying one or more medical services, receiving selection of the potential medical service, or presenting the real-time indication regarding coverage occur according to the collection of services implementing business, clinical, administrative, or financial rules and logic based on the aggregated data.

36. A method according to claim 34, wherein the computer-based system being configured to aggregate data across a plurality of systems includes being configured to aggregate data across legacy systems of the plurality of clinicians, facilities and the paying entities/plans, and wherein the computer-based system being configured to implement a collection of services includes being configured to implement the collection of services integrated into the legacy systems of the plurality of clinicians, facilities and paying entities/plans.

37. A method according to claim 34 further comprising:
providing a reporting of the aggregate data against one or more transactions including one or more of receipt of the proposed medical diagnosis, identification of one or more medical services, receipt of selection of the potential medical service, or presentation of the real-time indication.

38. A method according to claim 23 further comprising:
generating the automated, real-time indication regarding plan coverage from a decision table reflecting the paying entity/plan rules of the patient and medical necessity rules for the selected medical service.

39. A method according to claim 38, wherein presenting an automated, real-time indication includes presenting an automated, real-time indication of coverage or unresolved coverage for the selected medical service, and
wherein, when the real-time indication is of unresolved coverage, the method further comprises requesting and receiving additional information in accordance with the decision table, and presenting a real-time update of the indication regarding coverage based on the patient, the paying entity/plan of the patient and the additional information to thereby facilitate resolving the unresolved coverage.

40. A method according to claim 38, wherein the decision table is configurable according to a plurality of business, clinical, financial, or administrative rules of one or more clinicians responsible for diagnoses of respective patients, facilities responsible for performing the selected medical services with respect to respective patients, and the paying entities/plans responsible for the coverage of respective patients.

41. A method comprising:
accessing a catalog of a plurality of medical services spanning a plurality of one or more of clinicians responsible for diagnoses of respective patients, facilities responsible for performing medical services with respect to respective patients, or paying entities responsible for the coverage of respective patients,
wherein the plurality of one or more clinicians, facilities or paying entities have a respective plurality of nomenclatures for identifying the medical services, at least some of the nomenclatures differing in identifying similar medical services; and
receiving identification of a medical service in the nomenclature of one clinician, facility or paying entity, and from the catalog, translate the identification to the nomenclature of another clinician, facility or paying entity for transmission thereto.

42. A method according to claim 41, wherein the catalog includes a unique code for each of the plurality of medical services, and wherein translating the identification includes translating the identification based upon the unique code for the respective medical service.

43. A method according to claim 41 wherein the medical services are arranged in a hierarchy including a plurality of divisions, and subordinate to each division, a plurality of families, and wherein the unique code for each medical service reflects the division and family of the respective medical service.

44. A method according to claim 41, wherein the medical services include respective corresponding descriptions, the descriptions of some of the medical services being more specific than the descriptions for others of the medical services, and
wherein the unique codes for the medical services include granularities in line with the descriptions of the respective medical services, the unique codes of some of the medical services having finer granularity than the unique codes for others of the medical services.

45. One or more computer-readable storage mediums having computer-readable program code portions stored therein, the computer-readable program code portions comprising:
a first executable portion configured to receive a proposed medical diagnosis of a patient;
a second executable portion configured to automatically identify one or more potential medical services to be performed with respect to the patient, the identified one or medical services being deemed relevant to the proposed medical diagnosis;
a third executable portion configured to receive selection of a potential medical service from the identified one or more potential medical services; and
a fourth executable portion configured to present an automated, real-time indication regarding coverage for the selected medical service based on the patient and a paying entity/plan of the patient.

46. One or more computer-readable storage mediums according to claim 45, wherein the fourth executable portion is configured to present an indication of coverage or unresolved coverage for the selected medical service, and wherein the computer-readable program code portions further comprise:
a fifth executable portion configured to receive additional information into the system; and
a sixth executable portion configured to present a real-time update of the indication regarding plan coverage based on the patient, the paying entity/plan of the patient and the additional information to facilitate resolving the unresolved coverage, the fifth and sixth executable portions being configured to receive additional information and present a real-time update, respectively, when the indication is of unresolved coverage.

47. One or more computer-readable storage mediums according to claim 45, wherein the computer-readable program code portions further comprise:
a fifth executable portion configured to automatically determine one or more potential facilities to perform the selected medical service; and
a sixth executable portion configured to automatically determine a cost and/or quality metric for performance of the selected medical service by each of the one or more potential facilities to perform the selected medical service, the cost and/or quality metric being determined based on the selected medical service and the coverage for the selected medical service by the paying entity/plan.

48. One or more computer-readable storage mediums according to claim 47, wherein the sixth executable portion is configured to automatically determine a cost and/or quality metric for performance of the selected medical service by each of the one or more potential facilities further based on the respective one or more potential facilities.

49. One or more computer-readable storage mediums according to claim 45, wherein the computer-readable program code portions are configured for use by one or more users during login sessions of the respective one or more users, wherein for a login session of a user, one or more of the computer-readable program code portions are configured to present one or more displays of a graphical user interface configured to at least one of present information relevant to the respective user, or receive information from the respective user, and
wherein first, third and fourth executable portions are configured to receive a proposed medical diagnosis, receive selection of a potential medical service, and present an indication regarding plan coverage, respectively, during a login session of a first user.

50. One or more computer-readable storage mediums according to claim 49, wherein the fourth executable portion is configured to present an automated, real-time indication of coverage or unresolved coverage for the selected medical service, and wherein the computer-readable program code portions further comprise:
a fifth executable portion configured to delegate one or more unresolved tasks to a second user, the one or more unresolved tasks being delegated during the login session of the first user and to enable the computer-readable program code portions, during a login session of the second user, to receive additional information and present a real-time update of the indication regarding coverage based on the patient, the paying entity/plan of the patient and the additional information to thereby facilitate resolving the unresolved coverage, the fifth executable portion being configured to delegate one or more unresolved tasks when the real-time indication is of unresolved coverage.

51. One or more computer-readable storage mediums according to claim 49, wherein the computer-readable program code portions are configured for use by one or more clinician users responsible for diagnosis of the patient, and at least one of one or more facility users responsible for performing the selected medical service, or one or more paying entity/plan users responsible for the coverage of the patient, and
wherein first, third and fourth executable portions are configured to receive a proposed medical diagnosis, receive selection of a potential medical service, and present an indication regarding plan coverage, respectively, during a login session of a clinician user.

52. One or more computer-readable storage mediums according to claim 51, wherein the computer-readable program code portions further comprise:
a fifth executable portion configured to present an indication of the selected medical service during a login session of a facility user to thereby enable the facility user to perform and bill for the selected medical service; and
a sixth executable portion configured to present a result of the selected medical service during a login session of a clinician user.

53. One or more computer-readable storage mediums according to claim 51, wherein the fourth executable portion is configured to present an automated, real-time indication of coverage or unresolved coverage for the selected medical service, and wherein the computer-readable program code portions further comprise:
a fifth executable portion configured to present a request for review of coverage for the selected medical service during a login session of a paying entity/plan user to thereby enable the paying entity/plan user to perform the requested review; and
a sixth executable portion configured to present a result of the requested review during a login session of a clinician user, the fifth and sixth executable portions being configured to present a request and present a result, respectively, when the real-time indication is of unresolved coverage.

54. One or more computer-readable storage mediums according to claim 45, wherein the second executable portion being configured to automatically identify one or more potential medical services includes being configured to filter an electronic catalog based on the proposed medical diagnosis based on one or more business, financial, clinical, or administrative rules across multiple entities.

55. One or more computer-readable storage mediums according to claim 54, wherein the computer-readable program code portions are configured to implement a collection of services across a plurality of systems spanning a plurality of clinicians responsible for diagnoses of respective patients, facilities responsible for performing the selected medical services with respect to respective patients, and paying entities/plans responsible for the coverage of respective patients, and
wherein the second executable portion being configured to filter an electronic catalog includes being configured to filter an electronic catalog available to the plurality of clinicians, facilities and payors.

56. One or more computer-readable storage mediums according to claim 45, wherein the computer-readable program code portions are configured to aggregate data across a plurality of systems spanning a plurality of clinicians responsible for diagnoses of respective patients, facilities responsible for performing the selected medical services with respect to respective patients, and paying entities/plans responsible for the coverage of respective patients, and
wherein one or more of the first executable portion, second executable portion, third executable portion or fourth executable portion are configured to one or more of receive a proposed medical diagnosis, identify one or more medical services, receive selection of the potential medical service, or present the real-time indication regarding plan coverage, respectively, based on the aggregated data.

57. One or more computer-readable storage mediums according to claim 56, wherein the computer-readable program code portions are configured to implement a collection of services, and wherein one or more of the first executable portion, second executable portion, third executable portion or fourth executable portion are configured to one or more of receive a proposed medical diagnosis, identify one or more medical services, receive selection of the potential medical service, or present the real-time indication regarding plan coverage, respectively, according to the collection of services implementing business, clinical, administrative, or financial rules and logic based on the aggregated data.

58. One or more computer-readable storage mediums according to claim 56, wherein the computer-readable program code portions being configured to aggregate data across a plurality of systems includes being configured to aggregate data across legacy systems of the plurality of clinicians, facilities and paying entities/plans, and wherein the computer-readable program code portions being configured to implement a collection of services includes being configured to implement the collection of services integrated into the legacy systems of the plurality of clinicians, facilities and paying entities/plans.

59. One or more computer-readable storage mediums according to claim 56, wherein the computer-readable program code portions further comprise:
a fifth executable portion configured to provide a reporting of the aggregate data against one or more transactions including one or more of receipt of the proposed medical diagnosis, identification of one or more medical services, receipt of selection of the potential medical service, or presentation of the real-time indication.

60. One or more computer-readable storage mediums according to claim 45, wherein the computer-readable program code portions further comprise:
a fifth executable portion configured to generate the automated, real-time indication regarding plan coverage from a decision table reflecting the paying entity/plan rules of the patient and medical necessity rules for the selected medical service.

61. One or more computer-readable storage mediums according to claim 60, wherein the fourth executable portion being configured to present an automated, real-time indication includes being configured to present an automated, real-time indication of coverage or unresolved coverage for the selected medical service, and
wherein the computer-readable program code portions further comprise a sixth executable portion that, when the real-time indication is of unresolved coverage, is configured to request and receive additional information in accordance with the decision table, and present a real-time update of the indication regarding coverage based on the patient, the paying entity/plan of the patient and the additional information to thereby facilitate resolving the unresolved coverage.

62. One or more computer-readable storage mediums according to claim 60, wherein the decision table is configurable according to a plurality of business, clinical, financial, or administrative rules of one or more clinicians responsible for diagnoses of respective patients, facilities responsible for performing the selected medical services with respect to respective patients, and the paying entities/plans responsible for the coverage of respective patients.

63. One or more computer-readable storage mediums having computer-readable program code portions stored therein, the computer-readable program code portions comprising:
a first executable portion configured to access a catalog of a plurality of medical services spanning a plurality of one or more of clinicians responsible for diagnoses of respective patients, facilities responsible for performing medical services with respect to respective patients, or paying entities responsible for the coverage of respective patients,
wherein the plurality of one or more clinicians, facilities or paying entities have a respective plurality of nomenclatures for identifying the medical services, at least some of the nomenclatures differing in identifying similar medical services, and
a second executable portion configured to receive identification of a medical service in the nomenclature of one clinician, facility or paying entity, and from the catalog, translate the identification to the nomenclature of another clinician, facility or paying entity for transmission thereto.

64. One or more computer-readable storage mediums according to claim 63, wherein the catalog includes a unique code for each of the plurality of medical services, and wherein the second executable portion being configured to translate the identification includes being configured to translate the identification based upon the unique code for the respective medical service.

65. One or more computer-readable storage mediums according to claim 63 wherein the medical services are arranged in a hierarchy including a plurality of divisions, and subordinate to each division, a plurality of families, and wherein the unique code for each medical service reflects the division and family of the respective medical service.

66. One or more computer-readable storage mediums according to claim 63, wherein the medical services include respective corresponding descriptions, the descriptions of some of the medical services being more specific than the descriptions for others of the medical services, and
wherein the unique codes for the medical services include granularities in line with the descriptions of the respective medical services, the unique codes of some of the medical services having finer granularity than the unique codes for others of the medical services.
